(19) United States
(12) Patent Application Publication
(10) Pub. No.: US 2016/0074853 A1
(43) Pub. Date: Mar. 17, 2016

(54) LIGAND, NICKEL COMPLEX COMPRISING THE LIGAND, AND REACTION USING THE NICKEL COMPLEX

(71) Applicant: NATIONAL UNIVERSITY CORPORATION NAGOYA UNIVERSITY, Nagoya-shi (JP)

(72) Inventors: Kenichiro Itami, Nagoya-shi (JP); Junichiro Yamaguchi, Nagoya-shi (JP); Ryosuke Takise, Nagoya-shi (JP); Eva Koch, Nagoya-shi (JP)

(21) Appl. No.: 14/643,365

(22) Filed: Mar. 10, 2015

(30) Foreign Application Priority Data
Mar. 11, 2014 (JP) 2014-048094
Jul. 10, 2014 (JP) 2014-142721

(51) Int. Cl. B01J 31/24; C07F 15/04; C07B 37/04; C07F 9/6553

(52) U.S. Cl. CPC B01J 31/2409; C07F 9/655345; C07F 15/04; C07B 37/04; B01J 2531/847; B01J 2231/40

(57) ABSTRACT

An object of the present invention is to provide a method for directly performing arylation (particularly α-arylation) of carbonyl or thiocarbonyl compounds using a more inexpensive phenol derivative and nickel catalyst. Another object of the present invention is to provide a novel nickel catalyst that can be used in this method, and a novel ligand of the nickel catalyst. The novel compounds of the present invention are a compound having a diphosphine skeleton in which a five- or six-membered heterocyclic ring is substituted with two dialkylphosphines and/or dicycloalkylphosphines, or a salt thereof, and a compound having the diphosphine skeleton that is bound to nickel. Moreover, coupling reaction of a carbonyl compound and a phenol derivative can be advanced in the presence of a nickel compound having a monodentate or bidentate dialkylphosphine and/or dicycloalkylphosphine skeleton.

### TECHNICAL FIELD

The present invention relates to a ligand, a nickel complex comprising the ligand, and a reaction using the nickel complex (specifically coupling reaction of a carbonyl or thiocarbonyl compound and a phenol derivative).

### BACKGROUND ART

Various arylcarbonyl or arylthiocarbonyl compounds that are obtained, respectively, by arylation of carbonyl or thiocarbonyl compounds (particularly α-arylcarbonyl compounds that are obtained by arylation of the α-position of carbonyl compounds or α-arylthiocarbonyl compounds that are obtained by arylation of the α-position of thiocarbonyl compounds) are used as bioactive compounds, such as medicines. Therefore, arylation of the α-position of carbonyl or thiocarbonyl compounds is particularly very important. For this reason, there is a demand for methods for directly performing arylation of carbonyl or thiocarbonyl compounds in a more inexpensive manner.

Conventionally, the α-position of carbonyl compounds is often arylated by reacting carbonyl compounds, such as ketone, ester, amide, or aldehyde, and aryl halide (haloarene).

In particular, haloarenes having a halogen atom, such as iodine, bromine, or chlorine, are known as the most useful arylating agents because of their high reactivity in the presence of a palladium catalyst (NPL 1, etc.). It has also been reported that the α-position of carbonyl compounds is arylated by reaction with haloarenes using a copper catalyst and a nickel catalyst. However, there are few reports on methods for performing arylation (particularly α-arylation) of carbonyl or thiocarbonyl compounds using compounds that are more inexpensive than haloarenes, without using halogen-containing compounds.

In contrast, it has been reported that the C—O bond of phenol derivatives, such as the C—O bond of compounds represented by ArOSO₂R (R is CF₃, C₆H₄CH₃, methylimidazole, or the like), is activated in the presence of a palladium catalyst (NPL 2, etc.). However, there is no example using more inexpensive nickel catalysts.

Accordingly, in order to advance the reaction in a more inexpensive manner, there is a demand for methods for performing arylation (particularly α-arylation) of carbonyl or thiocarbonyl compounds using a more inexpensive substrate and nickel catalyst.

### CITATION LIST

### Non-Patent Literature

NPL 1: Angew. Chem. Int. Ed., 2010, 49, pp. 676-707
NPL 2: J. Am. Chem. Soc., 2003, 125, pp. 11818-11819

### SUMMARY OF INVENTION

### Technical Problem

An object of the present invention is to provide a method for directly performing arylation (particularly α-arylation) of carbonyl or thiocarbonyl compounds using a more inexpensive phenol derivative and nickel catalyst. Another object of the present invention is to provide a novel nickel catalyst that can be used in this method, and a novel ligand of the nickel catalyst.

### Solution to Problem

As a result of extensive studies to achieve the above objects, the present inventors succeeded in arylation (α-arylation) of carbonyl or thiocarbonyl compounds using various phenol derivatives, by using, as nickel catalysts, nickel compounds having a monodentate or bidentate (particularly bidentate) dialkylphosphine and/or dicycloalkylphosphine (particularly bidentate dicycloalkylphosphine) skeleton. In this nickel compound group, a nickel compound having a diphosphine skeleton in which a specific heterocyclic ring is substituted with two dialkylphosphines and/or dicycloalkylphosphines (particularly two dicycloalkylphosphines), and a ligand compound having the diphosphine skeleton are novel compounds that have not been disclosed in any documents. The present inventors conducted further studies based on these findings and completed the present invention.

Specifically, the present invention includes the following structures:

Item 1. A compound having a diphosphine skeleton in which a five- or six-membered heterocyclic ring is substituted with two dialkylphosphines and/or dicycloalkylphosphines, or a salt thereof.
Item 2. The compound or a salt thereof according to item 1, wherein the compound is represented by Formula (1):

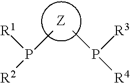

wherein Z is an optionally substituted five- or six-membered heterocyclic ring; and

R¹ to R⁴ are the same or different, and each is optionally substituted alkyl or optionally substituted cycloalkyl.

Item 3. The compound or a salt thereof according to item 2, wherein R¹ to R⁴ in Formula (1) are the same or different, and each is optionally substituted cycloalkyl.
Item 4. The compound or a salt thereof according to any one of items 1 to 3, which is used to produce a catalyst for coupling reaction of a carbonyl or thiocarbonyl compound and a phenol derivative.
Item 5. A compound having a diphosphine skeleton in which a five- or six-membered heterocyclic ring is substituted with two dialkylphosphines and/or dicycloalkylphosphines, the diphosphine skeleton being bound to nickel.
Item 6. The compound according to item 5, which is represented by Formula (2):

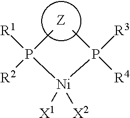

wherein Z is an optionally substituted five- or six-membered heterocyclic ring;

R¹ to R⁴ are the same or different, and each is optionally substituted alkyl or optionally substituted cycloalkyl; and

X¹ and X² are the same or different, and each is a ligand.

Item 7. The compound according to item 5 or 6, wherein R¹ to R⁴ in Formula (2) are the same or different, and each is optionally substituted cycloalkyl.
Item 8. The compound according to any one of items 5 to 7, which is a catalyst for coupling reaction of a carbonyl or thiocarbonyl compound and a phenol derivative.
Item 9. A method for producing an arylcarbonyl compound, comprising the step of subjecting a carbonyl or thiocarbonyl compound and a phenol derivative to coupling reaction in the presence of the compound according to any one of items 5 to 8.
Item 10. A coupling method comprising reacting a carbonyl or thiocarbonyl compound and a phenol derivative in the presence of the compound according to any one of items 5 to 8.
Item 11. A method for producing an aryl(thio)carbonyl compound comprising the step of subjecting a carbonyl or thiocarbonyl compound and a phenol derivative to coupling reaction;

the coupling reaction being performed in the presence of a nickel compound having a monodentate or bidentate dialkylphosphine and/or dicycloalkylphosphine skeleton.

Item 12. The production method according to item 11, wherein the nickel compound is represented by Formula (3):

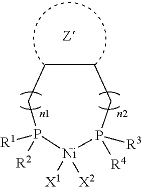

wherein Z′ may or may not form a ring; when Z′ forms a ring, Z′ is an aromatic hydrocarbon ring or a five- or six-membered heterocyclic ring;

R¹ to R⁴, and X¹ and X² are the same as above; and

n1 and n2 are the same or different, and each is an integer of 0 to 2.

Item 13. A coupling method for reacting a carbonyl or thiocarbonyl compound and a phenol derivative,

the reaction being performed in the presence of a nickel compound having a monodentate or bidentate dialkylphosphine and/or dicycloalkylphosphine skeleton.

Item 14. The method according to item 13, wherein the nickel compound is represented by Formula (3):

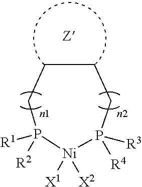

wherein Z′ may or may not form a ring; when Z′ forms a ring, Z′ is an aromatic hydrocarbon ring or a five- or six-membered heterocyclic ring;

R¹ to R⁴, and X¹ and X² are the same as above; and

n1 and n2 are the same or different, and each is an integer of 0 to 2.

### Advantageous Effects of Invention

The ligand compound and nickel complex (catalyst) of the present invention are novel compounds that have not been disclosed in any documents. These compounds enable direct arylation (particularly α-arylation) of carbonyl or thiocarbonyl compounds using a more inexpensive phenol derivative. Due to its extremely excellent storage stability and inexpensive availability, the nickel complex (catalyst) is highly practical and convenient.

Further, the present invention enables direct arylation (particularly α-arylation) of carbonyl or thiocarbonyl compounds using a more inexpensive phenol derivative and nickel catalyst. The coupling reaction of the present invention is a new type of coupling reaction in which two molecules are coupled while breaking the carbon-hydrogen bond of a carbonyl or thiocarbonyl compound (particularly the carbon-hydrogen bond at the α-position of a carbonyl or thiocarbonyl compound) and the carbon-oxygen bond of a phenol derivative. The carbonyl or thiocarbonyl compound used in this reaction may be not only a chain compound having a carbonyl or thiocarbonyl group, but also a cyclic compound having a carbonyl group.

Moreover, since a phenol derivative can be used as the coupling partner in place of aromatic halide (conventional type), and a carbonyl or thiocarbonyl compound is used as the other coupling partner, the coupling reaction can be performed more inexpensively without producing halogen waste and metal waste, which raise concerns about environmental pollution. Furthermore, the total number of processes can be significantly reduced, and arylcarbonyl compounds (particularly α-arylcarbonyl compounds) or arylthiocarbonyl compounds (particularly α-arylthiocarbonyl compounds) can be more easily synthesized.

Various arylcarbonyl compounds (particularly α-arylcarbonyl compounds) or arylthiocarbonyl compounds (α-arylthiocarbonyl compounds) obtained by using the method of the present invention are used as bioactive compounds, such as medicines. Further, the method of the present invention can be performed inexpensively and directly. Therefore, the method of the present invention is very useful.

Furthermore, arylcarbonyl compounds (particularly α-arylcarbonyl compounds) or arylthiocarbonyl compounds (particularly α-arylthiocarbonyl compounds) can be obtained with very high yield through the selection of substrates, nickel catalysts, etc. In this case, the selectivity of arylcarbonyl compounds (particularly α-arylcarbonyl compounds) or arylthiocarbonyl compounds (particularly α-arylthiocarbonyl compounds) is also high, possibly leading to greater energy savings.

In addition, inexpensive and air-stable nickel complexes can be used in place of rare and expensive palladium catalysts (conventional type).

### BRIEF DESCRIPTION OF DRAWINGS

FIG. 1 is a drawing showing the structure of a nickel complex (3f) obtained in Example 2-1, drawn by using the Thermal Ellipsoid Plot program ORTEP (50% probability ellipsoids).

FIG. 2 is a drawing showing the structure of a nickel complex 5 obtained in Test Example 1, drawn by using the Thermal Ellipsoid Plot program ORTEP (50% probability ellipsoids).

### DESCRIPTION OF EMBODIMENTS

The compounds (ligand compound and nickel complex (catalyst)) of the present invention, the method for producing aryl(thio)carbonyl compounds using a specific nickel compound, and the coupling method are described in detail below.

### 1. Ligand Compound and Metal Complex

### (1) Ligand Compound

The ligand compound of the present invention is a compound having a diphosphine skeleton in which a five- or six-membered heterocyclic ring is substituted with two dialkylphosphines and/or dicycloalkylphosphines, or a salt thereof, and is a novel compound that has not been disclosed in any documents. The ligand compound can be coordinated to nickel at two positions (two phosphorus atoms) to form a complex.

More specifically, the ligand compound of the present invention is a compound represented by Formula (1):

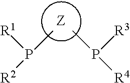

wherein Z is an optionally substitute five- or six-membered heterocyclic ring, and R¹ to R⁴ are the same or different, and each is optionally substituted alkyl or optionally substituted cycloalkyl;
or a salt thereof.

In Formula (1), the heterocyclic ring represented by Z is not particularly limited as long as it is a five- or six-membered heterocyclic ring. In terms of storage stability, a five- or six-membered heterocyclic aromatic ring is preferred. Specific examples thereof include a thiophene ring, a pyrrole ring, a pyridine ring, a furan ring, an imidazole ring, a pyrazole ring, a pyrazine ring, an oxazole ring, a thiazole ring, an indole ring, a benzofuran ring, a benzothiophene ring, and the like; preferably a thiophene ring, a pyrrole ring, a pyridine ring, a furan ring, an imidazole ring, a pyrazole ring, a pyrazine ring, an oxazole ring, a thiazole ring, and the like; and particularly preferably a thiophene ring. Examples of heterocyclic ring substituents include halogen (e.g., fluorine and chlorine), alkyl (e.g., C₁₋₄ alkyl, such as methyl and ethyl), haloalkyl (e.g., C₁₋₄ haloalkyl, such as trifluoromethyl), alkoxy (C₁₋₄ alkoxy, such as methoxy), a group represented by —COOR (R is alkyl, such as methyl or ethyl), and the like. The number of substituents is not particularly limited, but is preferably 0 to 6, and more preferably 0 to 3.

Examples of the alkyl groups represented by R¹ to R⁴ in Formula (1) include linear or branched C₁₋₆ alkyl, and preferably C₁₋₄ alkyl. Specific examples thereof include methyl, ethyl, n-propyl, isopropyl, n-butyl, isobutyl, sec-butyl, tert-butyl, pentyl, hexyl, and the like. Examples of alkyl substituents include halogen (e.g., fluorine and chlorine). The number of substituents is not particularly limited, but is preferably 0 to 6, and more preferably 0 to 3.

Examples of the cycloalkyl groups represented by R¹ to R⁴ in Formula (1) include C₃₋₈ cycloalkyl, and preferably C₄₋₆ cycloalkyl. Specific examples thereof include cyclopropyl, cyclobutyl, cyclopentyl, cyclohexyl, cycloheptyl, cyclooctyl, and the like. In terms of the yield of arylation (particularly α-arylation) of carbonyl or thiocarbonyl compounds using a phenol derivative, cyclobutyl, cyclopentyl, cyclohexyl, etc., are preferred; and cyclohexyl is more preferred. Examples of cycloalkyl substituents include halogen (e.g., fluorine and chlorine). The number of substituents is not particularly limited, but is preferably 0 to 6, and more preferably 0 to 3.

In Formula (1), R¹ to R⁴ may be the same or different, and each may be optionally substituted alkyl or optionally substituted cycloalkyl. In terms of the yield of arylation (particularly α-arylation) of carbonyl or thiocarbonyl compounds using a phenol derivative, optionally substituted cycloalkyl is preferred, and cycloalkyl is more preferred. R¹ to R⁴ are particularly preferably cyclobutyl, cyclopentyl, cyclohexyl, etc., and most preferably cyclohexyl.

In terms of the yield of arylation (particularly α-arylation) of carbonyl or thiocarbonyl compounds using a phenol derivative, the ligand compound of the present invention that satisfies such conditions is preferably a compound represented by Formula (1A):

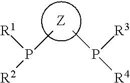

wherein Z is the same as above, and R¹ to R⁴ are the same or different, and each is optionally substituted cycloalkyl; and more preferably a compound represented by Formula (1A1):

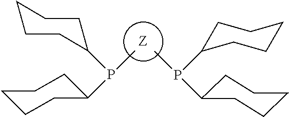

wherein Z is the same as above.

In another preferred embodiment, in terms of the yield of arylation (particularly α-arylation) of carbonyl or thiocarbonyl compounds using a phenol derivative, the ligand compound of the present invention is preferably a compound represented by Formula (1B):

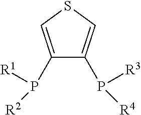

wherein R¹ to R⁴ are the same or different, and each is optionally substituted alkyl or optionally substituted cycloalkyl; and more preferably a compound represented by Formula (1B1):

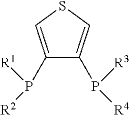

wherein R¹ to R⁴ are the same or different, and each is optionally substituted cycloalkyl.

A specific example of the ligand compound of the present invention is as follows:

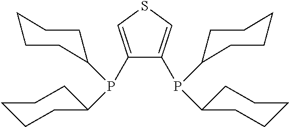 [SMILES: c1scc(P(C2CCCCC2)C2CCCCC2)c1P(C1CCCCC1)C1CCCCC1]

The ligand compound of the present invention may be not only the compound mentioned above, but also a salt of the compound. Examples of such salts include borane salts, fluoride salts, chloride salts, bromide salts, iodide salts, and the like. Borane salts are particularly preferred in terms of storage stability.

### (2) Nickel Complex (Catalyst)

The nickel complex of the present invention is a compound having a diphosphine skeleton in which a five- or six-membered heterocyclic ring is substituted with two dialkylphosphines and/or dicycloalkylphosphines, and the diphosphine skeleton is bonded (particularly coordinate-bonded) to nickel. This nickel complex is a novel compound that has not been disclosed in any documents. The nickel complex can be used as a catalyst for arylation (particularly α-arylation) of carbonyl or thiocarbonyl compounds, even when a more inexpensive phenol derivative is used. Moreover, when the nickel complex of the present invention is used as a catalyst, arylation (particularly α-arylation) of carbonyl or thiocarbonyl compounds can be performed with high yield. Further, storage stability is excellent. Accordingly, the nickel complex of the present invention is particularly useful as a catalyst for arylation (particularly α-arylation) of carbonyl or thiocarbonyl compounds.

More specifically, the ligand compound of the present invention is preferably a compound represented by Formula (2):

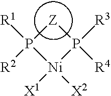

wherein Z is an optionally substituted five- or six-membered heterocyclic ring; R¹ to R⁴ are the same or different, and each is optionally substituted alkyl or optionally substituted cycloalkyl; and X¹ and X² are the same or different, and each is a ligand.

It is generally considered thought that the nickel atom and the two phosphorus atoms form coordinate bonds, and that the nickel atom and X¹ and X² form coordinate bonds; however, in Formula (2), the coordinate bonds are illustrated by solid lines for convenience.

Examples of the heterocyclic ring represented by Z in Formula (2) include those mentioned above as examples of Z in Formula (1). Preferred specific examples, the type of possible substituents, and the number of substituents are also the same as mentioned above. A thiophene ring is preferred.

Examples of the alkyl groups represented by R¹ to R⁴ in Formula (2) include those mentioned above as examples of R¹ to R⁴ in Formula (1). Preferred specific examples, the type of possible substituents, and the number of substituents are also the same as above. C₁₋₄ alkyl is particularly preferred.

Examples of the cycloalkyl groups represented by R¹ to R⁴ in Formula (2) include those mentioned above as examples of R¹ to R⁴ in Formula (1). Preferred specific examples, the type of possible substituents, and the number of substituents are also the same as above. C₄₋₆ cycloalkyl is particularly preferred.

In Formula (2), R¹ to R⁴ may be the same or different, and each may be optionally substituted alkyl or optionally substituted cycloalkyl. In terms of the yield of arylation (particularly α-arylation) of carbonyl or thiocarbonyl compounds using a phenol derivative, optionally substituted cycloalkyl is preferred, and cycloalkyl is more preferred. R¹ to R⁴ are particularly preferably cyclobutyl, cyclopentyl, cyclohexyl, etc., and most preferably cyclohexyl.

The ligands represented by X¹ and X² in Formula (2) are not particularly limited as long as they can be coordinated to nickel. Examples thereof include hydrogen (hydride; H⁻, halogen; lower alkoxy; carbon monoxide (CO); boron-based ligand; phosphorus-based ligand; antimony-based ligand; arsenic-based ligand; sulfonic acid-based ligand; sulfate; perchlorate; nitrate; bis(triflyl)imide; tris(triflyl)methane; bis(triflyl)methane; carboxylates; and the like.

Examples of halogen atoms as the ligands represented by X¹ and X² include fluorine, chlorine, bromine, and iodine.

Examples of lower alkoxy groups as the ligands represented by X¹ and X² include C₁₋₃ alkoxy, such as methoxy, ethoxy, n-propoxy, and isopropoxy.

Examples of boron-based ligands as the ligands represented by X¹ and X² include tetraphenylborate, tetrakis(bis(trifluoromethyl)phenyl)borate, tetrakis(pentafluorophenyl)borate, tetrafluoroborate, alkyltrifluoroborate, aryltrifluoroborate, and the like.

Examples of phosphorus-based ligands as the ligands represented by X¹ and X² include hexafluorophosphate and the like.

Examples of antimony-based ligands as the ligands represented by X¹ and X² include hexafluoroantimonate and the like.

Examples of arsenic-based ligands as the ligands represented by X¹ and X² include hexafluoroarsenate and the like.

Examples of sulfonic acid-based ligands as the ligands represented by X¹ and X² include tosilate, mesilate, triflate, and the like.

Examples of carboxylates as the ligands represented by X¹ and X² include acetate and the like.

In terms of the yield of arylation (particularly α-arylation) of carbonyl or thiocarbonyl compounds using a phenol derivative, the ligand compound of the present invention that satisfies such conditions is preferably a compound represented by Formula (2A):

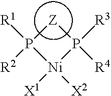

wherein Z, X¹, and X² are the same as above; R¹ to R⁴ are the same or different, and each is optionally substituted cycloalkyl; and the solid lines connecting a nickel atom and two phosphorus atoms, and the solid lines connecting the nickel atom and X¹ and X² are coordinate bonds;
and preferably a compound represented by Formula (2A1):

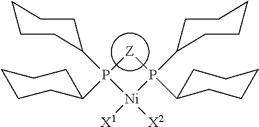

wherein Z, X¹, and X² are the same as above; and the solid lines connecting a nickel atom and two phosphorus atoms, and the solid lines connecting the nickel atom and X¹ and X² are coordinate bonds.

In another preferred embodiment, in terms of the yield of arylation (particularly α-arylation) of carbonyl or thiocarbonyl compounds using a phenol derivative, the ligand compound of the present invention is preferably a compound represented by Formula (2B):

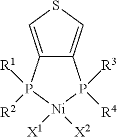

wherein R¹ to R⁴ are the same or different, and each is optionally substituted alkyl or optionally substituted cycloalkyl; and the solid lines connecting a nickel atom and two phosphorus atoms, and the solid lines connecting the nickel atom and X¹ and X² are coordinate bonds;
and more preferably a compound represented by Formula (2B1):

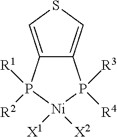

wherein R¹ to R⁴ are the same or different, and each is optionally substituted cycloalkyl; the solid lines connecting a nickel atom and two phosphorus atoms, and the solid lines connecting the nickel atom and X¹ and X² are coordinate bonds.

Specific examples of the ligand compound of the present invention include the following:

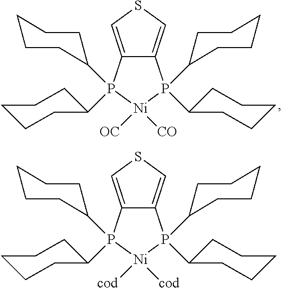

wherein cod is 1,5-cyclooctadiene (hereinafter the same); the solid lines connecting a nickel atom and two phosphorus atoms, and the solid lines connecting the nickel atom and CO or cod are coordinate bonds.

### (3) Method for Producing Ligand Compound and Nickel Complex

The ligand compound represented by Formula (1) and the nickel complex represented by Formula (2) can be produced according to, for example, the following reaction scheme:

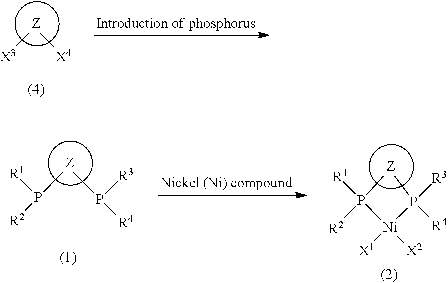

wherein Z, R¹ to R⁴, and X¹ and X² are the same as above; X³ and X⁴ are the same or different, and each is halogen; and the solid lines connecting a nickel atom and two phosphorus atoms, and the solid lines connecting the nickel atom and X¹ and X² are coordinate bonds.

Examples of the halogen atoms represented by X³ and X⁴ in the reaction scheme include fluorine, chlorine, bromine, and iodine; and preferably bromine.

### Synthesis of (4)->(1)

The ligand compound of the present invention represented by Formula (1) can be produced by, for example, reacting, in the presence of a base, the compound represented by Formula (4) with a phosphorus compound represented by Formula (5):

R¹R²P—X⁵

wherein R¹ and R² are the same as above, and X⁵ is halogen.

Z in Formula (4) may be any of the heterocyclic rings mentioned above. Preferred specific examples, the type of possible substituents, and the number of substituents are also the same as above. A thiophene ring is particularly preferred.

Examples of the halogen atoms represented by X³ and X⁴ in Formula (4) include fluorine, chlorine, bromine, and iodine; and preferably bromine.

The compound represented by Formula (4) may be a known or commercially available compound. For example, 3,4-dibromothiophene can be suitably used.

R¹ and R² in Formula (5) may be any of the alkyl or cycloalkyl mentioned above. Preferred specific examples, the type of possible substituents, and the number of substituents are also the same as above. C₄₋₆ cycloalkyl is particularly preferred.

Examples of the halogen atom represented by X⁵ in Formula (5) include fluorine, chlorine, bromine, and iodine; and preferably chlorine.

The compound represented by Formula (5) may be a known or commercially available compound. For example, chlorodicyclohexylphosphine can be suitably used.

In terms of yield, the amount of the phosphorus compound represented by Formula (5) is generally about 0.5 to 20 mol, and preferably about 1 to 10 mol, per mol of the compound represented by Formula (4).

Examples of the base include alkyllithiums, such as methyllithium, ethyllithium, n-butyllithium, s-butyllithium, and t-butyllithium; aryllithiums, such as phenyllithium; Grignard regents; and the like. In terms of yield, n-butyllithium, t-butyllithium, s-butyllithium, Grignard regents, etc., are preferred.

In terms of yield, the amount of the base used is generally about 0.5 to 20 mol, and preferably about 1 to 10 mol, per mol of the compound represented by Formula (4).

When a salt of the compound represented by Formula (1) described above is synthesized as the ligand compound of the present invention, it is preferable to also add a salt corresponding to the target salt during the reaction of the compound represented by Formula (4) with the compound represented by Formula (5).

For example, the target salt is a borane salt of the compound represented by Formula (1), it is preferable to use a borane salt, such as dialkyl sulfide borane (e.g., dimethyl sulfide borane).

When a salt, such as a borane salt, is used, the amount of the base is generally about 0.5 to 20 mol, and preferably about 1 to 10 mol, per mol of the compound represented by Formula (4), in terms of yield.

This reaction can be generally performed in a solvent. Examples of solvents include linear ethers, such as diethyl ether, dimethoxyethane, diisopropyl ether, and tert-butyl methyl ether; cyclic ethers, such as tetrahydrofuran and dioxane; aromatic hydrocarbons, such as toluene, xylene, benzene, and mesitylene; and aliphatic hydrocarbons, such as pentane, hexane, heptane, and cyclohexane. These may be used singly or in a combination of two or more. Preferred among these in the present invention are linear ethers, and particularly preferred is diethyl ether.

The reaction is carried out in such a manner that the compound represented by Formula (4) is reacted with a base at about −150 to 0° C. (particularly about −100 to −50° C.) for about 1 to 60 minutes (particularly about 5 to 30 minutes), and then the phosphorus compound represented by Formula (5) is added thereto at about −150 to 0° C. (particularly about −100 to −50° C.) and reacted for about 1 to 60 minutes (particularly about 5 to 30 minutes). Further, if necessary, a salt, such as a borane salt, may be added at about −150 to 0° C. (particularly about −100 to −50° C.), and reacted for about 1 to 120 minutes (particularly about 5 to 60 minutes). This reaction is preferably performed under anhydrous conditions and in an inert gas atmosphere (nitrogen gas, argon gas, etc.). This treatment may be repeated several times.

The completion of the reaction is followed by general isolation and purification processes, thereby obtaining the ligand compound of the present invention represented by Formula (1) or a salt thereof.

### Synthesis of (1)->(2)

The ligand compound of the present invention represented by Formula (1) or a salt thereof can be reacted with a nickel (Ni) compound to thereby produce a nickel complex represented by Formula (2) (nickel complex of the present invention).

The nickel (Ni) compound is not particularly limited. Examples thereof include NiCl₂, NiF₂, NiBr₂, NiI₂, Ni(BF₄)₂.6H₂O, Ni(OAc)₂.4H₂O, Ni(acac)₂, NiCl₂(PPh₃)₂, NiBr₂(PPh₃)₂, Ni(CO)₂(PPh₃)₂, NiCl₂(PCy₃)₂, and other nickel compounds (in these examples, Ac is acetyl, acac is acetylacetonate, Ph is phenyl, and Cy is cyclohexyl; hereinafter the same).

The amount of the nickel (Ni) compound used is generally about 0.1 to 5 mol, preferably about 0.2 to 3 mol, and more preferably about 0.5 to 2 mol, per mol of the ligand compound of the present invention represented by Formula (1) or a salt thereof.

When a salt is used as the ligand compound of the present invention represented by Formula (1) or a salt thereof, it is preferable to mix the salt with a base before reaction with a nickel (Ni) compound.

The base that can be used in this case is not particularly limited. Examples thereof include alkyllithiums, such as methyllithium, ethyllithium, n-butyllithium, s-butyllithium, and t-butyllithium; aryllithiums, such as phenyllithium; Grignard regents; amines, such as diisopropylethylamine, tributylamine, morpholine, and N-methylmorpholine; and the like. In terms of yield, amines are preferred; and morpholine, N-methylmorpholine, etc., are more preferred. In addition, a liquid base is preferably used because it can also be used as a solvent.

The amount of the base used in this case is generally about 0.1 to 5 mol, preferably about 0.2 to 3 mol, and more preferably about 0.5 to 2 mol, per mol of the ligand compound of the present invention represented by Formula (1) or a salt thereof. When a liquid base is used as the base, the amount thereof may be determined so that the ligand compound represented by Formula (1) is dissolved.

A solvent may be used in this reaction. Examples of solvents include linear ethers, such as diethyl ether, dimethoxyethane, diisopropyl ether, and tert-butyl methyl ether; cyclic ethers, such as tetrahydrofuran and dioxane; aromatic hydrocarbons, such as toluene, xylene, benzene, and mesitylene; aliphatic hydrocarbons, such as pentane, hexane, heptane, and cyclohexane; and the like. These may be used singly or in a combination of two or more.

This reaction can be performed under anhydrous conditions and in an inert gas atmosphere (nitrogen gas, argon gas, etc.) at about 25 to 200° C. (particularly about 50 to 150° C.).

The completion of the reaction is followed by general isolation and purification processes, thereby obtaining the nickel complex represented by Formula (2) (nickel complex of the present invention).

### 2. Method for Producing Aryl(Thio)Carbonyl Compound and Coupling Method

The nickel complex (catalyst) of the present invention is useful as a catalyst for effective coupling reaction of carbonyl or thiocarbonyl compounds with a phenol derivative to obtain aryl(thio)carbonyl compounds (particularly α-aryl(thio)carbonyl compounds). In the present specification, aryl(thio)carbonyl compounds mean arylcarbonyl compounds or arylthiocarbonyl compounds, and α-aryl(thio)carbonyl compounds mean α-arylcarbonyl compounds or α-arylthiocarbonyl compounds.

Due to its high catalytic activity, the nickel complex (catalyst) of the present invention can promote the coupling reaction of carbonyl or thiocarbonyl compounds and a phenol derivative using various substrates as a starting material, thereby obtaining various arylcarbonyl compounds (particularly α-arylcarbonyl compounds) or arylthiocarbonyl compounds (particularly α-arylthiocarbonyl compounds).

In the present invention, when a specific nickel complex (a nickel compound) is also used in addition to the nickel complex of the present invention, the coupling reaction of carbonyl or thiocarbonyl compounds with a phenol derivative can be promoted using various substrates as a starting material, thereby obtaining various arylcarbonyl compounds (particularly α-arylcarbonyl compounds) or arylthiocarbonyl compounds (particularly α-arylthiocarbonyl compounds).

In this coupling reaction, a carbonyl or thiocarbonyl compound is generally reacted with a phenol derivative in the presence of a specific nickel complex (catalyst), thereby obtaining an arylcarbonyl compound (particularly α-arylcarbonyl compound) or arylthiocarbonyl compound (α-arylthiocarbonyl compound). Specifically, a carbonyl or thiocarbonyl compound is reacted with a phenol derivative in a solvent in the presence of a specific nickel complex (nickel compound) and base, thereby obtaining an arylcarbonyl compound (particularly α-arylcarbonyl compound) or arylthiocarbonyl compound (particularly α-arylthiocarbonyl compound).

Although the phenol derivative to be subjected to the reaction is not particularly limited, an example thereof is a compound represented by Formula (7):

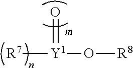

wherein Y¹ is carbon, phosphorus, or sulfur; R⁷ is the same or different, and each is optionally substituted alkyl, optionally substituted alkoxy, optionally substituted aryl, optionally substituted aryloxy, or optionally substituted amino; R⁸ is optionally substituted aryl or optionally substituted heteroaryl; n is 1 when Y¹ is carbon or sulfur, and n is 2 when Y¹ is phosphorus; and m is 1 when Y¹ is carbon or phosphorus, and m is 2 when Y¹ is sulfur.

In Formula (7), Y¹ is carbon, phosphorus, or sulfur; carbon is preferred in terms of the yield of arylation (particularly α-arylation).

Examples of the alkyl group represented by R⁷ in Formula (7) include linear or branched C₁₋₆ alkyl, preferably C₁₋₄ alkyl. Specific examples thereof include methyl, ethyl, n-propyl, isopropyl, n-butyl, isobutyl, sec-butyl, tert-butyl, pentyl, hexyl, and the like. Examples of alkyl substituents include halogen (e.g., fluorine and chlorine). The number of substituents is not particularly limited, but is preferably 0 to 6, and more preferably 0 to 3.

Examples of the alkoxy group represented by R⁷ in Formula (7) include linear or branched C₁₋₆ alkoxy, preferably C₁₋₄ alkoxy. Specific examples thereof include methoxy, ethoxy, n-propoxy, isopropoxy, n-butoxy, isobutoxy, sec-butoxy, tert-butoxy, pentoxy, and hexoxy. Examples of alkoxy substituents include halogen (e.g., fluorine and chlorine). The number of substituents is not particularly limited, but is preferably 0 to 6, and more preferably 0 to 3.

Examples of the aryl group represented by R⁷ in Formula (7) include phenyl, naphthyl, anthracenyl, biphenyl, and the like. Examples of aryl substituents include halogen (e.g., fluorine and chlorine), alkyl (e.g., C₁₋₄ alkyl, such as methyl and ethyl), haloalkyl (e.g., C₁₋₄ haloalkyl, such as trifluoromethyl), alkoxy (C₁₋₄ alkoxy, such as methoxy), a group represented by —COOR (R is alkyl, such as methyl or ethyl), and the like. The number of substituents is not particularly limited, but is preferably 0 to 6, and more preferably 0 to 3.

Moreover, the aryl may be the following:

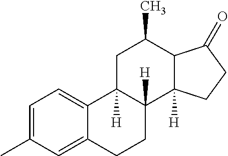

The aryl substituent may be the following:

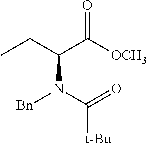

wherein Bn is benzyl, and t-Bu is tert-butyl; hereinafter the same.

Examples of the aryloxy group represented by R⁷ in Formula (7) include phenyloxy, naphthyloxy, anthracenyloxy, biphenyloxy, and the like. Examples of aryloxy substituents include halogen (e.g., fluorine and chlorine), alkyl (e.g., C₁₋₄ alkyl, such as methyl and ethyl), haloalkyl (e.g., C₁₋₄ haloalkyl, such as trifluoromethyl), alkoxy (C₁₋₄ alkoxy, such as methoxy), a group represented by —COOR (R is alkyl, such as methyl or ethyl), and the like. The number of substituents is not particularly limited, but is preferably 0 to 6, and more preferably 0 to 3.

Although the amino group represented by R⁷ in Formula (7) may be either substituted amino or unsubstituted amino, substituted amino is preferred. Examples of amino substituents include halogen (e.g., fluorine and chlorine), alkyl (e.g., C₁₋₄ alkyl, such as methyl and ethyl), haloalkyl (e.g., C₁₋₄ haloalkyl, such as trifluoromethyl), alkoxy (C₁₋₄ alkoxy, such as methoxy), a group represented by —COOR (R is alkyl, such as methyl or ethyl), and the like. The number of substituents is not particularly limited, but is preferably 0 to 2.

In Formula (7), R⁷ is preferably optionally substituted alkyl, optionally substituted alkoxy, optionally substituted amino, or the like, in terms of the yield of arylation (particularly α-arylation) of carbonyl or thiocarbonyl compounds using a phenol derivative. Preferred specific examples of R⁷ in Formula (7) vary depending on the type of carbonyl or thiocarbonyl compound, which is the coupling partner. For example, when the carbonyl or thiocarbonyl compound is a ketone (including cyclic ketones) or amide (including cyclic amides), R⁷ is preferably optionally substituted alkyl (particularly unsubstituted alkyl); and when the carbonyl or thiocarbonyl compound is an ester (including cyclic esters), R⁷ is preferably optionally substituted amino (particularly substituted amino).

Examples of the aryl group represented by R⁸ in Formula (7) include those mentioned above as examples of R⁷ in Formula (7). Preferred specific examples, the type of possible substituents, and the number of substituents are also the same as above.

Examples of the heteroaryl group represented by R⁸ in Formula (7) include pyridyl, furanyl, thiophenyl, indolyl, quinolyl, and the like. Examples of heteroaryl substituents include halogen (e.g., fluorine and chlorine), alkyl (e.g., C₁₋₄ alkyl, such as methyl and ethyl), haloalkyl (e.g., C₁₋₄ haloalkyl, such as trifluoromethyl), alkoxy (C₁₋₄ alkoxy, such as methoxy), a group represented by —COOR (R is alkyl, such as methyl or ethyl), and the like. The number of substituents is not particularly limited, but is preferably 0 to 5, and more preferably 0 to 3.

Moreover, the heteroaryl substituent may be the following:

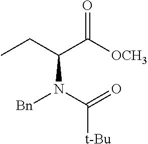

In Formula (7), R⁸ is preferably optionally substituted aryl in terms of the yield of arylation (particularly α-arylation) of carbonyl or thiocarbonyl compounds using a phenol derivative.

In Formula (7), n varies depending on the type of Y¹; n is 1 when Y¹ is carbon or sulfur, and n is 2 when Y¹ is phosphorus.

In Formula (7), m varies depending on the type of Y¹; m is 1 when Y¹ is carbon or phosphorus, and m is 2 when Y¹ is sulfur.

The phenol derivative as a substrate that satisfies such conditions is preferably a compound represented by Formula (7A):

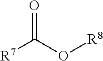

wherein R⁷ and R⁸ are the same as above;
and more preferably a compound represented by Formula (7A1):

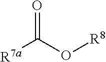

wherein R^{7a} is optionally substituted alkyl, and R⁸ is the same as above.

Examples of the phenol derivative as a substrate that satisfies such conditions include the following:

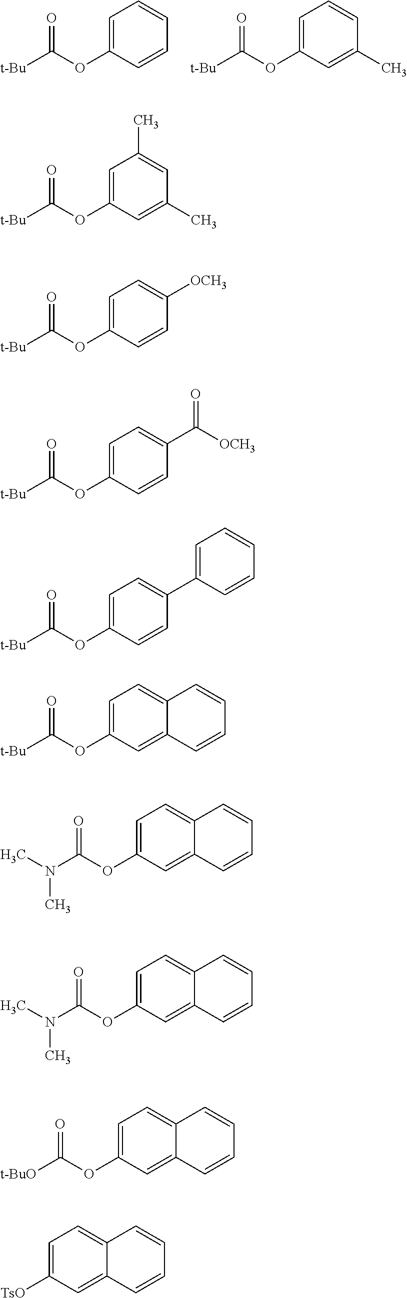

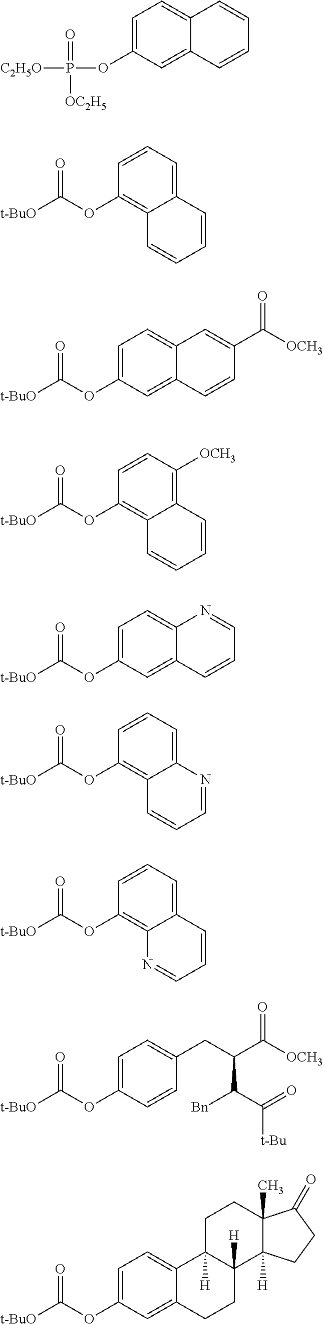

wherein Ts is tosyl; hereinafter the same.

Although the carbonyl or thiocarbonyl compound to be subjected to the reaction is not particularly limited, an example thereof is a compound represented by Formula (6):

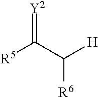

wherein R⁵ is optionally substituted alkyl, optionally substituted alkoxy, optionally substituted aryl, optionally substituted heteroaryl, or optionally substituted amino; R⁶ is hydrogen, optionally substituted alkyl, or optionally substituted aryl; Y² is oxygen or sulfur; and R⁵ and R⁶ may be bonded to each other to form a ring with the adjacent —C—C—.

In Formula (6), Y² may be either oxygen or sulfur; however, oxygen is preferred in terms of the yield of arylation (particularly α-arylation) of carbonyl or thiocarbonyl compounds using a phenol derivative.

Examples of the alkyl group represented by R⁵ in Formula (6) include those mentioned above as examples of R⁷ in Formula (7). Preferred specific examples, the type of possible substituents, and the number of substituents are also the same as above. Linear or branched C₁₋₆ alkyl, particularly C₁₋₄ alkyl, is preferred.

Examples of the alkoxy group represented by R⁵ in Formula (6) include those mentioned above as examples of R⁷ in Formula (7). Preferred specific examples, the type of possible substituents, and the number of substituents are also the same as above. Linear or branched C₁₋₆ alkoxy, particularly C₁₋₄ alkoxy, is preferred.

Examples of the aryl group represented by R⁵ in Formula (6) include those mentioned above as examples of R⁷ in Formula (7). Preferred specific examples, the type of possible substituents, and the number of substituents are also the same as above.

Examples of the heteroaryl group represented by R⁵ in Formula (6) include those mentioned above as examples of R⁸ in Formula (7). Preferred specific examples, the type of possible substituents, and the number of substituents are also the same as above.

Examples of the amino group represented by R⁵ in Formula (6) include those mentioned above as examples of R⁷ in Formula (7). Preferred specific examples, the type of possible substituents, and the number of substituents are also the same as above. Substituted amino is preferred.

In terms of the yield of arylation (particularly α-arylation) of carbonyl or thiocarbonyl compounds using a phenol derivative, R⁵ in Formula (6) is preferably optionally substituted alkyl, optionally substituted alkoxy, optionally substituted aryl, optionally substituted heteroaryl, optionally substituted amino, and the like; more preferably optionally substituted alkyl, optionally substituted aryl, optionally substituted heteroaryl, and the like; even more preferably optionally substituted aryl, optionally substituted heteroaryl, and the like; and particularly preferably optionally substituted aryl.

Examples of the alkyl group represented by R⁶ in Formula (6) include those mentioned above as examples of R⁷ in Formula (7). Preferred specific examples, the type of possible substituents, and the number of substituents are also the same as above. Linear or branched C₁₋₆ alkyl, particularly C₁₋₄ alkyl, is preferred.

Examples of the aryl group represented by R⁶ in Formula (6) include those mentioned above as examples of R⁷ in Formula (7). Preferred specific examples, the type of possible substituents, and the number of substituents are also the same as above.

In Formula (6), R⁵ is preferably optionally substituted aryl, in terms of the yield of arylation (particularly α-arylation) of carbonyl or thiocarbonyl compounds using a phenol derivative.

Moreover, in Formula (6), R⁵ and R⁶ may be bonded to each other to form a ring with the adjacent —C—C—. Examples of the ring formed in this case include a benzene ring, a pyrrolidine ring, a naphthalene ring, an indole ring, and the like. The ring may be further substituted. Examples of substituents include oxo (═O), halogen (e.g., fluorine and chlorine), alkyl (e.g., C₁₋₄ alkyl, such as methyl and ethyl), haloalkyl (e.g., C₁₋₄ haloalkyl, such as trifluoromethyl), alkoxy (C₁₋₄ alkoxy, such as methoxy), aryl (phenyl, naphthyl, etc.), a group represented by —COOR (R is alkyl, such as methyl or ethyl), and the like. The number of substituents is not particularly limited, but is preferably 0 to 6, and more preferably 0 to 3.

The (thio)carbonyl compound (carbonyl or thiocarbonyl compound) as a substrate that satisfies such conditions is preferably a compound represented by Formula (6A):

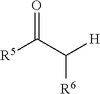

wherein R⁵ and R⁶ are the same as above;
and more preferably a compound represented by Formula (6A1):

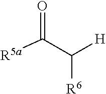

wherein R^{5a} is optionally substituted alkyl, optionally substituted aryl, or optionally substituted heteroaryl; and R⁶ is hydrogen, optionally substituted alkyl, or optionally substituted aryl.

Examples of the (thio)carbonyl compound (carbonyl or thiocarbonyl compound) as a substrate that satisfies such conditions include the following:

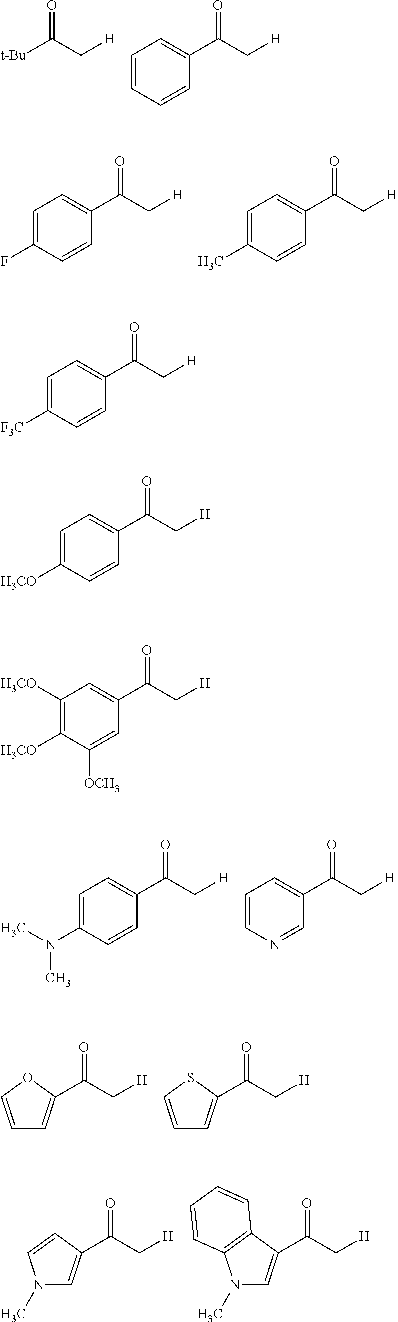

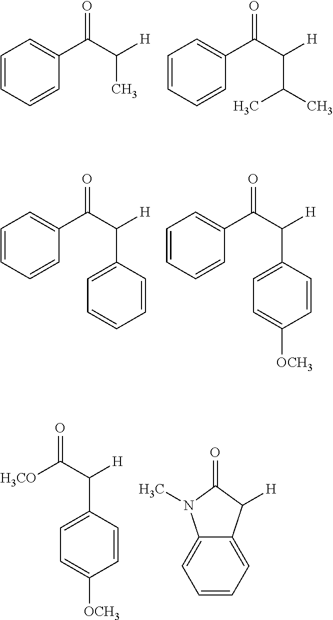

Although the amount of the (thio)carbonyl compound (carbonyl or thiocarbonyl compound) used is not particularly limited, for example, the amount is generally preferably about 0.1 to 10 mol, more preferably about 0.5 to 5 mol, and even more preferably about 1 to 3 mol, per mol of the phenol derivative.

As the nickel complex (catalyst), any of the above nickel complexes (catalysts) of the present invention can be preferably used.

Other preferred examples of the nickel complex (catalyst) include nickel compounds having a monodentate or bidentate dialkylphosphine and/or dicycloalkylphosphine skeleton (more preferably nickel compounds having a bidentate dialkylphosphine and/or dicycloalkylphosphine skeleton, particularly preferably nickel compounds having a bidentate dicycloalkylphosphine skeleton).

The nickel complex (catalyst) is preferably a compound represented by Formula (3):

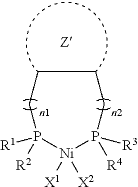

wherein Z′ may or may not form a ring; when Z′ forms a ring, Z′ is an aromatic hydrocarbon ring or a five- or six-membered heterocyclic ring; R¹ to R⁴, and X¹ and X² are the same as above; n1 and n2 are the same or different, and each is an integer of 0 to 2; and the solid lines connecting a nickel atom and two phosphorus atoms, and the solid lines connecting the nickel atom and X¹ and X² are coordinate bonds.

It is generally considered that the nickel atom and the two phosphorus atoms form coordinate bonds; however, in Formula (3), the coordinate bonds are illustrated by solid lines for convenience.

In Formula (3), Z′ may or may not form a ring.

In Formula (3), when Z′ forms an aromatic hydrocarbon ring, the ring is not particularly limited. Examples thereof include a benzene ring, a naphthalene ring, an anthracene ring, and the like. Examples of aromatic hydrocarbon ring substituents include halogen (e.g., fluorine and chlorine), alkyl (e.g., C₁₋₄ alkyl, such as methyl and ethyl), haloalkyl (e.g., C₁₋₄ haloalkyl, such as trifluoromethyl), alkoxy (C₁₋₄ alkoxy, such as methoxy), a group represented by —COOR (R is alkyl, such as methyl or ethyl), and the like. The number of substituents is not particularly limited, but is preferably 0 to 6, and more preferably 0 to 3.

In Formula (3), when Z′ forms a heterocyclic ring, examples of the ring include those mentioned above as examples of Z in Formula (1). Preferred specific examples, the type of possible substituents, and the number of substituents are also the same as above. A thiophene ring is preferred, and an unsubstituted thiophene ring is more preferred.

In Formula (3), when Z′ does not form a ring, nothing is present in the Z′ portion. This indicates a compound represented by Formula (3A):

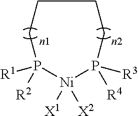

wherein R¹ to R⁴ are the same or different, and each is optionally substituted alkyl or optionally substituted cycloalkyl; X¹ and X² are the same or different, and each is a ligand; n1 and n2 are the same or different, and each is an integer of 0 to 2; and the solid lines connecting a nickel atom and two phosphorus atoms, and the solid lines connecting the nickel atom and X¹ and X² are coordinate bonds.

Examples of R¹ to R⁴ in Formula (3) include those mentioned above as examples of R¹ to R⁴ in Formula (1). Preferred specific examples, the type of possible substituents, and the number of substituents are also the same as above. C₄₋₆ cycloalkyl is particularly preferred.

Examples of X¹ and X² in Formula (3) include those mentioned above as examples of X¹ and X² in Formula (2). Preferred specific examples are also the same as above.

In Formula (3), n1 and n2 are each an integer of 0 to 2; 0 or 1 is preferred in terms of yield.

Examples of the nickel complex (catalyst) that satisfies such conditions include the following:

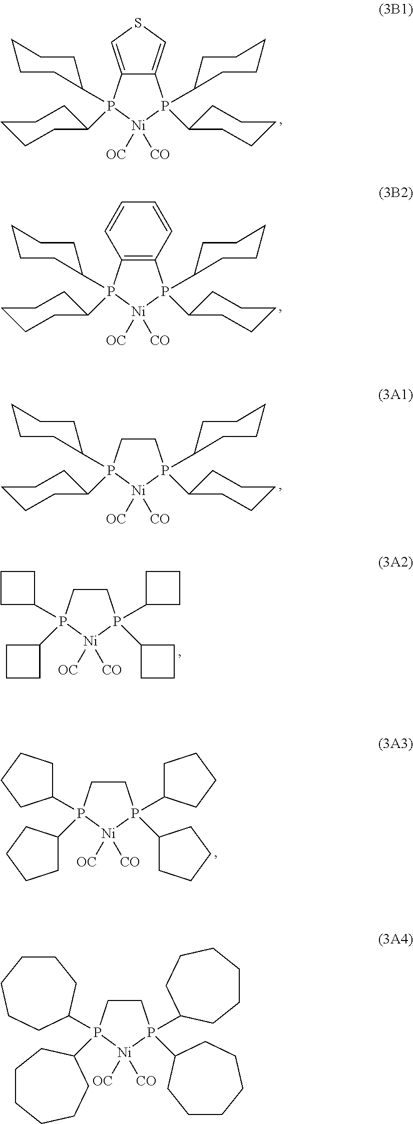

wherein the solid lines connecting a nickel atom and two phosphorus atoms, and the solid lines connecting the nickel atom and two COs are coordinate bonds.

Among the above nickel complexes (catalysts), the nickel complex (3B1) is the nickel complex (catalyst) of the present invention using the ligand compound of the present invention.

The nickel complex (3B2) may be synthesized in the same manner as in the reaction scheme mentioned above, except that the compound represented by Formula (4) used as a starting material for producing a ligand compound is a compound wherein Z is substituted with a benzene ring (dihalobenzene, such as dibromobenzene). Alternatively, a known or commercially available nickel complex may be used.

The nickel complexes (3A1) to (3A4) may be synthesized by, for example, reacting bis(dihalophosphino)alkane (1,2-bis(dihalophosphino)alkane, such as 1,2-bis(dichlorophosphino)ethane) with a Grignard regent having a cycloalkyl group (cycloalkyl magnesium bromide, such as cyclohexyl magnesium bromide), and further reacting a salt such as a borane salt (e.g., dimethylsulfide borane), if necessary. Alternatively, known or commercially available nickel complexes may be used.

Among these nickel complexes (catalysts), more preferred in terms of storage stability is a compound represented by Formula (3B):

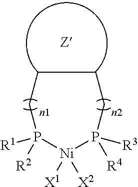

wherein Z′ is an aromatic hydrocarbon ring or a five- or six-membered heterocyclic ring; R¹ to R⁴, X¹ and X², and n1 and n2 are the same as above; and the solid lines connecting a nickel atom and two phosphorus atoms, and the solid lines connecting the nickel atom and X¹ and X² are coordinate bonds;
and particularly preferred in terms of yield is the nickel complex (catalyst) of the present invention represented by Formula (2). The most preferred is the nickel complex (3B1).

The nickel complex (catalyst) may be synthesized in advance or may be synthesized in the system. More specifically, when the above coupling reaction is initiated, the nickel complex (catalyst) may be added, or a ligand compound and a nickel compound may be added. Moreover, the above nickel complexes (catalysts) may be used singly or in a combination of two or more.

The amount of the nickel complex (catalyst) used can be suitably selected depending on the type of substrate (the number of reactive sites, the oxidation state, etc.). For example, the amount is generally preferably about 0.01 to 1 mol, more preferably about 0.02 to 0.5 mol, and even more preferably about 0.05 to 0.3 mol, per mol of the phenol derivative as the substrate. When the nickel complex (catalyst) is synthesized in a system, it is preferable to adjust the amount of the nickel complex (catalyst) present in the system within the above range.

The base is used to remove the proton (H) from the carbonyl or thiocarbonyl compound and form an active species.

Examples of the base include alkali metal phosphates, such as potassium phosphate and sodium phosphate; alkali metal carbonates, such as cesium carbonate and rubidium carbonate; alkali metal hydrides, such as lithium hydride (LiH) and sodium hydride (NaH); alkaline earth metal hydrides, such as calcium hydride (CaH₂); metal amides (particularly alkali metal amides), such as lithium diisopropylamide (LDA), lithium bis-trimethylsilylamide, sodium bis-trimethylsilylamide, and potassium bis-trimethylsilylamide; alkali metal alkoxides, such as sodium methoxide, sodium ethoxide, sodium t-butoxide, potassium t-butoxide, lithium t-butoxide, and sodium adamantoxide; alkali metal phenoxides, such as sodium phenoxide; aryllithiums, such as phenyllithium; Grignard regents; and the like. Among these, preferred in terms of yield are alkali metal phosphates and alkali metal carbonates; more preferred are potassium phosphate, sodium phosphate, cesium carbonate, rubidium carbonate, etc.; even more preferred are potassium phosphate, cesium carbonate, etc.; and particularly preferred is potassium phosphate.

The amount of the base used is generally preferably 1 to 50 mol, more preferably 2 to 30 mol, and even more preferably 3 to 20 mol, per mol of the nickel complex (catalyst).

Examples of solvents include linear ethers, such as diethyl ether, dimethoxyethane, diisopropyl ether, and tert-butyl methyl ether; cyclic ethers, such as dioxane; aromatic hydrocarbons, such as toluene, benzene, and mesitylene; aliphatic hydrocarbons, such as pentane, hexane, heptane, and cyclohexane; and the like. These may be used singly or in a combination of two or more. Preferred among these in the present invention are cyclic ethers and aromatic hydrocarbons; more preferred are dioxane, toluene, and benzene; and particularly preferred is toluene.

The coupling reaction of the present invention is preferably performed under anhydrous conditions and in an inert gas atmosphere (nitrogen gas, argon gas, etc.). The reaction temperature is generally about 0 to 200° C., preferably about 10 to 180° C., and more preferably about 20 to 160° C. The reaction time is generally about 10 minutes to 72 hours, and preferably about 1 to 48 hours.

The coupling reaction of the present invention is a new type of coupling reaction in which two molecules are coupled while breaking the carbon-hydrogen bond of a carbonyl or thiocarbonyl compound (particularly the carbon-hydrogen bond at the α-position of a carbonyl or thiocarbonyl compound) and the carbon-oxygen bond of a phenol derivative (particularly the bond between carbon present in the benzene ring and oxygen directly bonded to the carbon).

The completion of the reaction is followed by general isolation and purification processes, thereby obtaining an arylcarbonyl compound or arylthiocarbonyl compound. Various useful arylcarbonyl compounds or arylthiocarbonyl compounds can be obtained by using this coupling reaction, and natural products having a complicated structure can also be easily synthesized.

Among the compounds obtained in this manner, the following compounds:

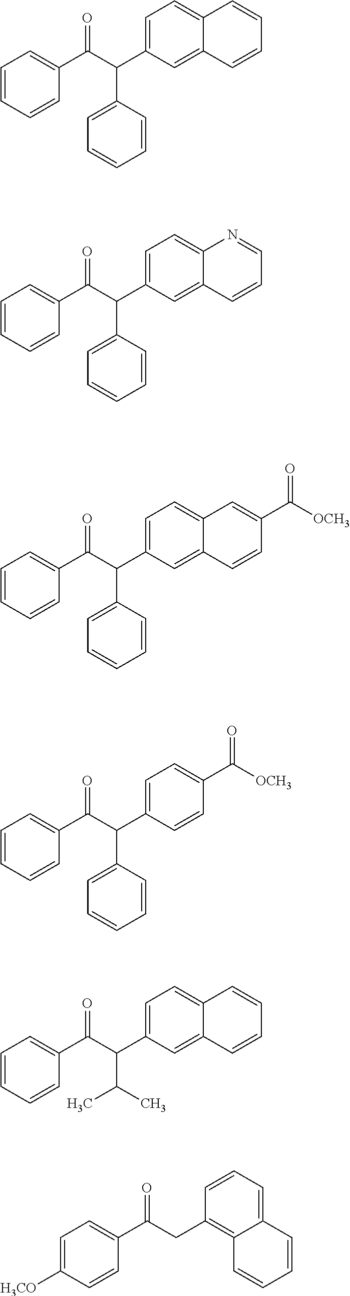 [SMILES: O=C(c1ccccc1)C(c1ccccc1)c1ccc2ccccc2c1 ; O=C(c1ccccc1)C(c1ccccc1)c1ccc2ncccc2c1 ; COC(=O)c1ccc2cc(C(C(=O)c3ccccc3)c3ccccc3)ccc2c1 ; COC(=O)c1ccc(C(C(=O)c2ccccc2)c2ccccc2)cc1 ; CC(C)C(C(=O)c1ccccc1)c1ccc2ccccc2c1 ; COc1ccc(C(=O)Cc2cccc3ccccc23)cc1]

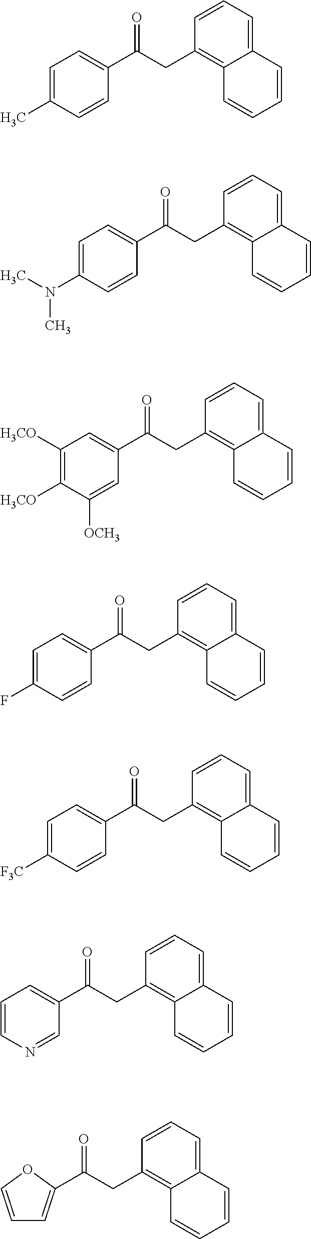

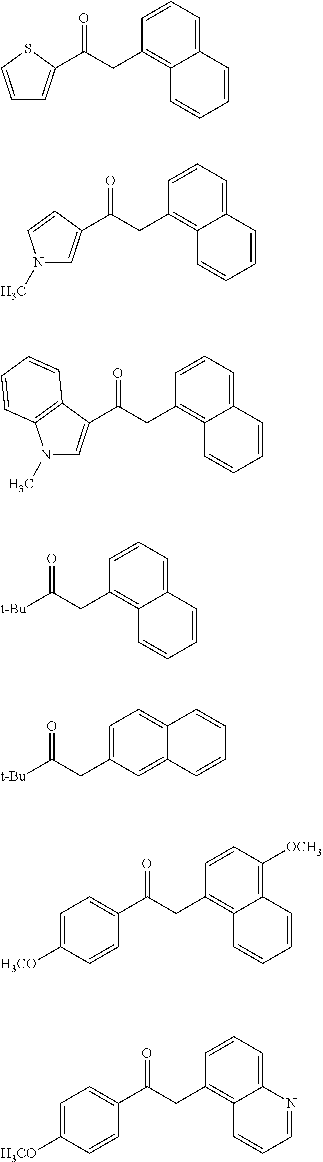

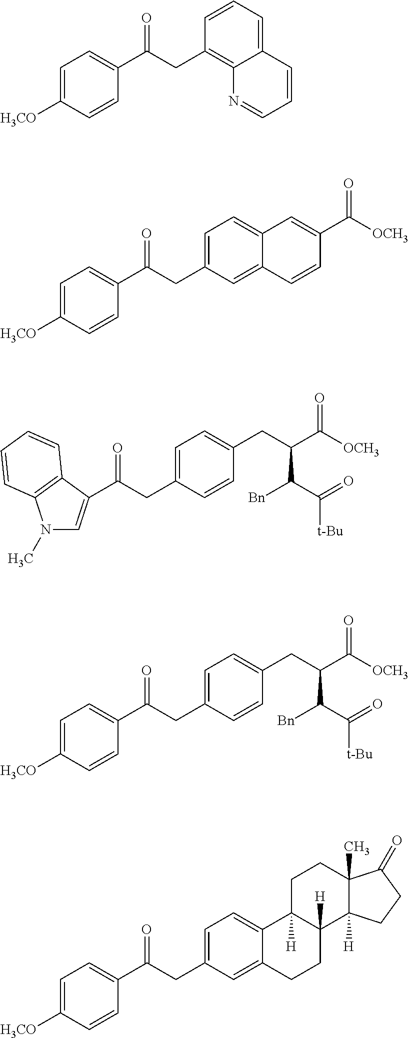

are novel compounds that have not been disclosed in any documents.

### 3. Reaction Mechanism

As described in the Examples described below, when a nickel complex (catalyst) represented by the following formula:

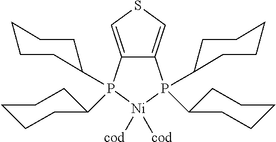

wherein the solid lines connecting a nickel atom and two phosphorus atoms, and the solid lines connecting the nickel atom and two cods are coordinate bonds;
is reacted with a phenol derivative represented by the following formula:

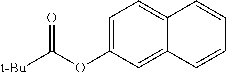 [SMILES: CC(C)(C)C(=O)Oc1ccc2ccccc2c1]

under predetermined conditions, the obtained compound is represented by the following formula:

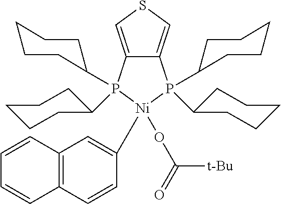

wherein the solid lines connecting a nickel atom and two phosphorus atoms, and the solid lines connecting the nickel atom and a naphthyl group or a pivaloyl group are coordinate bonds.

This suggests that, for example, when potassium phosphate is used as the base, the coupling reaction of the present invention is considered to undergo the following reaction mechanism:

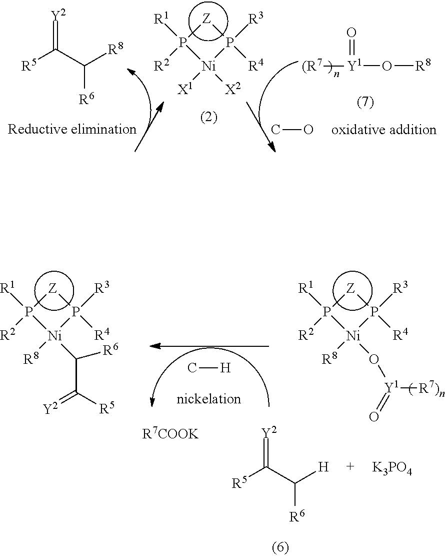

wherein the solid lines connecting a nickel atom and two phosphorus atoms, and the solid lines connecting the nickel atom and X¹, X², —CR⁶CY²R⁵, —OY¹O(R⁷)n, or R⁸ are coordinate bonds.

### EXAMPLES

The present invention is described in detail below with reference to Examples; however, the present invention is not limited to these Examples.

Unless otherwise specified, unmodified commercial products were used for all materials, including dry solvents. Bis(1,5-cyclooctadiene)nickel(0) (Ni(cod)₂) was purchased from Kanto Chemical Co., Inc., and K₃PO₄ was purchased from Wako Pure Chemical Industries, Ltd. 1,2-Bisdicyclohexylphosphinoethane (dcype; nickel complex 3a′) was purchased from Sigma-Aldrich Co. LLC. Unless otherwise noted, all reactions were performed under argon atmosphere using a dry solvent in a glass vessel dried using standard vacuum line technique. All C—H bond arylation reactions were performed while heating in an oil bath (containing a heater and a magnetic stirrer) using a 20-mL glass vessel tube equipped with a J. Young (registered trademark) O-ring tap. All post-treatment and purification procedures were performed in air using reagent grade solvents.

Thin layer chromatography (TLC) for analysis was performed using E. Merck silica gel 60 F254 precoated plates (0.25 mm). The developed chromatogram was analyzed under a UV lamp (254 nm). Flash column chromatography was performed using E. Merck silica gel 60 (230-400 mesh). Preparative thin-layer chromatography (PTLC) was performed using Wako-gel B5-F silica-coated plates (0.75 mm) prepared in advance. Gas chromatography (GC) was performed using dodecane as the internal standard, and using a Shimadzu GC-2010 instrument equipped with an HP-5 column (30 m×0.25 mm, produced by Hewlett-Packard). GCMS analysis was performed using a Shimadzu GCMS-QP2010 equipped with a RESTEC-5HT column (30 m×0.25 mm, produced by Hewlett Packard). Infrared spectra were recorded with a JASCO FTIR-6100 spectrometer. Nuclear magnetic resonance (NMR) spectra were recorded with a JEOL JNM-ECA-600 spectrometer CH 600 MHz, ¹³C 150 MHz, ³¹P 243 MHz) and a JEOL JNM-ECA-400 spectrometer CH 400 MHz, ¹³C 100 MHz, ³¹P 162 MHz). ¹H NMR chemical shifts were given in parts per million (ppm) relative to tetramethylsilane (δ0.00 ppm), the residual benzene peak (δ7.16 ppm), or CD₂Cl₂ (δ5.32 ppm). ¹³C NMR chemical shifts were given in parts per million (ppm) relative to CDCl₃ (δ77.0 ppm), benzene (δ128.1 ppm), or CD₂Cl₂ (δ53.8 ppm). High-resolution mass spectra were measured with a Thermo Fisher Scientific Exactive. The data are reported in the order of chemical shifts, multiplicity (s=singlet, d=doublet, dd=doublet of doublet, t=triplet, q=quartet, m=multiplet, br=broad signal), coupling constants (Hz), and integration.

### Synthesis Example 1

### Synthesis of Phenol Derivatives

### Synthesis Example 1-1

### Phenol Derivatives 2a to 2f, 2h to 2j, and 2n to 2t

The compounds shown in the following were obtained by using the methods described the documents listed below.
2a, 2c, 2e, 2h, 2i: J. Am. Chem. Soc., 2008, 130, pp. 14422-14423
2b, 2j: J. Am. Chem. Soc., 2012, 134, pp. 169-172
2d: T. Bull. Chem. Soc. Jpn., 2004, 77, pp. 569-574
2f: Tetrahedron, 2005, 61, pp. 6652-6656
2n: J. Org. Chem., 2006, 71, pp. 5785-5788
2o: J. Am. Chem. Soc., 2009, 131, pp. 17748-17749
2p: J. Am. Chem. Soc., 2008, 130, pp. 13848-13849
2q: Synth. Commun., 1997, 27, pp. 3035
2r: J. Phys. Org. Chem., 2011, 24, pp. 1081-1087
2s: J. Am. Chem. Soc., 2012, 134, pp. 8298-8301
2t: Tetrahedron, 2002, 58, pp. 2965-2972

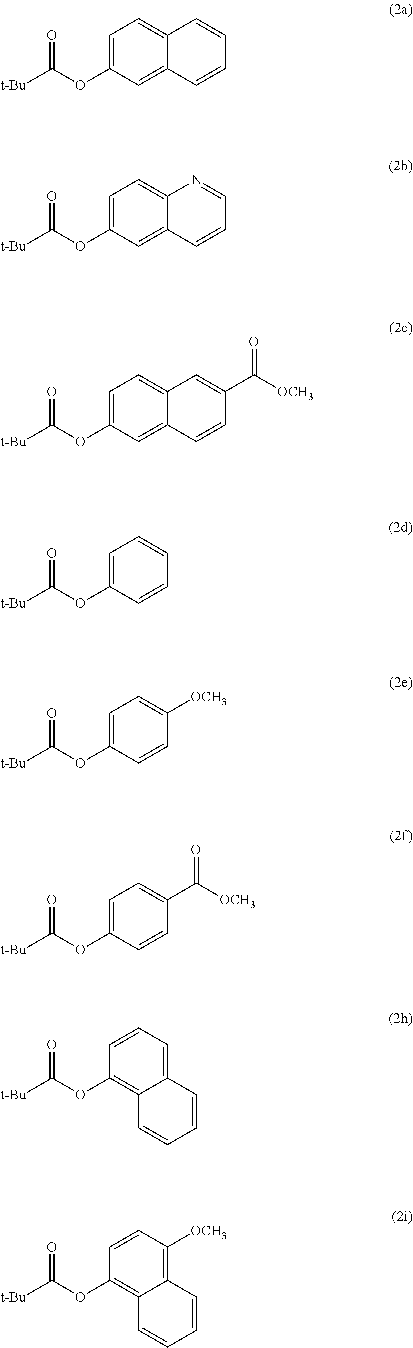

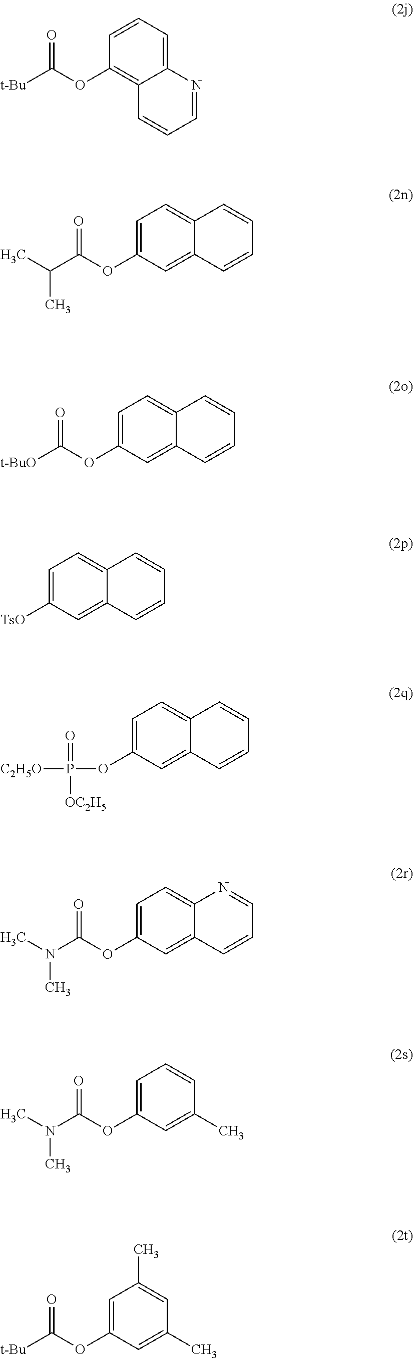

### Synthesis Example 1-2

### Phenol Derivative 2k

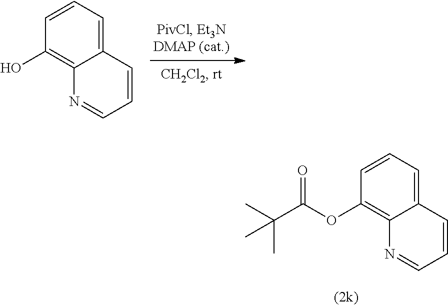 [SMILES: Oc1cccc2cccnc12 ; CC(C)(C)C(=O)Oc1cccc2cccnc12]

wherein Piv is pivaloyl, and DMAP is 4,4-dimethylaminopyridine; hereinafter the same.

Triethylamine (1.84 mL, 13.2 mmol, 1.2 equivalents) was added to a CH₂Cl₂ (20 mL) solution of 8-quinolinol (1.60 g, 11 mmol) and a small amount of 4,4-dimethylaminopyridine (DMAP) at room temperature. Then, pivaloyl chloride (1.62 mL, 13.2 mmol, 1.2 equivalents) was added dropwise at 0° C. for 3 minutes. After stirring for 15 minutes, the reaction mixture was quenched with a saturated aqueous NaHCO₃ solution (10 mL), and the layers were separated. The aqueous layer was extracted three times with CH₂Cl₂ (25 mL). The organic layer was dried over Na₂SO₄, followed by filtration. After the solvent was evaporated under reduced pressure, the crude product was purified by flash column chromatography (hexane/ethyl acetate=5:1), thereby obtaining a phenol derivative 2k as a white solid (2.20 g, 96%).

¹H NMR (400 MHz, CDCl₃) δ8.88 (dd, J=4.0, 2.0 Hz, 1H), 8.14 (dd, J=8.0, 1.2 Hz, 1H), 7.70 (d, J=8.0 Hz, 1H), 7.51 (t, J=8.0 Hz, 1H), 7.43-7.37 (m, 2H), 1.51 (s, 9H); ¹³C NMR (100 MHz, CDCl₃) δ 177.5, 150.4, 148.0, 141.5, 135.7, 129.5, 126.1, 125.6, 121.6, 121.2, 39.3, 27.4; HRMS (ESI) m/z calcd for C₁₄H₁₅NO₂⁺ [M+H]⁺: 230.1176. found 230.1170.

### Synthesis Example 1-3

### Phenol Derivatives 2g and 2m

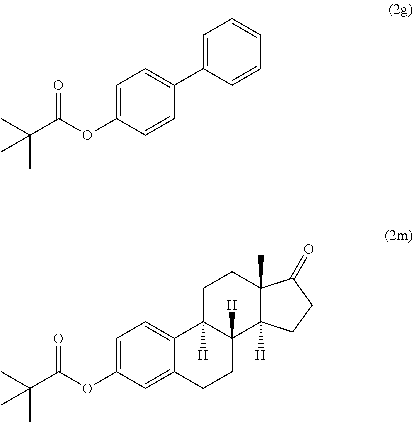

Phenol derivatives 2g (2.77 g, 99%) and 2m (2.05 g, 96%) were obtained in the same manner as in Synthesis Example 1-2, except that suitable materials were used the starting materials, and the crude product was purified by flash column chromatography (hexane/ethyl acetate=10:1). The spectrum data of each compound were as follows:

### Compound 2g

¹H NMR (400 MHz, CDCl₃) δ 7.60-7.54 (m, 4H), 7.46-7.41 (m, 2H), 7.34 (tt, J=7.2, 5.2 Hz, 1H), 7.13 (d, J=8.8 Hz, 1H), 1.38 (s, 9H); ¹³C NMR (100 MHz, CDCl₃) δ 177.1, 150.5, 140.4, 138.7, 128.8, 128.1, 127.3, 127.1, 121.7, 39.1, 27.1; HRMS (ESI) m/z calcd for C₁₇H₁₉O₂⁺ [M+H]⁺: 255.1380. found 255.1369.

### Compound 2m

¹H NMR (600 MHz, CDCl₃) δ 7.28 (d, J=8.4 Hz, 1H), 7.46-7.41 (m, 2H), 7.34 (tt, J=7.2, 1.2 Hz, 1H), 7.13 (d, J=8.8 Hz, 2H), 1.38 (s, 9H); ¹³C NMR (150 MHz, CDCl₃) δ 220.8, 177.3, 149.0, 137.9, 137.1, 126.3, 121.5, 118.6, 50.4, 47.9, 44.1, 39.0, 38.0, 35.9, 31.5, 29.4, 27.1, 26.3, 25.8, 21.6, 13.8; HRMS (ESI) m/z calcd for C₂₃H₃₀NaO₃⁺ [M+Na]⁺: 377.2087. found 377.2077.

### Synthesis Example 1-4

### Phenol Derivative 21

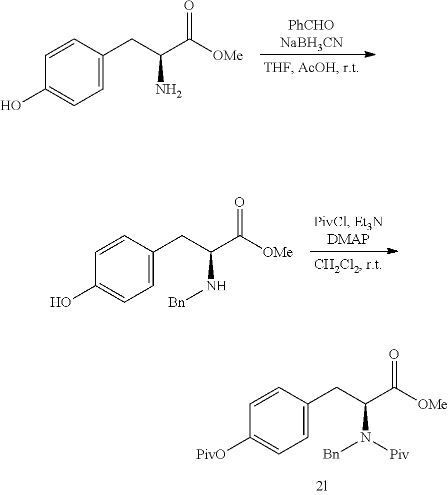

Benzaldehyde (0.76 mL, 7.5 mmol, 1.5 equivalents) was added to a THF (20 mL) solution of L-tyrosine methyl ester (977 mg, 5.0 mmol), sodium boron cyanohydride (471 mg, 7.5 mmol, 1.5 equivalents), and acetic acid (280 μL) at room temperature. After stirring for 1 hour, the reaction mixture was quenched with a saturated aqueous NaHCO₃ solution, extracted with ethyl acetate, and concentrated under reduced pressure. The crude product was purified by flash column chromatography (hexane/ethyl acetate=1:2), thereby obtaining N-benzyl-L-tyrosine methyl ester as a yellow liquid (628.5 mg, 44%).

Triethylamine (1.66 mL, 12 mmol, 6.0 equivalents) was added to a CH₂Cl₂ (8.0 mL) solution of N-benzyl-L-tyrosine methyl ester (571 mg, 2.0 mmol) and a small amount of 4,4-dimethylaminopyridine (DMAP) at room temperature. Then, pivaloyl chloride (1.48 mL, 12 mmol, 6.0 equivalents) was added dropwise at room temperature. After stirring for 24 minutes, the reaction mixture was quenched with a saturated aqueous NaHCO₃ solution, and the layers were separated. The aqueous layer was extracted with CH₂Cl₂. The organic layer was dried over Na₂SO₄, followed by filtration. After the solvent was evaporated under reduced pressure, the crude product was purified by flash column chromatography (hexane/ethyl acetate=3:1), thereby obtaining a phenol derivative 21 as a yellow liquid (867.5 mg, 96%).

¹H NMR (600 MHz, DMSO-d₆, 120° C.) δ 7.31 (dd, J=8.4, 6.6 Hz, 2H), 7.27-7.20 (m, 3H), 7.06 (d, J=7.8 Hz, 2H), 6.96 (d, J=7.8 Hz, 2H), 4.70 (d, J=16.8 Hz, 1H), 4.31 (d, J=16.8 Hz, 1H), 3.96 (t, J=6.6 Hz, 1H), 3.57 (s, 3H), 3.34 (dd, J=14.4, 7.8 Hz, 1H), 3.07 (dd, J=14.4, 7.8 Hz, 1H), 1.33 (s, 9H), 1.27 (s, 9H); ¹³C NMR (150 MHz, DMSO-d₆, 120° C.) δ 176.7, 175.5, 169.7, 149.1, 136.2, 135.2, 129.4, 127.6, 127.1, 126.5, 120.4, 61.2, 51.7, 50.6, 38.2, 37.9, 34.2, 27.7, 26.2; HRMS (ESI) m/z calcd for C₂₇H₃₅NNaO₅[M+Na]⁺: 476.2407. found 476.2396.

### Synthesis Example 1-5

### Phenol Derivative 2u

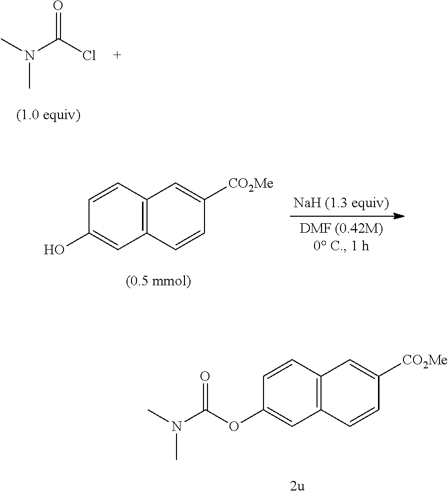

wherein Me is methyl, and DMF is dimethylformamide; hereinafter the same.

Methyl 6-hydroxy-2-naphthoate (1.01 g, 5.00 mmol, 1.0 equivalent) was dissolved in dry DMF (0.42 M) in a round-bottom flask. Sodium hydride (60% oil dispersion, 1.3 equivalents) was added thereto little by little at 0° C., and the mixture was stirred for 30 minutes. Further, dimethylcarbamic acid chloride (1.0 equivalent) was slowly added to the mixture, and the reaction mixture was further stirred at room temperature for 30 minutes. Ice was added to quench the reaction, and the obtained mixture was extracted with ethyl acetate, and washed with 2 M NaOH and brine. The crude product was dried over Na₂SO₄, and the solvent was removed under reduced pressure. The crude mixture was purified by column chromatography (hexane/ethyl acetate=3/1), thereby obtaining methyl 6-(dimethylcarbamoyl)oxy)-2-naphthoate as white crystals (1.18 g, 4.35 mmol, 87%).

Rf=0.43 (hexane/ethyl acetate=2:1); ¹H NMR (400 MHz, CDCl₃): δ 8.59 (s, 1H), 8.05 (dd, J=8.8, 1.6 Hz, 1H), 7.94 (d, J=8.8 Hz, 1H), 7.82 (d, J=8.8 Hz, 1H), 7.62 (d, J=2.4 Hz, 1H), 7.35 (dd, J=8.8, 2.4 Hz, 1H), 3.97 (s, 3H), 3.16 (s, 3H), 3.05 (s, 3H); ¹³C NMR (100 MHz, CDCl₃): δ 167.3, 154.8, 151.2, 136.3, 131.0, 130.8, 130.3, 127.9, 127.1, 125.9, 122.7, 118.5, 52.4, 36.9, 36.7; HRMS (ESI): calculated for C₁₅H₁₆NO₄[M+H]⁺=274.1074. found: 274.1063.

### Synthesis Example 2

### Synthesis of Nickel Complexes

### Synthesis Example 2-1

### Synthesis of Nickel Complex 3b

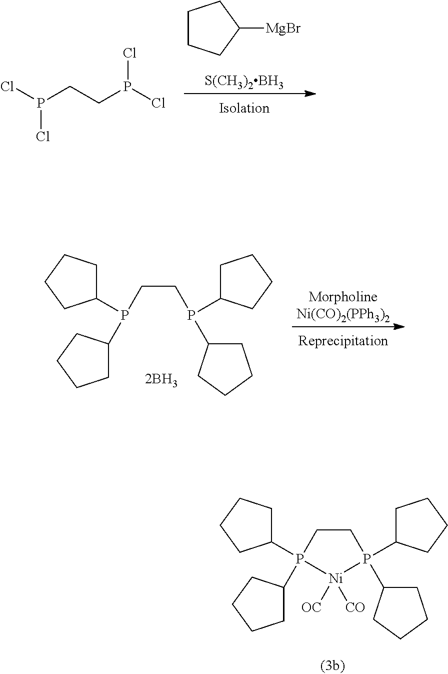

wherein the solid lines connecting a nickel atom and two phosphorus atoms, and the solid lines connecting the nickel atom and two COs are coordinate bonds.

A diethyl ether (12 mL) solution of 1,2-bis(dichlorophosphino)ethane (1.0 mmol) was cooled to 0° C., and cyclopentylmagnesium bromide (1.0 M solution of diethyl ether, 12 mL, 12 equivalents) was slowly added thereto. After stirring at this temperature for 1 hour, dimethylsulfide borane (0.24 mL, 4.0 equivalents) was added. The reaction mixture was stirred for 1 hour, quenched with water, extracted with ethyl acetate, and concentrated under reduced pressure. The crude product was purified by flash column chromatography (hexane/ethyl acetate=30:1), thereby obtaining 1,2-bis(dicyclopentylphosphino)ethane diborane (borane salt of L2) as a white solid (314.7 mg, 40%).

Subsequently, a morpholine (3 mL) solution of the white solid (314.7 mg) was stirred at 120° C. for 2 hours, and concentrated under reduced pressure. After the reaction vessel was placed in a glove box in an argon atmosphere, the mixture was passed through a short silica gel pad using tetrahydrofuran (THF). Thereafter, Ni(CO)₂(PPh₃)₂ (511.4 mg, 0.80 mmol, 1.0 equivalent) was added to the reaction vessel. After the vessel was taken out from the glove box, the mixture was stirred at room temperature for 4 hours. The mixture was concentrated, and the residue was purified by reprecipitation with cooled acetone, thereby obtaining (1,2-bis(dicyclopentylphosphino)ethane)dicarbonyl nickel (Ni(L2)(CO)₂; nickel complex 3b) as a white solid (207.3 mg, 41%, 16% in 2 steps). This Synthesis Example corresponds to Entry 1 of the following Table 1.

¹H NMR (600 MHz, C₆D₆) δ 1.97-1.26 (m, 40H); ¹³C NMR (150 MHz, C₆D₆) δ 204.4 (t, J_{PC}=4.2 Hz), 39.3 (t, J_{PC}=10.1 Hz), 30.7 (t, J_{PC}=4.2 Hz), 26.7 (t, J_{PC}=4.2 Hz), 26.6 (t, J_{PC}=4.4 Hz), 26.1 (t, J_{PC}=20.1 Hz); ³¹P NMR (243 MHz, C₆D₆) δ 67.7; IR (neat): 1979.6, 1918.8 cm⁻¹; HRMS (FAB⁺): m/z calcd for C₂₃H₄₀NiOP₂[M−CO]⁺: 452.1908. found 452.1901.

### Synthesis Example 2-2

### Nickel Complexes 3c and 3d

The compounds shown in Table 1 below were obtained in the same manner as in Synthesis Example 2-1, except that suitable materials were used as the Grignard regent.

TABLE 1

| | | | Yield |
|---|---|---|---|
| Entry | Grignard reagent | Product | (%) |
| 1 | 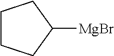 | 3b | 16 |
| 2 | 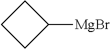 | 3c | 19 |
| 3 | 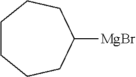 | 3d | 19 |

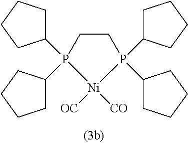

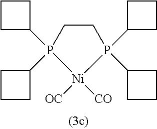

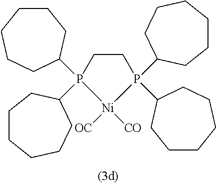

(1,2-Bis(dicyclobutylphosphino)ethane)dicarbonyl nickel (Ni(L1)(CO)₂; nickel complex 3c) (19% in 2 steps) and (1,2-bis(dicycloheptylphosphino)ethane)dicarbonyl nickel (Ni(L3)(CO)₂; nickel complex 3d) (19% in 2 steps) were obtained in the same manner as in Synthesis Example 2-1, except that suitable materials were used as the starting materials. The spectrum data of each compound were as follow:

### Nickel Complex 3c (Ni(L1)(CO)₂)

¹H NMR (600 MHz, C₆D₆) δ 2.47-2.35 (m, 4H), 2.29-2.13 (m, 4H), 2.13-1.86 (m, 16H), 1.86-1.72 (m, 4H), 1.04 (d, J=10.8 Hz, 4H); ¹³C NMR (150 MHz, C₆D₆) δ 204.3, 33.5 (t, J_{PC}=8.6 Hz), 25.7, 24.8, 24.1 (t, J_{PC}=20.1 Hz), 21.3 (t, J_{PC}=8.6 Hz); ³¹P NMR (160 MHz, C₆D₆) δ60.9; IR (neat): 1984.4, 1912.1 cm⁻¹; HRMS (FAB⁺): m/z calcd for C₁₉H₃₂NiOP₂ [M−CO]⁺: 396.1282. found 396.1287.

### Nickel Complex 3d (Ni(L3)(CO)₂)

¹H NMR (400 MHz, C₆D₆) δ 2.03-1.60 (m, 20H), 1.60-1.20 (m, 36H). ¹³C NMR (100 MHz, C₆D₆) δ 204.3, 37.1 (t, J_{PC}=7.2 Hz), 30.6 (d, J_{PC}=8.6 Hz), 29.3-29.0 (m), 28.2 (d, J_{PC}=21.1 Hz), 24.3 (t, J_{PC}=18.2 Hz); ³¹P NMR (160 MHz, C₆D₆) δ 74.9; IR (neat): 1980.5, 1916.9 cm⁻¹; HRMS (FAB⁺): m/z calcd for C₃₁H₅₆NiOP₂[M−CO]⁺: 564.3160. found 564.3158.

### Synthesis Example 2-3

### Nickel Complex 3e

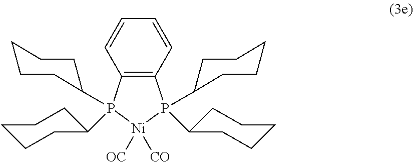

A (2-bromophenyl)dicyclohexylphosphine borane complex was synthesized according to the method described in J. Org. Chem. 2012, 77, pp. 5759-5769.

(2-Bromophenyl)dicyclohexylphosphine (1.5 mmol) and dry diethyl ether (6.0 mL) were added to a 50-mL round-bottom glass flask in which a magnetic stirrer was placed. After cooling to −78° C., a hexane solution of n-butyllithium (1.6 M, 0.94 mL, 1.0 equivalent) was added at −78° C. for 10 minutes. After stirring at −78° C. for 1 hour, a diethyl ether (6.0 mL) solution of chlorodicyclohexylphosphine (0.34 mL, 1.5 mmol, 1.0 equivalent) was added at −78° C. for 10 minutes. After stirring at −78° C. for 2 hours, dimethyl sulfide borane (0.11 mL, 1.8 mmol, 1.2 equivalents) was added. After stirring for 1 hour, the reaction mixture was quenched with water, extracted with ethyl acetate, and concentrated under reduced pressure. The crude product was purified by flash column chromatography (hexane/ethyl acetate=10:1), thereby obtaining 1,2-bis(dicyclohexylphosphino)benzene diborane (borane salt of dcypbz) as a white solid (303.6 mg, 41%).

Subsequently, a morpholine (3 mL) solution of the white solid (242.3 mg, 0.50 mmol) was stirred at 120° C. for 2 hours, and concentrated under reduced pressure. After the reaction vessel was placed in a glove box in an argon atmosphere, the mixture was passed through a short silica gel pad using tetrahydrofuran (THF). Thereafter, Ni(CO)₂(PPh₃)₂ (319.6 mg, 0.50 mmol, 1.0 equivalent) was added to the reaction vessel. After the vessel was taken out from the glove box, the mixture was stirred at room temperature for 4 hours. The mixture was concentrated, and the residue was purified by reprecipitation with cooled acetone, thereby obtaining (1,2-bis(dicyclohexylphosphino)benzene)dicarbonyl nickel (Ni(dcypbz)(CO)₂; nickel complex 3e) as a white solid (242.0 mg, 83%, 34% in 2 steps).

¹H NMR (600 MHz, C₆D₆) δ 7.37-7.31 (m, 2H), 7.10-7.06 (m, 2H), 2.12-1.97 (m, 8H), 1.72 (d, J=13.2 Hz, 4H), 1.62-1.44 (m, 12H), 1.33-1.19 (m, 12H), 1.19-1.00 (m, 8H); ¹³C NMR (150 MHz, C₆D₆) δ 204.8, 146.5 (t, J_{PC}=33.0 Hz), 131.0, 129.3, 30.4 (t, J_{PC}=4.4 Hz), 28.8, 27.6 (t, J_{PC}=4.4 Hz), 27.4 (t, J_{PC}=5.7 Hz), 26.6; ³¹P NMR (160 MHz, C₆D₆) δ 64.3; IR (neat): 1984.4, 1918.8 cm⁻¹; HRMS (FAB⁺): m/z calcd for C₃₁H₄₈NiOP₂ [M−CO]⁺: 556.2534. found 556.2528.

### Example 1

### Synthesis of Ligand of the Present Invention

### Example 1-1

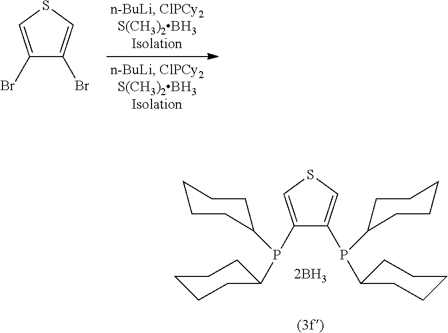

3,4-Dibromothiophene (1.32 mL, 12 mmol) and dry diethyl ether (12 mL) were added to a 50-mL round-bottom glass flask in which a magnetic stirrer was placed. After cooling to −78° C., a hexane solution of n-butyllithium (2.6 M, 4.6 mL, 1.0 equivalent) was added at −78° C. for 10 minutes. After stirring at −78° C. for 1 hour, a diethyl ether (12 mL) solution of chlorodicyclohexylphosphine (2.64 mL, 12 mmol, 1.0 equivalent) was added at −78° C. for 10 minutes. After stirring at −78° C. for 30 minutes, dimethylsulfide borane (0.85 mL, 14.4 mmol, 1.2 equivalents) was added. After stirring for 1 hour, the reaction mixture was quenched with water, extracted with ethyl acetate, and concentrated under reduced pressure. The crude product was purified by flash column chromatography (hexane/ethyl acetate=20:1), thereby obtaining 3-bromo-4-dicyclohexylphosphino thiophene borane as a white solid (4.07 g, 91%).

After cooling a diethyl ether (3.0 mL) solution of the obtained 3-bromo-4-dicyclohexylphosphino thiophene borane (1.12 g, 3.0 mmol) to −78° C., a hexane solution of n-butyllithium (2.6 M, 1.15 mL, 1.0 equivalent) was slowly added. After stirring at −78° C. for 1 hour, a diethyl ether (3.0 mL) solution of chlorodicyclohexylphosphine (0.67 mL, 3.0 mmol, 1.0 equivalent) was added at −78° C. for 10 minutes. After stirring at −78° C. for 30 minutes, dimethylsulfide borane (0.22 mL, 3.6 mmol, 1.2 equivalents) was added. After stirring for 1 hour, the reaction mixture was quenched with water, extracted with CH₂Cl₂, and concentrated under reduced pressure. The crude product was purified by reprecipitation with hexane, thereby obtaining 3,4-bis(dicyclohexylphosphino)thiophene diborane (borane salt of dcypt; borane salt of ligand 3f′) as a white solid (77.3 mg, 47%).

### Example 1-2

3,4-Dibromothiophene (1.1 mL, 9.92 mmol) and dry diethyl ether (10 mL) were added to a 50-mL round-bottom glass flask in which a magnetic stirrer was placed. After cooling to −78° C., a hexane solution of n-butyllithium (1.6 M, 6.1 mL, 1.0 equivalent) was added at −78° C. for 10 minutes. After stirring at −78° C. for 1 hour, a diethyl ether (5.0 mL) solution of chlorodicyclohexylphosphine (2.3 mL, 10.4 mmol, 1.05 equivalents) was added at −78° C. for 15 minutes. After stirring at −78° C. for 30 minutes, a hexane solution of n-butyllithium (1.6 M, 6.1 mL, 1.0 equivalent) was added at −78° C. for 10 minutes. After stirring at −78° C. for 1 hour, a diethyl ether (5.0 mL) solution of chlorodicyclohexylphosphine (2.3 mL, 10.4 mmol, 1.05 equivalents) was added at −78° C. for 10 minutes. Thereafter, the reaction mixture was stirred at −78° C. for 30 minutes. After warming to room temperature, the reaction mixture was quenched with water, extracted with hexane, washed with brine, dried over Na₂SO₄, and concentrated under reduced pressure. The crude product was purified by reprecipitation with toluene (1.0 mL), thereby obtaining 3,4-bis(dicyclohexylphosphino)thiophene (dcypt; ligand 3f′) as a white solid (3.05 g, 65%).

¹H NMR (600 MHz, CDCl₃) δ 7.39 (t, J=1.8 Hz, 2H), 1.93-1.82 (m, 8H), 1.78-1.57 (m, 16H), 1.30-1.01 (m, 20H); ¹³C NMR (150 MHz, CDCl₃) δ 141.5 (d, J_{PC}=8.7 Hz), 128.5, 34.4 (t, J_{PC}=4.2 Hz), 30.2 (t, J_{PC}=7.2 Hz), 29.0 (t, J_{PC}=4.2 Hz), 27.3-27.1 (m) 26.5; ³¹P NMR (162 MHz, CDCl₃) δ −20.4; HRMS (ESI) m/z calcd for C₂₈H₄₇P₂S⁺ [M+H]⁺: 477.2868. found 477.2855.

### Example 2

### Synthesis of Nickel Complex

### Example 2-1

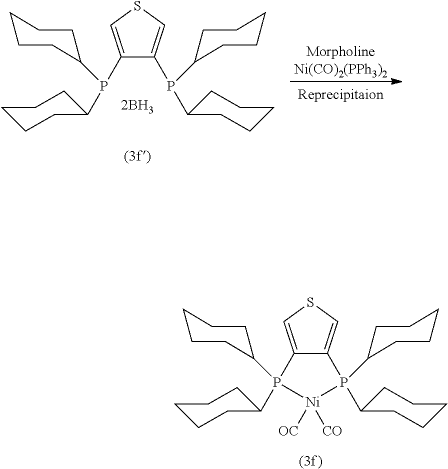

A morpholine (3 mL) solution of the borane salt of the ligand 3f′ (borane salt of dcypt) (136.7 mg, 0.28 mmol) obtained in Example 1-1 was stirred at 120° C. for 2 hours, and concentrated under reduced pressure. After the reaction vessel was placed in a glove box in an argon atmosphere, the mixture was passed through a short silica gel pad using tetrahydrofuran (THF). Thereafter, Ni(CO)₂(PPh₃)₂ (134.8 mg, 0.28 mmol, 1.0 equivalent) was added to the reaction vessel. After the vessel was taken out from the glove box, the mixture was stirred at room temperature for 4 hours. The mixture was concentrated, and the residue was purified by reprecipitation with cooled acetone, thereby obtaining (3,4-bis(dicyclohexylphosphino)thiophene)dicarbonyl nickel (Ni(dcypt)(CO)₂; nickel complex 3f) as a white solid (77.3 mg, 47%, 33% in 2 steps).

¹H NMR (400 MHz, C₆D₆) δ 7.39-7.32 (m, 2H), 7.12-7.06 (m, 2H), 2.13-1.98 (m, 8H), 1.73 (d, J=12 Hz, 4H), 1.64-1.38 (m, 12H), 1.35-1.02 (m, 20H); ¹³C NMR (100 MHz, C₆D₆) δ 204.7, 146.4 (t, J_{PC}=51.8 Hz), 130.9, 129.2, 30.2 (t, J_{PC}=7.2 Hz), 28.7, 27.5 (t, J_{PC}=7.2 Hz), 27.3 (t, J_{PC}=10.1 Hz), 26.5; ³¹P NMR (160 MHz, C₆D₆) δ 40.1; IR (neat): 1987.3, 1926.5 cm⁻¹; HRMS (FAB⁺): m/z calcd for C₂₉H₄₆NiOP₂S [M−CO]⁺: 562.2098. found 562.2096.

### Example 3

### Coupling Reaction

### Example 3-1

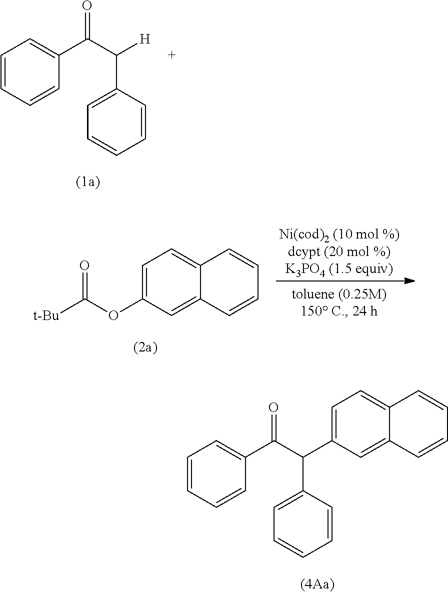

A magnetic stirrer was placed in a 20-ml glass vessel equipped with a J. Young (registered trademark) O-ring tap, and K₃PO₄ (95.5 mg, 0.45 mmol, 1.5 equivalents) was supplied. After drying with a heat gun under reduced pressure and cooling to room temperature, the vessel was filled with argon. A carbonyl compound (1a) (0.45 mmol, 1.5 equivalents) and a phenol derivative (2a) (0.30 mmol, 1.0 equivalent) were placed in the vessel, and the glass vessel was placed in a glove box in an argon atmosphere. In the glove box, Ni(cod)₂ (8.3 mg, 0.03 mmol, 10 mol %) and 3,4-bis(dicyclohexylphosphino)thiophene (dcypt) (28.6 mg, 0.06 mmol, 20 mol %) obtained in Example 1-2 were added to the vessel, and toluene (1.2 mL) was further added. After sealing with the O-ring tap, the glass vessel was taken out from the glove box. The glass vessel was heated in an oil bath while stirring at 150° C. for 24 hours. After the reaction mixture was cooled to room temperature, the mixture was passed through a short silica gel pad using ethyl acetate. The filtrate was concentrated, and the residue was subjected to preparative thin-layer chromatography (hexane/diethyl ether=5:1 after the addition of toluene). As a coupling product, 2-(naphthalen-2-yl)-1,2-diphenylethan-1-one (compound 4Aa), which was an α-arylcarbonyl compound, was obtained as a white solid (87.6 mg, 91%). This Example corresponds to Entry 1 of Table 2, Entry 3 of Table 4, Entry 8 of Table 5, and Entry 1 of Table 7, provided later.

¹H NMR (600 MHz, CDCl₃) δ 8.04 (d, J=7.8 Hz, 2H), 7.82-7.78 (m, 2H), 7.78-7.74 (m, 1H), 7.70 (s, 1H), 7.51 (t, J=7.8 Hz, 1H), 7.46-7.39 (m, 5H), 7.35-7.30 (m, 4H), 7.28-7.25 (m, 1H), 6.20 (s, 1H); ¹³C NMR (150 MHz, CDCl₃) δ 198.2, 139.0, 136.8, 136.6, 133.4, 133.1, 132.5, 129.3, 129.0, 128.7, 128.6, 128.5, 127.9, 127.7, 127.6, 127.3, 127.2, 126.1, 126.0, 59.5; HRMS (ESI) m/z calcd for C₂₄H₁₉O⁺ [M+H]⁺: 323.1430. found 323.1423.

### Example 3-2

The compounds shown in Table 2 below were obtained in the same manner as in Example 3-1 (with the purification method being appropriately changed, if necessary), except that various starting materials were used in place of the carbonyl compound (1a) and the phenol derivative (2a).

TABLE 2

| | Carbonyl | Phenol | | | Amount | Yield |
|---|---|---|---|---|---|---|
| Entry | compound | derivative | Product | State | (mg) | (%) |
| 1 | 1a | 2a | 4Aa | White solid | 87.6 | 91 |
| 2 | 1a | 2a′ | 4Aa | White solid | | 77 |
| 3 | 1a | 2b | 4Ab | Yellow liquid | 65.8 | 68 |
| 4 | 1a | 2c | 4Ac | White solid | 81.0 | 71 |
| 5 | 1a | 2d | 4Ad | White solid | 48.7 | 60 |
| 6 | 1a | 2e | 4Ae | Colorless liquid | 68.8 | 76 |
| 7 | 1a | 2f | 4Af | White solid | 56.5 | 57 |
| 8 | 1a | 2g | 4Ag | White solid | 66.2 | 63 |
| 9 | 1b | 2a | 4Ba | White solid | 48.0 | 61 |
| 10 | 1c | 2a | 4Ca | White solid | 37.1 | 43 |
| 11 | 1d | 2h | 4Dh | White solid | 73.7 | 89 |
| 12 | 1e | 2h | 4Eh | White solid | 63.3 | 81 |
| 13 | 1f | 2h | 4Fh | Yellow solid | 64.8 | 75 |
| 14 | 1g | 2h | 4Gh | White solid | 75.2 | 75 |
| 15 | 1h | 2h | 4Hh | White solid | 60.3 | 76 |
| 16 | 1i | 2h | 4Ih | White solid | 55.1 | 61 |
| 17 | 1j | 2h | 4Jh | White solid | 42.2 | 57 |
| 18 | 1k | 2h | 4Kh | White solid | 57.1 | 81 |
| 19 | 1l | 2h | 4Lh | White solid | 62.5 | 83 |
| 20 | 1m | 2h | 4Mh | White solid | 54.4 | 73 |
| 21 | 1n | 2h | 4Nh | Brown solid | 68.4 | 76 |
| 22 | 1o | 2h | 4Oh | White solid | 36.3 | 53 |
| 23 | 1o | 2a | 4Oa | White solid | 37.7 | 55 |
| 24 | 1d | 2i | 4Di | White solid | 70.8 | 77 |
| 25 | 1d | 2j | 4Dj | Yellow solid | 62.8 | 75 |
| 26 | 1d | 2k | 4Dk | Yellow solid | 54.7 | 66 |
| 27 | 1d | 2c | 4Dc | White solid | 49.5 | 49 |
| 28 | 1n | 2l | 4Nl | Yellow liquid | 72.2 | 55 |
| 29 | 1d | 2l | 4Dl | Yellow liquid | 118.8 | 79 |
| 30 | 1d | 2m | 4Dm | Colorless liquid | 67.9 | 56 |

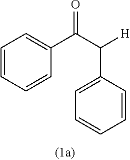 [SMILES: O=C(Cc1ccccc1)c1ccccc1]

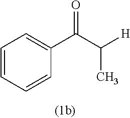

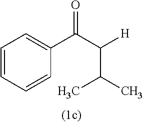

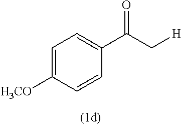 [SMILES: COc1ccc(C(C)=O)cc1]

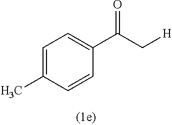

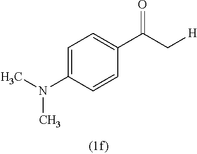

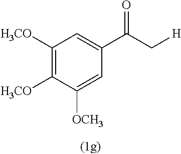 [SMILES: COc1cc(C(C)=O)cc(OC)c1OC]

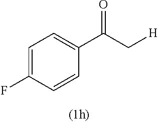

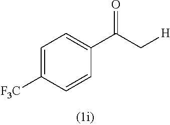 [SMILES: CC(=O)c1ccc(C(F)(F)F)cc1]

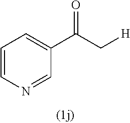

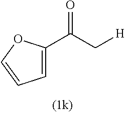

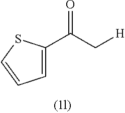

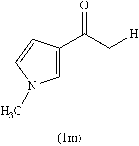

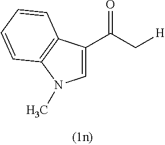

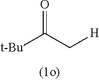

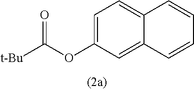 [SMILES: CC(C)(C)C(=O)Oc1ccc2ccccc2c1]

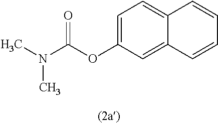 [SMILES: CN(C)C(=O)Oc1ccc2ccccc2c1]

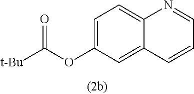 [SMILES: CC(C)(C)C(=O)Oc1ccc2ncccc2c1]

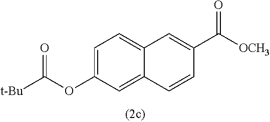 [SMILES: COC(=O)c1ccc2cc(OC(=O)C(C)(C)C)ccc2c1]

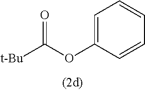 [SMILES: CC(C)(C)C(=O)Oc1ccccc1]

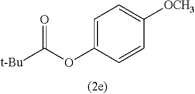 [SMILES: COc1ccc(OC(=O)C(C)(C)C)cc1]

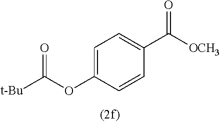 [SMILES: COC(=O)c1ccc(OC(=O)C(C)(C)C)cc1]

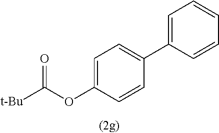 [SMILES: CC(C)(C)C(=O)Oc1ccc(-c2ccccc2)cc1]

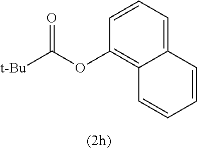 [SMILES: CC(C)(C)C(=O)Oc1cccc2ccccc12]

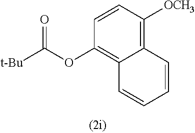 [SMILES: COc1ccc(OC(=O)C(C)(C)C)c2ccccc12]

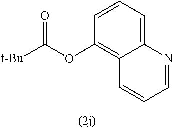 [SMILES: CC(C)(C)C(=O)Oc1cccc2ncccc12]

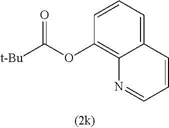 [SMILES: CC(C)(C)C(=O)Oc1cccc2cccnc12]

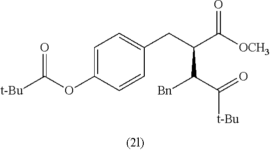 [SMILES: COC(=O)[C@H](Cc1ccc(OC(=O)C(C)(C)C)cc1)C(Cc1ccccc1)C(=O)C(C)(C)C]

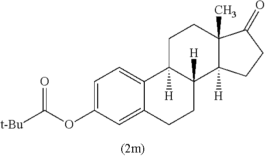

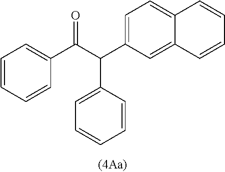 [SMILES: O=C(c1ccccc1)C(c1ccccc1)c1ccc2ccccc2c1]

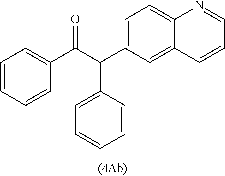 [SMILES: O=C(c1ccccc1)C(c1ccccc1)c1ccc2ncccc2c1]

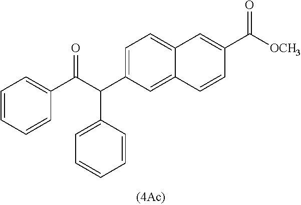 [SMILES: COC(=O)c1ccc2cc(C(C(=O)c3ccccc3)c3ccccc3)ccc2c1]

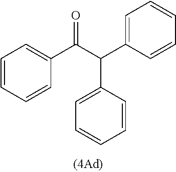 [SMILES: O=C(c1ccccc1)C(c1ccccc1)c1ccccc1]

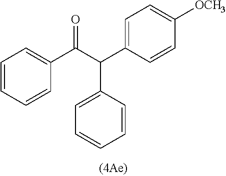 [SMILES: COc1ccc(C(C(=O)c2ccccc2)c2ccccc2)cc1]

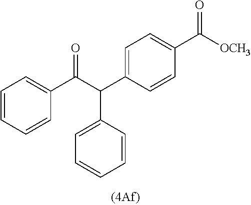 [SMILES: COC(=O)c1ccc(C(C(=O)c2ccccc2)c2ccccc2)cc1]

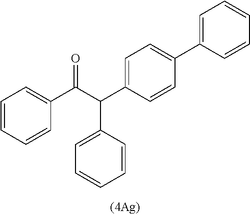 [SMILES: O=C(c1ccccc1)C(c1ccccc1)c1ccc(-c2ccccc2)cc1]

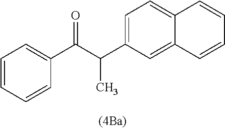 [SMILES: CC(C(=O)c1ccccc1)c1ccc2ccccc2c1]

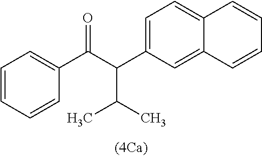 [SMILES: CC(C)C(C(=O)c1ccccc1)c1ccc2ccccc2c1]

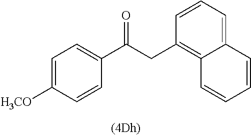 [SMILES: COc1ccc(C(=O)Cc2cccc3ccccc23)cc1]

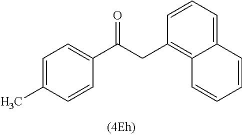 [SMILES: Cc1ccc(C(=O)Cc2cccc3ccccc23)cc1]

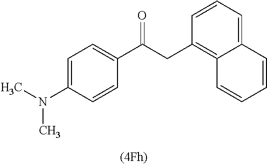 [SMILES: CN(C)c1ccc(C(=O)Cc2cccc3ccccc23)cc1]

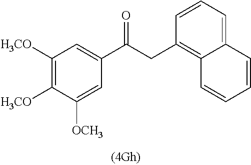 [SMILES: COc1cc(C(=O)Cc2cccc3ccccc23)cc(OC)c1OC]

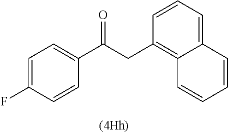 [SMILES: O=C(Cc1cccc2ccccc12)c1ccc(F)cc1]

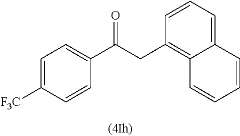 [SMILES: O=C(Cc1cccc2ccccc12)c1ccc(C(F)(F)F)cc1]

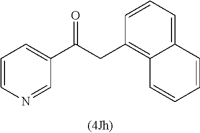 [SMILES: O=C(Cc1cccc2ccccc12)c1cccnc1]

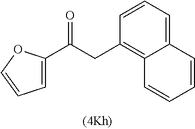 [SMILES: O=C(Cc1cccc2ccccc12)c1ccco1]

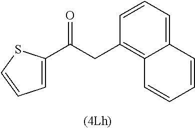 [SMILES: O=C(Cc1cccc2ccccc12)c1cccs1]

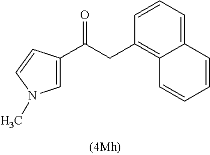 [SMILES: Cn1ccc(C(=O)Cc2cccc3ccccc23)c1]

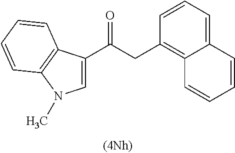 [SMILES: Cn1cc(C(=O)Cc2cccc3ccccc23)c2ccccc21]

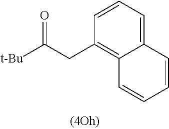 [SMILES: CC(C)(C)C(=O)Cc1cccc2ccccc12]

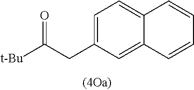 [SMILES: CC(C)(C)C(=O)Cc1ccc2ccccc2c1]

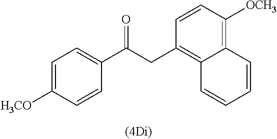 [SMILES: COc1ccc(C(=O)Cc2ccc(OC)c3ccccc23)cc1]

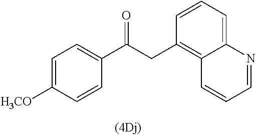 [SMILES: COc1ccc(C(=O)Cc2cccc3ncccc23)cc1]

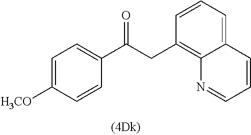 [SMILES: COc1ccc(C(=O)Cc2cccc3cccnc23)cc1]

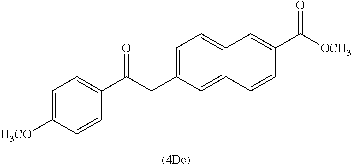 [SMILES: COC(=O)c1ccc2cc(CC(=O)c3ccc(OC)cc3)ccc2c1]

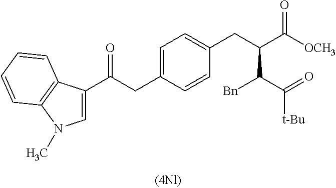 [SMILES: COC(=O)[C@H](Cc1ccc(CC(=O)c2cn(C)c3ccccc23)cc1)C(Cc1ccccc1)C(=O)C(C)(C)C]

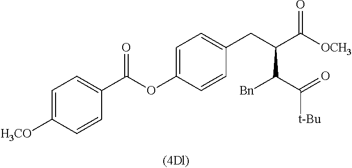 [SMILES: COC(=O)[C@H](Cc1ccc(OC(=O)c2ccc(OC)cc2)cc1)C(Cc1ccccc1)C(=O)C(C)(C)C]

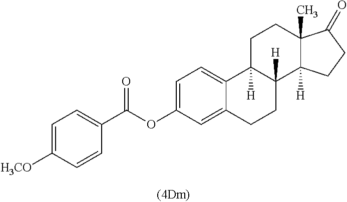

The spectrum data of each compound were as follows:

### Compound 4Ab (1,2-diphenyl-2-(quinolin-6-yl)ethan-1-one)

¹H NMR (400 MHz, CDCl₃) δ 8.87 (dd, J=4.4, 1.6 Hz, 1H), 8.10-8.02 (m, 4H), 7.66 (m, 2H), 7.52 (t, J=8.0 Hz, 1H), 7.42 (t, J=8.0 Hz, 2H), 7.38-7.31 (m, 5H), 7.29-7.25 (m, 1H), 6.24 (s, 1H); ¹³C NMR (100 MHz, CDCl₃) δ 197.9, 150.4, 147.4, 138.4, 137.6, 136.5, 136.0, 133.2, 131.0, 129.8, 129.1, 129.0, 128.9, 128.7, 128.1, 127.5, 127.4, 121.3, 59.1; HRMS (ESI) m/z calcd for C₂₃H₁₈NO⁺ [M+H]⁺: 324.1383. found 324.1373.

### Compound 4Ac (methyl 6-(2-oxo-1,2-diphenylethyl)-2-naphthoate)

¹H NMR (400 MHz, CDCl₃) δ 8.56 (s, 1H), 8.06-8.00 (m, 3H), 7.92 (d, J=8.4 Hz, 1H), 7.79 (d, J=8.4 Hz, 1H), 7.71 (s, 1H), 7.56-7.46 (m, 2H), 7.42 (t, J=8.0 Hz, 2H), 7.37-7.31 (m, 4H), 7.31-7.27 (m, 1H), 6.22 (s, 1H), 3.97 (s, 3H); ¹³C NMR (100 MHz, CDCl₃) δ 197.9, 167.2, 139.4, 138.5, 136.6, 135.5, 133.3, 131.5, 130.7, 129.8, 129.2, 129.0, 128.9, 128.7, 128.22, 128.19, 127.6, 127.4, 125.6, 59.5, 52.2; HRMS (ESI) m/z calcd for C₂₆H₂₁O₃⁺ [M+H]⁺: 381.1485. found 381.1473.

### Compound 4Ad (1,2,2-triphenylethan-1-one)

¹H NMR (600 MHz, CDCl₃) δ 8.00 (dd, J=7.2, 1.2 Hz, 2H), 7.51 (tt, J=7.2, 1.2 Hz, 1H), 7.41 (t, J=7.8 Hz, 2H), 7.34-7.30 (m, 4H), 7.30-7.22 (m, 6H), 6.04 (s, 1H); ¹³C NMR (150 MHz, CDCl₃) δ 198.2, 139.1, 136.8, 133.0, 129.1, 128.9, 128.7, 128.6, 127.1, 59.4; HRMS (ESI) m/z calcd for C₂₀H₁₇O⁺ [M+H]⁺: 273.1274. found 273.1265.

### Compound 4Ae (2-(4-methoxyphenyl)-1,2-diphenylethan-1-one)

¹H NMR (400 MHz, CDCl₃) δ 8.00 (d, J=7.6 Hz, 2H), 7.50 (t, J=7.2 Hz, 1H), 7.40 (t, J=8.0 Hz, 2H), 7.35-7.28 (m, 2H), 7.28-7.22 (m, 3H), 7.19 (d, J=9.2 Hz, 2H), 6.86 (d, J=8.4 Hz, 2H), 5.99 (s, 1H), 3.77 (s, 3H); ¹³C NMR (150 MHz, CDCl₃) δ 198.4, 158.6, 139.4, 136.8, 133.0, 131.1, 130.1, 129.0, 128.9, 128.7, 128.6, 127.0, 114.1, 58.6, 55.2; HRMS (ESI) m/z calcd for C₂₁H₁₉O₂+[M+H]⁺: 303.1380. found 303.1371.

### Compound 4Af (4-(2-oxo-1,2-diphenylethyl)benzoate)

¹H NMR (400 MHz, CDCl₃) δ 8.01-7.97 (m, 4H), 7.53 (tt, J=7.6, 1.2 Hz, 1H), 7.42 (t, J=7.6 Hz, 2H), 7.36-7.31 (m, 4H), 7.29-7.26 (m, 3H), 6.08 (s, 1H), 3.89 (s, 3H); ¹³C NMR (100 MHz, CDCl₃) δ 197.5, 166.8, 144.3, 138.2, 136.5, 133.3, 129.9, 129.2, 129.1, 128.9, 128.7, 127.5, 59.3, 52.1; HRMS (ESI) m/z calcd for C₂₂H₁₉O₃+[M+H]⁺: 331.1329. found 331.1319.

### Compound 4Ag (2-([1,1′-biphenyl]-4-yl)-1,2-diphenylethan-1-one)

¹H NMR (400 MHz, CDCl₃) δ 8.03 (d, J=7.6 Hz, 2H), 7.58-7.50 (m, 5H), 7.45-7.38 (m, 4H), 7.37-7.30 (m, 7H), 7.30-7.26 (m, 1H), 6.08 (s, 1H); ¹³C NMR (100 MHz, CDCl₃) δ 198.2, 140.7, 140.0, 139.0, 138.1, 136.8, 133.1, 129.5, 129.1, 129.0, 128.8, 128.7, 128.6, 127.4, 127.3, 127.2, 127.1, 59.1; HRMS (ESI) m/z calcd for C₂₆H₂₁O⁺ [M+H]⁺: 349.1587. found 349.1579.

### Compound 4Ba (2-(naphthalen-2-yl)-1-phenylpropan-1-one)

¹H NMR (600 MHz, CDCl₃) δ 7.98 (dd, J=8.4, 1.2 Hz, 2H), 7.79-7.77 (m, 3H), 7.72 (s, 1H), 7.45-7.39 (m, 4H), 7.34 (t, J=7.8 Hz, 2H), 4.84 (q, J=6.6 Hz, 1H), 1.61 (d, J=6.6 Hz, 3H); ¹³C NMR (150 MHz, CDCl₃) δ 200.2, 139.0, 136.4, 133.6, 132.8, 132.3, 128.8, 128.5, 127.7, 127.6, 126.4, 126.1, 125.9, 125.8, 48.0, 19.5; HRMS (ESI) m/z calcd for C₁₉H₁₆NaO⁺ [M+Na]⁺: 283.1093. found 283.1085.

### Compound 4Ca (3-methyl-2-(naphthalen-2-yl)-1-phenylbutan-1-one)

¹H NMR (400 MHz, CDCl₃) δ 8.01 (dd, J=8.4, 1.6 Hz, 2H), 7.80-7.75 (m, 4H), 7.53-7.35 (m, 6H), 4.38 (d, J=10.4 Hz, 1H), 2.77-2.65 (m, 1H), 1.06 (d, J=6.4 Hz, 3H), 0.77 (d, J=6.4 Hz, 3H); ¹³C NMR (150 MHz, CDCl₃) δ 200.5, 137.6, 136.1, 133.5, 132.8, 132.5, 128.5, 128.4, 127.74, 127.69, 127.6, 126.7, 126.0, 125.7, 61.4, 31.9, 22.0, 20.6; HRMS (ESI) m/z calcd for C₂₁H₂₁O⁺ [M+H]⁺: 289.1587. found 289.1578.

### Compound 4Dh (1-(4-methoxyphenyl)-2-(naphthalen-1-yl)ethan-1-one)

¹H NMR (600 MHz, CDCl₃) δ 8.06 (d, J=9.0 Hz, 2H), 7.91-7.85 (m, 2H), 7.78 (d, J=8.4 Hz, 1H), 7.51-7.46 (m, 2H), 7.42 (t, J=7.8 Hz, 1H), 7.35 (d, J=6.6 Hz, 1H), 6.95 (d, J=9.0 Hz, 2H), 4.69 (s, 2H), 3.87 (s, 3H); ¹³C NMR (150 MHz, CDCl₃) δ 196.2, 163.6, 133.9, 132.3, 131.7, 130.8, 129.8, 128.8, 127.9, 127.7, 126.3, 125.7, 125.5, 123.9, 113.8, 55.5, 42.8; HRMS (ESI) m/z calcd for C₁₉H₁₇O₂+[M+H]⁺: 277.1223. found 277.1213.

### Compound 4Eh (2-(naphthalen-1-yl)-1-(p-tolyl)ethan-1-one)

¹H NMR (600 MHz, CDCl₃) δ 7.98 (d, J=8.4 Hz, 2H), 7.89-7.84 (m, 2H), 7.78 (d, J=8.4 Hz, 1H), 7.50-7.46 (m, 2H), 7.42 (dd, J=8.4, 7.2 Hz, 1H), 7.35 (d, J=7.2 Hz, 1H), 7.27 (d, J=8.4 Hz, 2H), 4.71 (s, 2H), 2.42 (s, 3H); ¹³C NMR (150 MHz, CDCl₃) δ 197.3, 144.1, 134.2, 133.9, 132.2, 131.6, 129.4, 128.8, 128.6, 127.9, 127.8, 126.3, 125.7, 125.4, 123.9, 43.0, 21.7; HRMS (ESI) m/z calcd for C₁₉H₁₇O⁺ [M+H]⁺: 261.1274. found 261.1268.

### Compound 4Fh (1-(4-(dimethylamino)phenyl)-2-(naphthalen-1-yl)ethan-1-one)

¹H NMR (600 MHz, CDCl₃) δ 8.00 (d, J=9.0 Hz, 2H), 7.94 (dd, J=7.2, 2.4 Hz, 1H), 7.85 (dd, J=7.2, 2.4 Hz, 1H), 7.76 (d, J=7.8 Hz, 1H), 7.50-7.45 (m, 2H), 7.41 (t, J=7.8 Hz, 1H), 7.36 (d, J=6.6 Hz, 1H), 6.66 (d, J=9.0 Hz, 2H), 4.65 (s, 2H), 3.06 (s, 6H). ¹³C NMR (150 MHz, CDCl₃) δ 195.7, 153.4. 133.8, 132.5, 132.3, 130.8, 128.7, 127.8, 127.5, 126.1, 125.6, 125.5, 124.7, 124.1, 110.7, 42.4, 40.0; HRMS (ESI) m/z calcd for C₂₀H₂₀NO⁺ [M+H]⁺: 290.1539. found 290.1529.

### Compound 4Gh (2-(naphthalen-1-yl)-1-(3,4,5-trimethoxyphenyl)ethan-1-one)

¹H NMR (600 MHz, CDCl₃) δ 7.93 (d, J=8.4 Hz, 1H), 7.88 (dd, J=7.2, 2.4 Hz, 1H), 7.80 (d, J=8.4 Hz, 1H), 7.53-7.47 (m, 2H), 7.43 (dd, J=8.4, 7.2 Hz, 1H), 7.38 (d, J=7.2 Hz, 1H), 7.31 (s, 2H), 4.70 (s, 2H), 3.91 (s, 3H), 3.84 (s, 6H); ¹³C NMR (150 MHz, CDCl₃) δ 196.4, 153.0, 142.6, 133.9, 132.1, 131.8, 131.5, 128.9, 127.90, 127.85, 126.4, 125.8, 125.5, 123.7, 106.0, 60.9, 56.2, 43.2; HRMS (ESI) m/z calcd for C₂₁H₂₁O₄⁺ [M+H]⁺: 337.1434. found 337.1424.

### Compound 4Hh (1-(4-fluorophenyl)-2-(naphthalen-1-yl)ethan-1-one)

¹H NMR (600 MHz, CDCl₃) δ 8.12-8.08 (m, 2H), 7.89-7.85 (m, 2H), 7.80 (d, J=8.4 Hz, 1H), 7.52-7.47 (m, 2H), 7.43 (dd, J=7.8, 6.6 Hz, 1H), 7.35 (d, J=7.2 Hz, 1H), 7.17-7.12 (m, 2H), 4.71 (s, 2H); ¹³C NMR (150 MHz, CDCl₃) δ 196.1, 165.8 (d, J_{CF}=256.4 Hz), 133.9, 133.1, 132.2, 131.2 (d, J_{CF}=10.1 Hz), 131.1, 128.6, 127.98, 127.95, 126.4, 125.8, 125.5, 123.7, 115.8 (d, J_{CF}=23.1 Hz), 43.1; HRMS (ESI) m/z calcd for C₁₈H₁₄FO⁺ [M+H]⁺: 265.1023. found 265.1016.

### Compound 4Ih (2-(naphthalen-1-yl)-1-(4-(trifluoromethyl)phenyl)ethan-1-one)

¹H NMR (400 MHz, CDCl₃) 58.16 (d, J=8.4 Hz, 2H), 7.90-7.84 (m, 2H), 7.81 (d, J=8.4 Hz, 1H), 7.74 (d, J=8.4 Hz, 2H), 7.53-7.49 (m, 2H), 7.44 (dd, J=8.4, 7.2 Hz, 1H), 7.36 (d, J=7.2 Hz, 1H), 4.76 (s, 2H); ¹³C NMR (150 MHz, CDCl₃) δ 196.7, 139.3, 134.4 (q, J_{CF}=33.2 Hz), 133.9, 132.1, 130.5, 128.9, 128.8, 128.2, 128.0, 126.5, 125.8 (q, J_{CF}=2.9 Hz), 125.5, 123.6, 123.5 (q, J_{CF}=273.6 Hz), 44.4; HRMS (ESI) m/z calcd for C₁₉H₁₄F₃O⁺ [M+H]⁺: 315.0991. found 315.0981.

### Compound 4Jh (2-(naphthalen-1-yl)-1-(pyridin-3-yl)ethan-1-one)

¹H NMR (600 MHz, CDCl₃) δ 9.31 (d, J=1.2 Hz, 1H), 8.78 (dd, J=7.2, 1.8 Hz, 1H), 8.28 (dt, J=8.4, 1.8 Hz, 1H), 7.89-7.85 (m, 2H), 7.80 (d, J=7.8 Hz, 1H), 7.53-7.47 (m, 2H), 7.44-7.38 (m, 2H), 7.37 (d, J=7.2 Hz, 1H), 4.73 (s, 2H); ¹³C NMR (150 MHz, CDCl₃) δ 196.5, 153.6, 149.9, 135.8, 133.9, 132.1, 131.9, 130.3, 128.9, 128.2, 128.1, 126.5, 125.8, 125.4, 123.7, 123.6, 43.5; HRMS (ESI) m/z calcd for C₁₇H₁₄NO⁺ [M+H]⁺: 248.1070. found 248.1064.

### Compound 4Kh (1-(furan-2-yl)-2-(naphthalen-1-yl)ethan-1-one)

¹H NMR (400 MHz, CDCl₃) δ 7.99 (d, J=8.0 Hz, 1H), 7.85 (dd, J=7.2, 2.0 Hz, 1H), 7.78 (dd, J=7.2, 2.4 Hz, 1H), 7.58 (dd, J=2.0, 0.8 Hz, 1H), 7.53-7.40 (m, 4H), 7.22 (d, J=3.6 Hz, 1H), 6.54 (dd, J=3.6, 2.0 Hz, 1H), 4.59 (s, 2H); ¹³C NMR (100 MHz, CDCl₃) δ 186.5, 152.4, 146.4, 133.8, 132.2, 130.6, 128.7, 128.2, 127.9, 126.3, 125.7, 125.4, 117.7, 112.4, 43.0; HRMS (ESI) m/z calcd for C₁₆H₁₃O₂+[M+H]⁺: 237.0910. found 237.0904.

### Compound 4Lh (2-(naphthalen-1-yl)-1-(thiophen-2-yl)ethan-1-one)

¹H NMR (600 MHz, CDCl₃) δ 7.97 (d, J=7.8 Hz, 1H), 7.86 (dd, J=7.8, 1.8 Hz, 1H), 7.84 (dd, J=4.2, 1.2 Hz, 1H), 7.80 (m, 1H), 7.64 (dd, J=4.8, 1.2 Hz, 1H), 7.53-7.46 (m, 2H), 7.45-7.41 (m, 2H), 7.12 (dd, J=4.8, 4.2 Hz, 1H), 4.65 (s, 2H); ¹³C NMR (150 MHz, CDCl₃) δ 190.4, 143.8, 133.9, 133.9, 132.4, 132.2, 130.9, 128.7, 128.1, 128.0, 126.4, 125.8, 125.4, 123.9, 44.1; HRMS (ESI) m/z calcd for C₁₆H₁₃OS+[M+H]⁺: 253.0682. found 253.0672.

### Compound 4Mh (1-(1-methyl-1H-pyrrol-3-yl)-2-(naphthalen-1-yl)ethan-1-one)

¹H NMR (600 MHz, CDCl₃) δ: 7.99 (d, J=7.8 Hz, 1H), 7.84 (dd, J=7.2, 2.4 Hz, 1H), 7.76 (d, J=7.8 Hz, 1H), 7.50-7.43 (m, 2H), 7.43-7.38 (m, 2H), 7.28 (t, J=1.8 Hz, 1H), 6.66 (dd, J=3.0, 1.8 Hz, 1H), 6.56 (t, J=2.4 Hz, 1H), 4.47 (s, 2H), 3.65 (s, 3H); ¹³C NMR (150 MHz, CDCl₃) δ: 192.8, 133.8, 132.4, 132.3, 128.6, 127.8, 127.5, 126.9, 126.1, 125.6, 125.4, 124.2, 123.2, 109.8, 44.3, 36.6; HRMS (ESI) m/z calcd for C₁₇H₁₆NO⁺ [M+H]⁺: 250.1226. found 250.1220.

### Compound 4Nh (1-(1-methyl-1H-indol-3-yl)-2-(naphthalen-1-yl)ethan-1-one)

¹H NMR (400 MHz, CDCl₃) δ 8.43-8.39 (m, 1H), 8.05-8.00 (m, 1H), 7.88-7.84 (m, 1H), 7.81 (s, 1H), 7.78 (dd, J=6.4, 3.2 Hz, 1H), 7.50-7.40 (m, 4H), 7.35-7.27 (m, 3H), 4.61 (s, 2H), 3.81 (s, 3H); ¹³C NMR (150 MHz, CDCl₃) δ 192.6, 137.4, 135.5, 133.9, 132.5, 132.4, 128.7, 127.8, 127.6, 126.6, 126.2, 125.7, 125.5, 124.1, 123.5, 122.8, 122.7, 116.2, 109.6, 44.6, 33.5; HRMS (ESI) m/z calcd for C₂₁H₁₈NO⁺ [M+H]⁺: 300.1383. found 300.1372.

### Compound 4Oh (3,3-dimethyl-1-(naphthalen-1-yl)butan-2-one)

¹H NMR (600 MHz, CDCl₃) δ 7.84 (dd, J=7.8, 1.8 Hz, 1H), 7.76 (d, J=8.4 Hz, 1H), 7.73 (dd, J=7.8, 1.8 Hz, 1H), 7.49-7.43 (m, 2H), 7.40 (dd, J=8.4, 7.2 Hz, 1H), 7.25 (d, 6.6 Hz, 1H), 4.26 (s, 2H), 1.30 (s, 9H); ¹³C NMR (150 MHz, CDCl₃) δ 212.6, 133.8, 132.4, 131.6, 128.7, 127.9, 127.6, 126.0, 125.5, 125.3, 123.7, 44.7, 41.0, 26.8; HRMS (ESI) m/z calcd for C₁₆H₁₉O⁺ [M+H]⁺: 227.1430. found 227.1422.

### Compound 4Oa (3,3-dimethyl-1-(naphthalen-2-yl)butan-2-one)

¹H NMR (600 MHz, CDCl₃) δ 7.82-7.76 (m, 3H), 7.63 (s, 1H), 7.46-7.41 (m, 2H), 7.31 (dd, J=8.4, 1.8 Hz, 1H), 3.96 (s, 2H), 1.23 (s, 9H); ¹³C NMR (150 MHz, CDCl₃) δ 212.9, 133.4, 132.5, 132.3, 128.1, 127.9, 127.8, 127.61, 127.57, 125.9, 125.5, 44.7, 43.5, 26.5; HRMS (ESI) m/z calcd for C₂₀H₁₈NaO⁺ [M+Na]⁺: 249.1250. found 249.1241.

### Compound 4Di (2-(4-methoxynaphthalen-1-yl)-1-(4-methoxyphenyl)ethan-1-one)

¹H NMR (400 MHz, CDCl₃) δ 8.31 (dd, J=7.2, 1.6 Hz, 1H), 8.05 (dd, J=8.8 Hz, 2H), 7.82 (dd, J=7.2, 1.6 Hz, 1H), 7.53-7.44 (m, 2H), 7.25 (d, J=8.0 Hz, 1H), 6.94 (d, J=8.8 Hz, 2H), 6.76 (d, J=8.0 Hz, 1H), 4.60 (s, 2H), 3.98 (s, 3H), 3.86 (s, 3H); ¹³C NMR (100 MHz, CDCl₃) δ 196.6, 163.5, 154.9, 133.0, 130.8, 129.8, 127.7, 126.7, 126.0, 125.0, 123.7, 123.6, 122.6, 113.8, 103.4, 55.5, 42.4; HRMS (ESI) m/z calcd for C₂₀H₁₉O₃⁺ [M+H]⁺: 307.1329. found 307.1320.

### Compound 4Dj (1-(4-methoxyphenyl)-2-(quinolin-5-yl)ethan-1-one)

¹H NMR (600 MHz, CDCl₃) δ 8.92 (dd, J=4.2, 1.8 Hz, 1H), 8.25 (d, J=8.4 Hz, 1H), 8.08-8.04 (m, 3H), 7.67 (dd, J=8.4, 7.2 Hz, 1H), 7.44 (d, J=7.2 Hz, 1H), 7.41 (dd, J=8.4, 4.2 Hz, 1H), 6.97 (d, J=9.0 Hz, 2H), 4.70 (s, 2H), 3.89 (s, 3H); ¹³C NMR (150 MHz, CDCl₃) δ 195.5, 163.8, 150.1, 148.7, 132.6, 132.1, 130.8, 129.4, 129.2, 129.0, 128.4, 127.6, 121.1, 113.9, 55.5, 42.2; HRMS (ESI) m/z calcd for C₁₈H₁₆NO₂⁺ [M+H]⁺: 278.1176. found 278.1170.

### Compound 4Dk (1-(4-methoxyphenyl)-2-(quinolin-8-yl)ethan-1-one)

¹H NMR (600 MHz, CDCl₃) δ 8.90 (dd, J=4.2, 1.8 Hz, 1H), 8.16-8.12 (m, 3H), 7.75 (dd, J=8.4, 1.2 Hz, 1H), 7.65 (d, J=7.2 Hz, 1H), 7.50 (dd, J=8.4, 7.2 Hz, 1H), 7.40 (dd, J=9.0, 4.2 Hz, 1H), 6.91 (d, J=9.0 Hz, 2H), 4.95 (s, 2H), 3.85 (s, 3H); ¹³C NMR (150 MHz, CDCl₃) δ 197.1, 163.3, 149.6, 146.5, 136.3, 134.5, 131.0, 130.3, 130.1, 128.5, 127.1, 126.3, 121.1, 113.6, 55.4, 40.4; HRMS (ESI) m/z calcd for C₁₈H₁₆NO₂⁺ [M+H]⁺: 278.1176. found 278.1168.

### Compound 4Dc (methyl 6-(2-(4-methoxyphenyl)-2-oxoethyl)-2-naphthoate)

¹H NMR (600 MHz, CDCl₃) δ 8.58 (s, 1H), 8.05-8.01 (m, 3H), 7.91 (d, J=8.4 Hz, 1H), 7.82 (d, J=9.0 Hz, 1H), 7.76 (s, 1H), 7.46 (dd, J=8.4, 1.8 Hz, 1H), 6.94 (d, J=9.0 Hz, 2H), 4.42 (s, 2H), 3.97 (s, 3H), 3.86 (s, 3H); ¹³C NMR (150 MHz, CDCl₃) δ 195.8, 167.2, 163.7, 135.6, 135.3, 131.4, 130.9, 130.8, 129.6, 128.5, 127.92, 127.85, 127.2, 125.5, 113.9, 55.5, 52.2, 45.4; HRMS (ESI) m/z calcd for C₂₁H₁₉O₄+[M+H]⁺: 337.1434. found 337.1424.

### Compound 4N1 ((S)-2-(N-benzylpivalamide)-3-(4-(2-(1-methyl-1H-indol-3-yl)-2-oxoethyl)phenyl)propanoate)

¹H NMR (400 MHz, DMSO-d₆, 120° C.) δ 8.32 (s, 1H), 8.22 (d, J=8.4 Hz, 1H), 7.49 (d, J=8.4 Hz, 1H), 7.30-7.17 (m, 7H), 7.15 (d, J=7.2 Hz, 2H), 6.97 (d, J=8.0 Hz, 2H), 4.63 (d, J=16.8 Hz, 1H), 4.21 (d, J=16.8 Hz, 1H), 4.10 (s, 2H), 3.91 (t, J=6.4 Hz, 1H), 3.87 (s, 3H), 3.54 (s, 3H), 3.30 (dd, J=14.4, 6.4 Hz, 1H), 3.02 (dd, J=14.4, 6.4 Hz, 1H), 1.23 (s, 9H); ¹³C NMR (100 MHz, DMSO-d₆, 120° C.) δ 191.2, 176.7, 169.8, 137.0, 136.8, 136.2, 135.8, 133.9, 128.51, 128.48, 127.5, 127.0, 126.4, 125.9, 122.2, 121.3, 121.0, 114.8, 109.6, 61.3, 51.6, 50.6, 45.2, 38.1, 34.5, 32.4, 27.7. HRMS (ESI) m/z calcd for C₃₃H₃₇N₂O₄ [M+H]⁺: 525.2748. found. 525.2737.

### Compound 4Dl ((S)-2-(N-benzylpivalamide)-3-(4-(2-(4-methoxyphenyl)-2-oxoethyl)phenyl)propanoate)

¹H NMR (400 MHz, DMSO-d₆, 120° C.) δ 7.98 (d, J=8.8 Hz, 2H), 7.30-7.24 (m, 3H), 7.17-7.11 (m, 4H), 7.03-6.94 (m, 4H), 4.63 (d, J=16.4 Hz, 1H) 4.23 (s, 2H), 4.13 (d, J=16.4 Hz, 1H), 3.90 (t, J=7.6 Hz, 1H), 3.84 (s, 3H), 3.54 (s, 3H), 3.28 (dd, J=14.4, 7.6 Hz, 1H), 3.03 (dd, J=14.4, 7.6 Hz, 1H), 1.22 (s, 9H); ¹³C NMR (100 MHz, DMSO-d₆, 120° C.) δ 195.4, 176.6, 169.8, 162.7, 136.2, 136.0, 133.0, 130.0, 129.2, 128.6, 127.5, 127.0, 126.5, 113.4, 61.2, 54.9, 51.6, 50.6, 43.7, 38.1, 34.4, 27.7. HRMS (ESI) m/z calcd for CₙH₃₅NNaO₃[M+Na]⁺: 524.2407. found. 524.2394.

### Compound 4Dm (8R,9S,13S,14S)-3-(2-(4-methoxyphenyl)-2-oxoethyl)-13-methyl-6,7,8,9,11,12,13,14,15,16-decahydro-17H-cyclopenta[a]phenanthren-17-one)

¹H NMR (400 MHz, CDCl₃) δ 8.00 (d, J=8.8 Hz, 2H), 7.24 (d, J=8.0 Hz, 1H), 7.05 (dd, J=8.0, 2.0 Hz, 1H), 7.00 (d, J=2.0 Hz, 1H), 6.93 (d, J=8.8 Hz, 2H) 4.17 (s, 2H), 3.86 (s, 3H), 2.89 (dd, J=8.8, 4.0 Hz, 2H), 2.50 (dd, J=19.6, 8.8 Hz, 1H), 2.44-2.36 (m, 1H), 2.28 (td, J=10.4, 4.0 Hz, 1H), 2.19-1.91 (m, 4H), 1.68-1.35 (m, 6H), 0.90 (s, 3H); ¹³C NMR (100 MHz, CDCl₃) δ 220.9, 196.4, 163.5, 138.2, 136.7, 132.2, 130.9, 129.9, 129.6, 126.8, 125.6, 113.7, 55.4, 50.4, 47.9, 44.7, 44.2, 38.0, 35.8, 31.5, 29.3, 26.4, 25.6, 21.5, 13.8; HRMS (ESI) m/z calcd for C₂₇H₃₁O₃[M+H]⁺: 403.2268. found 403.2257.

### Example 3-3

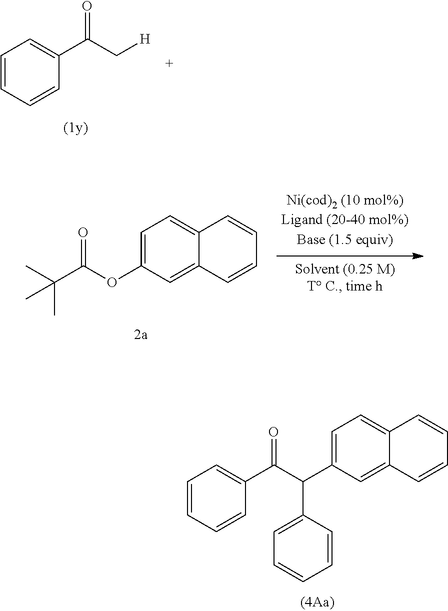 [SMILES: CC(=O)c1ccccc1 ; CC(C)(C)C(=O)Oc1ccc2ccccc2c1 ; O=C(c1ccccc1)C(c1ccccc1)c1ccc2ccccc2c1]

An experiment was performed in the same manner as in Example 3-1, except that the carbonyl compound as a starting material was a carbonyl compound 1y, and the molar ratio of the carbonyl compound and the phenol derivative, the type of ligand, the type of base, the type of solvent, the reaction temperature, and the reaction time were changed in various ways. Table 3 shows the results. In this Example, when a monodentate ligand was used, 40 mol % of it was supplied, and when a bidentate ligand was used, 20 mol % of it was supplied.

TABLE 3

| | 1y:2a | | | | | | |
|---|---|---|---|---|---|---|---|
| | (molar | | | | T | Time | Yield |
| Entry | ratio) | Ligand | Base | Solvent | (° C.) | (h) | (%) |
| 1 | 1:1.5 | dcype | Cs₂CO₃ | Toluene | 120 | 12 | 26 |
| 2 | 1:1.5 | dcype | Cs₂CO₃ | 1,4- | 120 | 12 | 12 |
| | | | | Dioxane | | | |
| 3 | 1:1.5 | dcype | Cs₂CO₃ | Benzene | 120 | 12 | 19 |
| 4 | 1:1.5 | dcype | Cs₂CO₃ | Hexane | 120 | 12 | 7 |
| 5 | 1:1.5 | dcype | K₃PO₄ | Toluene | 120 | 12 | 29 |
| 6 | 1:1.5 | dcype | Na₃PO₄ | Toluene | 120 | 12 | 2 |
| 7 | 1:1.5 | dcype | Rb₂CO₃ | Toluene | 120 | 12 | 6 |
| 8 | 1:1.5 | dcypbz | K₃PO₄ | Toluene | 120 | 12 | 13 |
| 9 | 1:1.5 | PCy₃ | K₃PO₄ | Toluene | 120 | 12 | 4 |
| 10 | 1:1.5 | dppf | K₃PO₄ | Toluene | 120 | 12 | 4 |
| 11 | 1:1.5 | JohnPhos | K₃PO₄ | Toluene | 120 | 12 | 10 |
| 12 | 1:1.5 | dcype | K₃PO₄ | Toluene | 120 | 24 | 40 |
| 13 | 1:1.5 | dcype | K₃PO₄ | Toluene | 120 | 12 | 44 |
| 14 | 1.5:1 | dcype | K₃PO₄ | Toluene | 100 | 24 | 39 |
| 15 | 1.5:1 | dcype | K₃PO₄ | Toluene | 110 | 24 | 40 |
| 16 | 1.5:1 | dcype | K₃PO₄ | Toluene | 120 | 24 | 51 |
| 17 | 1.5:1 | dcype | K₃PO₄ | Toluene | 130 | 24 | 56 |
| 18 | 1.5:1 | dcype | K₃PO₄ | Toluene | 140 | 24 | 53 |
| 19 | 1.5:1 | dcype | K₃PO₄ | Toluene | 150 | 24 | 24 |
| 20 | 1.5:1 | dcypt | K₃PO₄ | Toluene | 130 | 24 | 43 |
| 21 | 1.5:1 | dcypt | K₃PO₄ | Toluene | 150 | 24 | 66 |

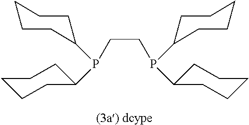 [SMILES: C1CCC(P(CCP(C2CCCCC2)C2CCCCC2)C2CCCCC2)CC1]

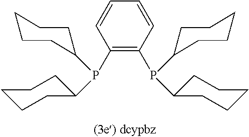 [SMILES: c1ccc(P(C2CCCCC2)C2CCCCC2)c(P(C2CCCCC2)C2CCCCC2)c1]

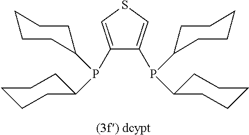 [SMILES: c1scc(P(C2CCCCC2)C2CCCCC2)c1P(C1CCCCC1)C1CCCCC1]

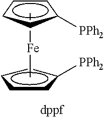

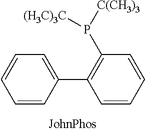 [SMILES: CC(C)(C)P(c1ccccc1-c1ccccc1)C(C)(C)C]

### Example 3-4

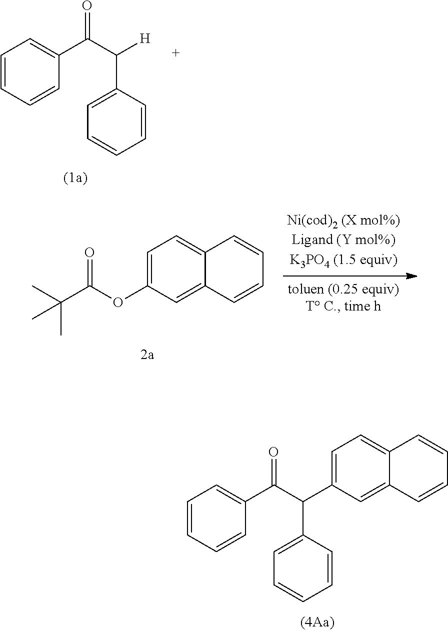 [SMILES: O=C(Cc1ccccc1)c1ccccc1 ; CC(C)(C)C(=O)Oc1ccc2ccccc2c1 ; O=C(c1ccccc1)C(c1ccccc1)c1ccc2ccccc2c1]

An experiment was performed in the same manner as in Example 3-1, except that the amount of nickel catalyst, the type and amount of ligand, the reaction temperature, and the reaction time were changed in various ways. Table 4 shows the results. The number in parentheses in Entry 3 of Table 4 indicates the isolated yield. Further, in Entry 8 of Table 4, Ni(PPh₃)₂Cl₂ was used as the nickel catalyst in place of Ni(cod)₂.

TABLE 4

| | | X | Y | T | Time | Yield |
|---|---|---|---|---|---|---|
| Entry | Ligand | (mol %) | (mol %) | (° C.) | (h) | (%) |
| 1 | dcype | 10 | 20 | 130 | 24 | 54 |
| 2 | dcype | 10 | 20 | 150 | 24 | 57 |
| 3 | dcypt | 10 | 20 | 150 | 24 | 98 (91) |
| 4 | dcypt | 10 | 20 | 100 | 96 | 92 |
| 5 | dcypt | 5 | 10 | 150 | 24 | 95 |
| 6 | dcypt | 1 | 2 | 150 | 24 | 45 |
| 7 | dcypt | 1 | 2 | 150 | 48 | 59 |
| 8 | dcypt | 10 | 20 | 150 | 24 | 66 |

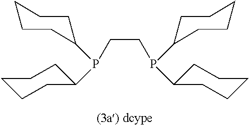 [SMILES: C1CCC(P(CCP(C2CCCCC2)C2CCCCC2)C2CCCCC2)CC1]

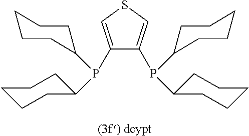 [SMILES: c1scc(P(C2CCCCC2)C2CCCCC2)c1P(C1CCCCC1)C1CCCCC1]

### Example 3-5

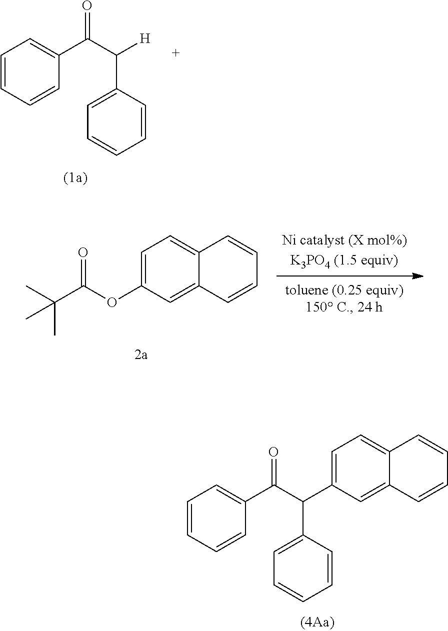 [SMILES: O=C(Cc1ccccc1)c1ccccc1 ; CC(C)(C)C(=O)Oc1ccc2ccccc2c1 ; O=C(c1ccccc1)C(c1ccccc1)c1ccc2ccccc2c1]

An experiment was performed in the same manner as in Example 3-1, except that the type and amount of nickel catalyst, and the supply method were changed in various ways. Table 5 shows the results. In Table 5, for example, “Ni(cod)₂/dcype” indicates that Ni(cod)₂ and dcype were separately supplied, and “Ni(dcype)(CO)₂” indicates that Ni(dcype)(CO)₂ synthesized in advance was supplied. The same applies to other nickel complexes. Moreover, the number in parentheses in Entry 8 of Table 5 indicates the isolated yield.

TABLE 5

| | | Ni source: | X | Yield |
|---|---|---|---|---|
| Entry | Nickel complex | Ligand | (mol %) | (%) |
| 1 | Ni(cod)₂/dycpe | 1:2 | 10 | 57 |
| 2 | Ni(dcype)(CO)₂ | — | 10 | 25 |
| 3 | Ni(L1)(CO)₂ | — | 10 | 61 |
| 4 | Ni(L2)(CO)₂ | — | 10 | 30 |
| 5 | Ni(L3)(CO)₂ | — | 10 | 18 |
| 6 | Ni(dcypbz)(CO)₂ | — | 10 | 46 |
| 7 | Ni(dcypt)(CO)₂ | — | 10 | 79 |
| 8 | Ni(cod)₂/dcypt | 1:2 | 10 | 98 (91) |
| 9 | Ni(cod)₂/dcypt | 1:1 | 10 | 92 |
| 10 | Ni(cod)₂/dcypt | 1:2 | 5 | 95 |
| 11 | Ni(cod)₂/dcypt | 1:2 | 1 | 59 |
| 12 | Ni(cod)₂/dcypt | 1:2 | 10 | 92 |
| 13 | Ni(Ph₃P)₂Cl₂/dcypt | 1:2 | 10 | 66 |

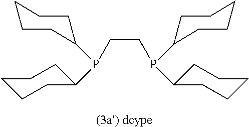 [SMILES: C1CCC(P(CCP(C2CCCCC2)C2CCCCC2)C2CCCCC2)CC1]

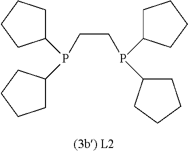 [SMILES: C1CCC(P(CCP(C2CCCC2)C2CCCC2)C2CCCC2)C1]

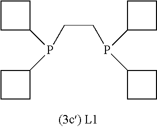 [SMILES: C1CC(P(CCP(C2CCC2)C2CCC2)C2CCC2)C1]

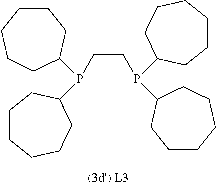 [SMILES: C1CCCC(P(CCP(C2CCCCCC2)C2CCCCCC2)C2CCCCCC2)CC1]

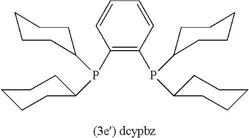 [SMILES: c1ccc(P(C2CCCCC2)C2CCCCC2)c(P(C2CCCCC2)C2CCCCC2)c1]

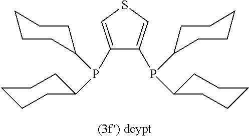 [SMILES: c1scc(P(C2CCCCC2)C2CCCCC2)c1P(C1CCCCC1)C1CCCCC1]

### Example 3-6

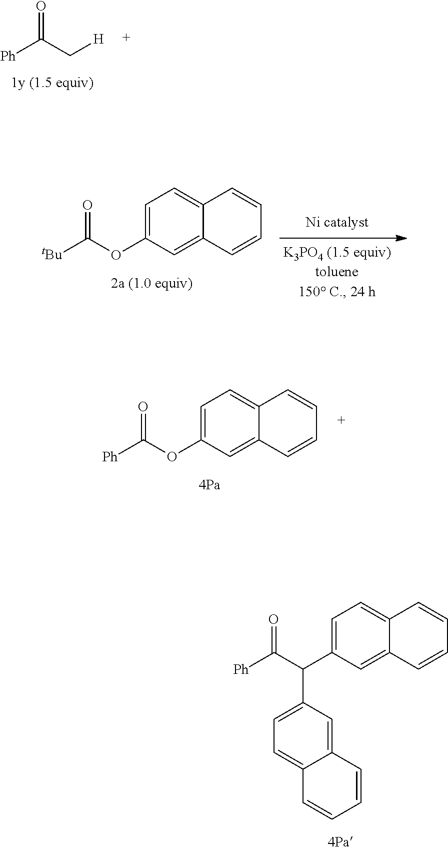 [SMILES: CC(=O)c1ccccc1 ; CC(C)(C)C(=O)Oc1ccc2ccccc2c1 ; O=C(Oc1ccc2ccccc2c1)c1ccccc1 ; O=C(c1ccccc1)C(c1ccc2ccccc2c1)c1ccc2ccccc2c1]

An experiment was performed in the same manner as in Example 3-5, except that the carbonyl compound as a starting material was a carbonyl compound 1y, and the type and amount of nickel catalyst were changed in various ways. Table 6 shows the results. In Table 6, for example, “Ni(cod)₂/dcype” indicates that Ni(cod)₂ and dcype were separately supplied, and “Ni(dcype)(CO)₂” indicates that Ni(dcype)(CO)₂ synthesized in advance was supplied. The same applies to other nickel complexes.

TABLE 6

| | | Amount | | Conversion |
|---|---|---|---|---|
| Entry | Nickel complex | (mol %) | 4Pa/4Pa′ | rate (%) |
| 1 | Ni(dcype)(CO)₂ | 10 | 33/4 | 41 |
| 2 | Ni(L1)(CO)₂ | 10 | 6/0 | 6 |
| 3 | Ni(L2)(CO)₂ | 10 | 35/3 | 41 |
| 4 | Ni(L3)(CO)₂ | 10 | 39/3 | 45 |
| 5 | Ni(dcypbz)(CO)₂ | 10 | 51/8 | 67 |
| 6 | Ni(cod)₂/dcypt | 10 | 66/11 | 88 |
| 7 | Ni(dcypt)(CO)₂ | 10 | 66/13 | 92 |
| 8 | Ni(cod)₂/dcypt | 10 | 1:2 | 98 (91) |

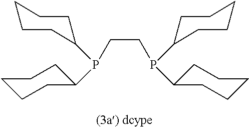 [SMILES: C1CCC(P(CCP(C2CCCCC2)C2CCCCC2)C2CCCCC2)CC1]

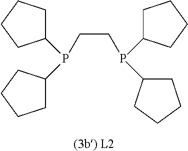 [SMILES: C1CCC(P(CCP(C2CCCC2)C2CCCC2)C2CCCC2)C1]

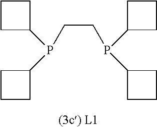 [SMILES: C1CC(P(CCP(C2CCC2)C2CCC2)C2CCC2)C1]

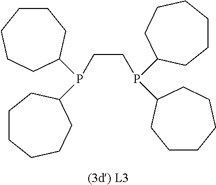 [SMILES: C1CCCC(P(CCP(C2CCCCCC2)C2CCCCCC2)C2CCCCCC2)CC1]

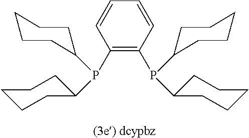 [SMILES: c1ccc(P(C2CCCCC2)C2CCCCC2)c(P(C2CCCCC2)C2CCCCC2)c1]

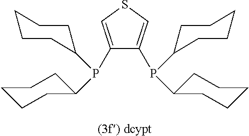 [SMILES: c1scc(P(C2CCCCC2)C2CCCCC2)c1P(C1CCCCC1)C1CCCCC1]

### Example 3-7

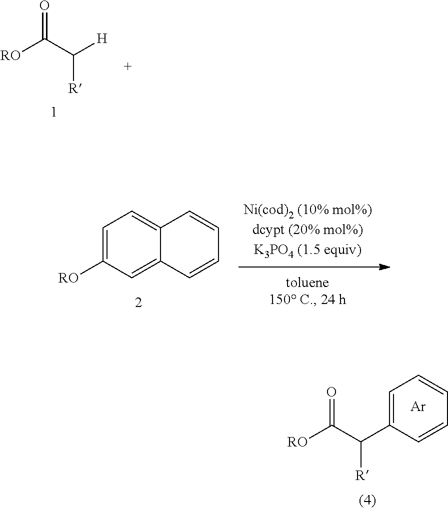

The compounds shown in Table 7 below were obtained in the same manner as in Example 3-1 (with the purification method being appropriately changed, if necessary), except that various starting materials were used in place of the carbonyl compound (1a) and the phenol derivative (2a), and the amount of substrate was changed, if necessary.

TABLE 7

| | Carbonyl | | | | | | |
|---|---|---|---|---|---|---|---|
| | compound | | | | | | |
| | | Amount | Phenol | | | | |
| | | (equiv- | deriv- | | | Amount | Yield |
| Entry | Type | alent) | ative | Product | State | (mg) | (%) |
| 1 | 1a | 1.5 | 2a | 4Aa | White solid | 87.6 | 91 |
| 2 | 1a | 1.5 | 2a′ | 4Aa | White solid | | 77 |
| 3 | 1a | 1.5 | 2n | 4Aa | White solid | | 31 |
| 4 | 1a | 1.5 | 2o | 4Aa | White solid | | 49 |
| 5 | 1a | 1.5 | 2p | 4Aa | White solid | | 43 |
| 6 | 1a | 1.5 | 2q | 4Aa | White solid | | 49 |
| 7 | 1p | 2.0 | 2a | 4Pa | White oily | | 11 |
| | | | | | solid | | |
| 8 | 1p | 2.0 | 2a′ | 4Pa | White oily | 42.9 | 47 |
| | | | | | solid | | |
| 9 | 1p | 2.0 | 2o | 4Pa | White oily | | 46 |
| | | | | | solid | | |
| 10 | 1p | 2.0 | 2p | 4Pa | White oily | 21.9 | 24 |
| | | | | | solid | | |
| 11 | 1p | 2.0 | 2q | 4Pa | White oily | | 36 |
| | | | | | solid | | |
| 12 | 1q | 1.5 | 2a | 4Qa | Reddish- | 55.9 | 68 |
| | | | | | white | | |
| | | | | | oily solid | | |
| 13 | 1q | 1.5 | 2a′ | 4Qa | Reddish- | | 76 |
| | | | | | white | | |
| | | | | | oily solid | | |
| 14 | 1q | 1.5 | 2p | 4Qa | Reddish- | 32.9 | 40 |
| | | | | | white | | |
| | | | | | oily solid | | |
| 15 | 1q | 1.5 | 2q | 4Qa | Reddish- | | 24 |
| | | | | | white | | |
| | | | | | oily solid | | |

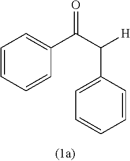 [SMILES: O=C(Cc1ccccc1)c1ccccc1]

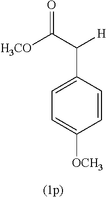 [SMILES: COC(=O)Cc1ccc(OC)cc1]

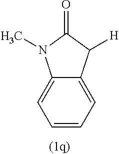

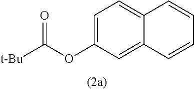 [SMILES: CC(C)(C)C(=O)Oc1ccc2ccccc2c1]

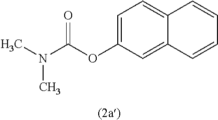 [SMILES: CN(C)C(=O)Oc1ccc2ccccc2c1]

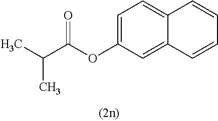 [SMILES: CC(C)C(=O)Oc1ccc2ccccc2c1]

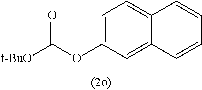 [SMILES: CC(C)(C)OC(=O)Oc1ccc2ccccc2c1]

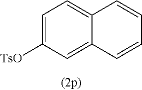 [SMILES: Cc1ccc(S(=O)(=O)Oc2ccc3ccccc3c2)cc1]

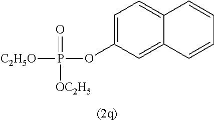

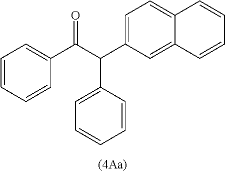 [SMILES: O=C(c1ccccc1)C(c1ccccc1)c1ccc2ccccc2c1]

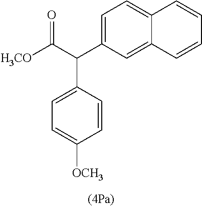 [SMILES: COC(=O)C(c1ccc(OC)cc1)c1ccc2ccccc2c1]

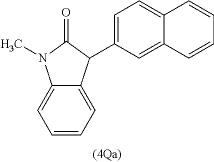 [SMILES: CN1C(=O)C(c2ccc3ccccc3c2)c2ccccc21]

The spectrum data of each compound were as follows:

### Compound 4Pa (methyl 2-(4-methoxyphenyl)-2-(naphthalen-2-yl)acetate)

Rf=0.74 (hexane/ethyl acetate=3:1); ¹H NMR (600 MHz, CDCl₃): δ 7.82-7.77 (m, 3H), 7.74 (s, 1H), 7.45 (m, 2H), 7.41 (dd, J=8.4, 1.8 Hz, 1H), 7.27 (d, J=9.0 Hz, 2H), 6.86 (d, J=9.0 Hz, 2H), 5.15 (s, 1H), 3.77 (s, 3H), 3.76 (s, 3H); ¹³C NMR (150 MHz, CDCl₃): δ 173.4, 159.0, 136.5, 133.5, 132.6, 130.8, 129.9, 128.5, 128.1, 127.7, 127.2, 126.8, 126.3, 126.1, 114.2, 56.4, 55.4, 52.5; HRMS (ESI): calculated for C₂₀H₁₈NaO₃[M+Na]⁺=329.1148. found: 329.1140.

### Compound 4Qa (1-methyl-3-(naphthalen-2-yl)indolin-2-one)

Rf=0.46 (hexane/ethyl acetate: 2/1); ¹H NMR (400 MHz, CDCl₃): δ 7.82-7.74 (m, 3H), 7.70 (s, 1H), 7.47-7.40 (m, 2H), 7.35 (t, J=8.0 Hz, 1H), 7.26 (dd, J=8.4, 2.0 Hz, 1H), 7.18 (t, J=7.6 Hz, 1H), 7.07 (t, J=8.0 Hz, 1H), 6.93 (d, J=8.0 Hz, 1H), 4.77 (s, 1H), 3.28 (s, 3H); ¹³C NMR (100 MHz, CDCl₃): δ 176.0, 144.5, 134.0, 133.5, 132.8, 128.9, 128.7, 128.5, 127.8, 127.8, 127.5, 126.2, 126.1, 125.9, 125.1, 122.8, 108.2, 52.2, 26.5; HRMS (EST): calculated for C₁₉H₁₆NO [M+H]⁺=274.1226. found: 274.1207.

### Example 3-8

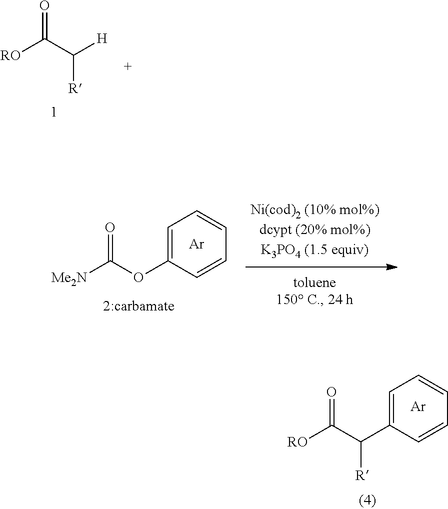

The compounds shown in Table 8 below were obtained in the same manner as in Example 3-1 (with the purification method being appropriately changed, if necessary), except that various starting materials were used in place of the carbonyl compound (1a) and the phenol derivative (2a), and the amount of substrate was changed.

TABLE 8

| | Carbonyl | | | | | | |
|---|---|---|---|---|---|---|---|
| | compound | | | | | | |
| | | Amount | | | | | |
| | | (equiv- | Phenol | | | Amount | Yield |
| Entry | Type | alent) | derivative | Product | State | (mg) | (%) |
| 1 | 1p | 2.0 | 2a′ | 4Pa | White oily | 42.9 | 47 |
| | | | | | solid | | |
| 2 | 1r | 2.0 | 2a′ | 4Ra | White oily | 72.0 | 78 |
| | | | | | solid | | |
| 3 | 1s | 2.0 | 2a′ | 4Sa | White oily | 64.6 | 60 |
| | | | | | solid | | |
| 4 | 1t | 2.0 | 2a′ | 4Ta | White oily | 47.5 | 55 |
| | | | | | solid | | |
| 6 | 1p | 2.0 | 2c | 4Pc | Slightly | 68.8 | 63 |
| | | | | | reddish oil | | |
| 7 | 1p | 2.0 | 2r | 4Pr | Reddish- | 36.0 | 39 |
| | | | | | white | | |
| | | | | | oily solid | | |
| 8 | 1p | 2.0 | 2s | 4Ps | Colorless | 22.0 | 27 |
| | | | | | oil | | |

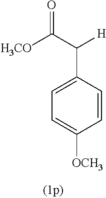

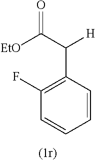

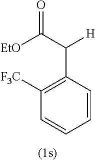

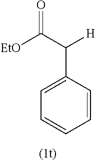

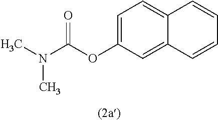

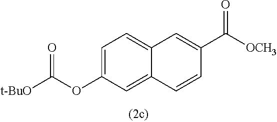

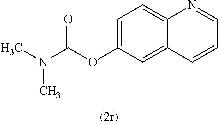

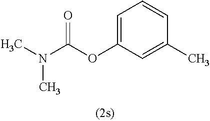

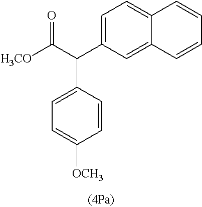

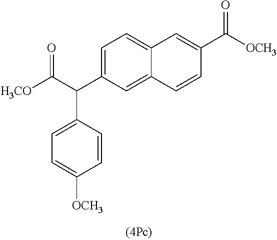

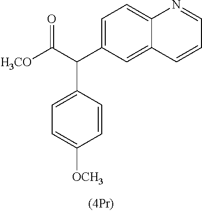

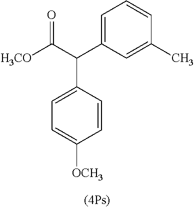

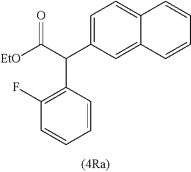

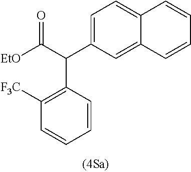

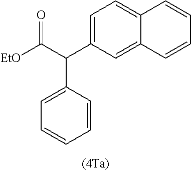

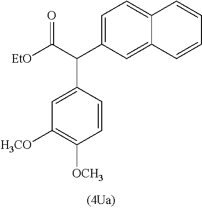

wherein Et is ethyl; hereinafter the same.

The spectrum data of each compound were as follows:

### Compound 4Pc (methyl 6-(2-methoxy-1-(4-methoxyphenyl)-2-oxoethyl)-2-naphthoate)

Rf=0.30 (hexane/ethyl acetate=5:1); ¹H NMR (600 MHz, CDCl₃): δ 8.56 (s, 1H), 8.04 (dd, J=8.4, 1.8 Hz, 1H), 7.89 (d, J=8.4 Hz, 1H), 7.82 (d, J=8.4 Hz, 1H), 7.77 (s, 1H), 7.48 (dd, J=8.4, 1.8 Hz, 1H), 7.27 (d, J=9.0 Hz, 2H), 6.88 (d, J=9.0 Hz, 2H), 5.16 (s, 1H), 3.97 (s, 3H), 3.78 (s, 3H), 3.77 (s, 3H); ¹³C NMR (150 MHz, CDCl₃): δ 173.0, 167.3, 159.1, 139.2, 135.6, 131.7, 130.8, 130.3, 129.9, 129.8, 128.3, 127.7, 127.6, 127.0, 125.7, 114.3, 56.4, 55.4, 52.6, 52.4; HRMS (EST): calculated for C₂₂H₂₁O₅ [M+H]⁺=365.1384. found: 365.1365.

Compound 4Pr (methyl 2-(4-methoxyphenyl)-2-(quinolin-6-yl)acetate): Rf=0.35 (hexane/ethyl acetate=1:1); ¹H NMR (400 MHz, CDCl₃): δ 8.88 (dd, J=4.4, 1.6 Hz, 1H), 8.10 (dd, J=8.4, 2.0 Hz, 1H), 8.06 (d, J=9.2 Hz, 1H), 7.72 (d, J=2.0 Hz, 1H), 7.65 (dd, J=9.2, 2.0 Hz, 1H), 7.37 (dd, J=8.8, 4.4 Hz, 1H), 7.30-7.24 (m, 2H), 6.88 (d, J=9.2 Hz, 2H), 5.17 (s, 1H), 3.79 (s, 3H), 3.77 (s, 3H); ¹³C NMR (100 MHz, CDCl₃): δ 172.9, 159.0, 150.4, 147.5, 137.3, 136.0, 130.4, 130.2, 129.73, 129.70, 128.1, 126.8, 121.3, 114.1, 56.0, 55.2, 52.4; HRMS (EST): calculated for C₁₉H₁₈NO₃[M+H]⁺=308.1281. found: 308.1265.

### Compound 4Ps (methyl 2-(4-methoxyphenyl)-2-(m-tolyl)acetate)

Rf=0.61 (hexane/ethyl acetate=4:1); ¹H NMR (400 MHz, CDCl₃): δ 7.25-7.18 (m, 3H), 7.12-7.04 (m, 3H), 6.85 (d, J=9.2 Hz, 2H), 4.94 (s, 1H), 3.78 (s, 3H), 3.73 (s, 3H), 2.32 (s, 3H); ¹³C NMR (100 MHz, CDCl₃): δ 173.4, 158.8, 138.9, 138.4, 130.9, 129.8, 129.2, 128.6, 128.1, 125.5, 114.0, 56.2, 55.3, 52.4, 21.6; HRMS (ESI): calculated for C₁₇H₁₉O₃[M+H]⁺=271.1329. found: 271.1318.

### Compound 4Ra (ethyl 2-(2-fluorophenyl)-2-(naphthalen-2-yl)acetate)

Rf=0.86 (hexane/ethyl acetate=3:1); ¹H NMR (600 MHz, CDCl₃): δ 7.84-7.79 (m, 3H), 7.78 (s, 1H) 7.49-7.42 (m, 3H), 7.28-7.21 (m, 2H), 7.09-7.02 (m, 2H), 5.44 (s, 1H), 4.29-4.19 (m, 2H), 1.26 (t, J=7.0 Hz, 3H); ¹³C NMR (150 MHz, CDCl₃): δ 172.0, 160.6 (d, J_{CF}=247.5 Hz), 134.8, 133.5, 132.8, 130.2 (d, J_{CF}=4.5 Hz), 129.2 (d, J_{CF}=7.5 Hz), 128.6, 128.1, 127.8, 127.7, 126.9, 126.38, 126.38 (d, J_{CF}=15.0 Hz), 126.3, 124.3 (d, J_{CF}=4.0 Hz), 115.5 (d, J_{CF}=22.0 Hz), 61.6, 50.2, 14.3. HRMS (ESI): calculated for C₂₀H₁₇FNaO₂[M+Na]⁺=331.1105. found: 331.1099.

### Compound 4Sa (ethyl 2-(naphthalen-2-yl)-2-(2-(trifluoromethyl)phenyl)acetate)

Rf=0.83 (hexane/ethyl acetate=3:1); ¹H NMR (600 MHz, CDCl₃): δ 7.83-7.76 (m, 4H), 7.65 (s, 1H), 7.57-7.51 (m, 2H), 7.50-7.45 (m, 2H), 7.45-7.39 (m, 2H), 5.22 (s, 1H), 4.25 (q, J=7.2 Hz, 2H), 1.26 (t, J=7.2 Hz, 3H); ¹³C NMR (150 MHz, CDCl₃): δ 172.0, 139.8, 135.5, 133.5, 132.8, 132.3 (q, J_{CF}=1.5 Hz), 131.0 (q, J_{CF}=33.0 Hz), 129.2, 128.8, 128.1, 127.8, 127.4, 126.54, 126.53, 126.4, 125.6 (q, J_{CF}=4.5 Hz), 124.4 (q, J_{CF}=4.5 Hz), 124.2 (q, J_{CF}=273.0 Hz), 61.7, 57.1, 14.2; HRMS (ESI): calculated for C₂₁H₁₇F₃NaO₂[M+Na]⁺=381.1073. found: 381.1065.

### Compound 4Ta (ethyl 2-(naphthalen-2-yl)-2-phenylacetate)

Rf=0.89 (hexane/ethyl acetate=3:1); ¹H NMR (400 MHz, CDCl₃): δ 7.82-7.75 (m, 4H), 7.48-7.39 (m, 3H), 7.38-7.28 (m, 4H), 7.28-7.23 (m, 1H), 5.18 (s, 1H), 4.23 (q, J=7.2 Hz, 2H), 1.26 (t, J=7.2 Hz, 3H); ¹³C NMR (100 MHz, CDCl₃): δ 172.6, 138.8, 136.3, 133.4, 132.6, 128.8, 128.7, 128.4, 128.1, 127.7, 127.4, 127.3, 126.9, 126.3, 126.1, 61.4, 57.3, 14.3; HRMS (ESI): calculated for C₂₀H₁₈NaO₂ [M+Na]⁺=313.1199. found: 313.1193.

### Example 3-9

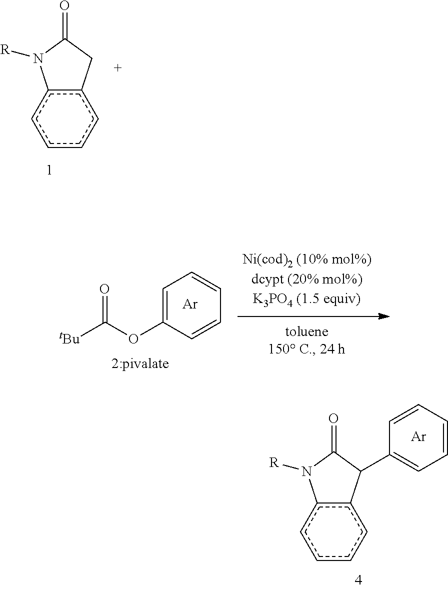

The compounds shown in Table 9 below were obtained in the same manner as in Example 3-1 (with the purification method being appropriately changed, if necessary), except that various starting materials were used in place of the carbonyl compound (1a) and the phenol derivative (2a).

TABLE 9

| | Carbonyl | Phenol | | | Amount | Yield |
|---|---|---|---|---|---|---|
| Entry | compound | derivative | Product | State | (mg) | (%) |
| 1 | 1q | 2a | 4Qa | Reddish-white | 55.9 | 68 |
| | | | | solid | | |
| 2 | 1q | 2c | 4Qc | Reddish-white | 62.4 | 63 |
| | | | | solid | | |
| 3 | 1q | 2f | 4Qf | White solid | 53.3 | 63 |
| 4 | 1q | 2g | 4Qg | Reddish-white | 52.7 | 59 |
| | | | | solid | | |
| 5 | 1q | 2t | 4Qt | Reddish-white | 25.6 | 34 |
| | | | | solid | | |
| 6 | 1v | 2a | 4Va | Reddish-white | 25.6 | 55 |
| | | | | solid | | |
| 7 | 1w | 2a | 4Wa | White crystal | 18.9 | 27 |
| 8 | 1x | 2a | 4Xa | White crystal | 40.3 | 56 |

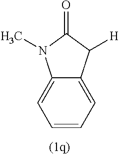

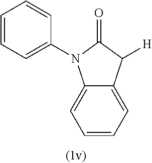 [SMILES: O=C1Cc2ccccc2N1c1ccccc1]

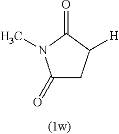

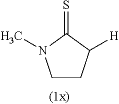

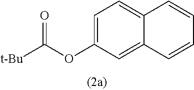 [SMILES: CC(C)(C)C(=O)Oc1ccc2ccccc2c1]

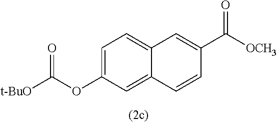 [SMILES: COC(=O)c1ccc2cc(OC(=O)OC(C)(C)C)ccc2c1]

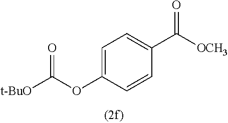 [SMILES: COC(=O)c1ccc(OC(=O)OC(C)(C)C)cc1]

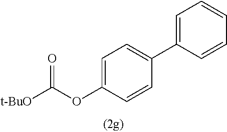 [SMILES: CC(C)(C)OC(=O)Oc1ccc(-c2ccccc2)cc1]

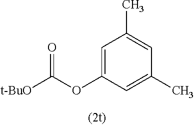 [SMILES: Cc1cc(C)cc(OC(=O)OC(C)(C)C)c1]

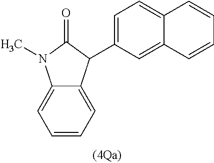 [SMILES: CN1C(=O)C(c2ccc3ccccc3c2)c2ccccc21]

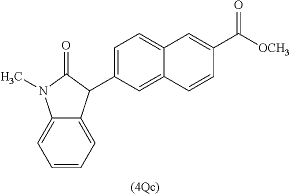 [SMILES: COC(=O)c1ccc2cc(C3C(=O)N(C)c4ccccc43)ccc2c1]

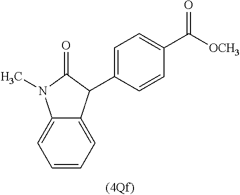 [SMILES: COC(=O)c1ccc(C2C(=O)N(C)c3ccccc32)cc1]

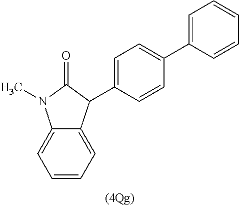 [SMILES: CN1C(=O)C(c2ccc(-c3ccccc3)cc2)c2ccccc21]

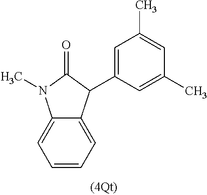

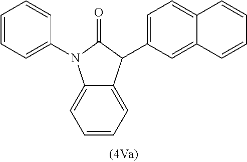 [SMILES: O=C1C(c2ccc3ccccc3c2)c2ccccc2N1c1ccccc1]

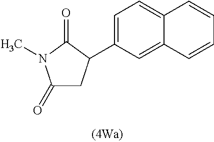 [SMILES: CN1C(=O)CC(c2ccc3ccccc3c2)C1=O]

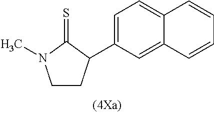 [SMILES: CN1CCC(c2ccc3ccccc3c2)C1=S]

The spectrum data of each compound were as follows:

### Compound 4Qc (methyl 6-(1-methyl-2-oxoindolin-3-yl)-2-naphthoate)

Rf=0.63 (hexane/ethyl acetate=1:2); ¹H NMR (600 MHz, CDCl₃): δ 8.57 (s, 1H), 8.04 (dd, J=9.0, 1.8 Hz, 1H), 7.90 (d, J=8.4 Hz, 1H), 7.81 (d, J=9.0 Hz, 1H), 7.74 (s, 1H), 7.36 (t, J=7.8 Hz, 1H), 7.33 (dd, J=8.4, 1.2 Hz, 1H), 7.18 (d, J=7.2 Hz, 1H), 7.08 (td, J=7.2, 1.2 Hz, 1H), 6.93 (d, J=8.4 Hz, 1H), 4.78 (s, 1H), 3.96 (s, 3H), 3.27 (s, 3H); ¹³C NMR (150 MHz, CDCl₃): δ 175.6, 167.2, 144.6, 136.8, 135.7, 131.9, 130.9, 130.2, 128.8, 128.5, 128.2, 127.6, 127.5, 127.1, 125.7, 125.2, 123.0, 108.5, 52.3, 26.6, There is one overlapping carbon signal as 1 peak is missing even with prolonged scans; HRMS (ESI): calculated for C₂₁H₁₈NO₃[M+H]⁺=332.1281. found: 332.1272.

### Compound 4Qf (methyl 4-(1-methyl-2-oxoindolin-3-yl)benzoate)

Rf=0.75 (hexane/ethyl acetate=1:2); ¹H NMR (400 MHz, CDCl₃): δ 8.00 (d, J=8.0 Hz, 2H), 7.35 (t, J=7.6 Hz, 1H), 7.29 (d, J=8.0 Hz, 2H), 7.14 (d, J=7.6 Hz, 1H), 7.07 (t, J=7.6 Hz, 1H), 6.92 (d, J=7.6 Hz, 1H), 4.66 (s, 1H), 3.90 (s, 3H), 3.26 (s, 3H); ¹³C NMR (100 MHz, CDCl₃): δ 175.3, 166.9, 144.5, 141.8, 130.2, 129.5, 128.8, 128.6, 128.1, 125.1, 123.0, 108.5, 52.2, 52.0, 26.6; HRMS (EST): calculated for C₁₇H₁₆NO₃[M+H]⁺=282.1125. found: 282.1107.

### Compound 4Qg (3-([1,1′-biphenyl]-4-yl)-1-methylindolin-2-one)

Rf=0.71 (hexane/ethyl acetate=1:2); ¹H NMR (600 MHz, CDCl₃): δ 7.57-7.53 (m, 4H), 7.41 (t, J=8.4 Hz, 2H), 7.36-7.31 (m, 2H), 7.27 (d, J=7.8 Hz, 2H), 7.20 (d, J=7.8 Hz, 1H), 7.08 (t, J=7.8 Hz, 1H), 6.91 (d, J=7.8 Hz, 1H), 4.65 (s, 1H), 3.26 (s, 3H); ¹³C NMR (150 MHz, CDCl₃): δ 176.1, 144.6, 140.9, 140.7, 135.7, 128.92, 128.86, 128.8, 128.6, 127.8, 127.4, 127.2, 125.2, 122.9, 108.3, 51.8, 26.6; HRMS (ESI): calculated for C₂H₁₈N0 [M+H]⁺=300.1383. found: 300.1375.

### Compound 4Qt (3-(3,5-dimethylphenyl)-1-methylindolin-2-one)

Rf=0.75 (hexane/ethyl acetate=1/2); ¹H NMR (400 MHz, CDCl₃): δ 7.32 (t, J=7.6 Hz, 1H), 7.15 (d, J=7.2 Hz, 1H), 7.05 (t, J=7.6 Hz, 1H), 6.92-6.87 (m, 2H), 6.78 (s, 2H), 4.52 (s, 1H), 3.26 (s, 3H), 2.27 (s, 6H); ¹³C NMR (100 MHz, CDCl₃): δ 176.3, 144.4, 138.4, 136.4, 129.3, 129.2, 128.2, 126.2, 125.0, 122.7, 108.0, 52.1, 26.4, 21.3; HRMS (EST): calculated for C₁₇H₁₈NONa [M+Na]⁺=274.1208. found: 274.1181.

### Compound 4Va (3-(naphthalen-2-yl)-1-phenylindolin-2-one)

Rf=0.69 (hexane/ethyl acetate=2:1); ¹H NMR (400 MHz, CDCl₃): δ 7.84-7.77 (m, 4H), 7.54-7.44 (m, 6H), 7.42-7.34 (m, 2H), 7.27-7.21 (m, 2H), 7.09 (t, J=7.5 Hz, 1H), 6.92 (d, J=8.0 Hz, 1H), 4.95 (s, 1H); ¹³C NMR (150 MHz, CDCl₃): δ 175.4, 144.6, 134.7, 134.3, 133.6, 133.0, 129.8, 129.0, 128.8, 128.5, 128.2, 128.0, 127.8, 127.8, 126.8, 126.4, 126.3, 126.2, 125.6, 123.4, 109.7, 52.5; HRMS (ESI): calculated for C₂₄H₁₈NO [M+H]⁺=336.1310. found: 336.1364.

### Compound 4Wa (1-methyl-3-(naphthalen-2-yl)pyrrolidine-2,5-dione)

Rf=0.32 (hexane/ethyl acetate=3:1); ¹H NMR (400 MHz, CDCl₃): δ 7.88-7.78 (m, 3H), 7.70 (s, 1H), 7.53-7.46 (m, 2H), 7.29 (dd, J=8.8, 2.0 Hz, 1H), 4.20 (dd, J=9.6, 4.8 Hz, 1H), 3.28 (dd, J=18.8, 9.6 Hz, 1H), 3.11 (s, 3H), 2.93 (dd, J=18.8, 4.8 Hz, 1H); ¹³C NMR (100 MHz, CDCl₃): δ 177.9, 176.4, 134.4, 133.5, 132.9, 129.4, 127.9, 127.8, 126.8, 126.7, 126.5, 124.9, 46.2, 37.2, 25.4; HRMS (ESI): calculated for C₁₅H₁₄NO₂[M+H]⁺=240.1019. found: 240.1012.

### Compound 4Xa (1-methyl-3-(naphthalen-2-yl)pyrrolidine-2-thione)

Rf=0.49 (hexane/ethyl acetate=1:1); ¹H NMR (400 MHz, CDCl₃): δ 7.84-7.75 (m, 3H), 7.69 (s, 1H), 7.47-7.41 (m, 2H), 7.30 (dd, J=8.8, 2.0 Hz, 1H), 4.29 (t, J=8.4 Hz, 1H), 3.94-3.85 (m, 1H), 3.84-3.75 (m, 1H), 3.39 (s, 3H), 2.69-2.58 (m, 1H), 2.30-2.18 (m, 1H); ¹³C NMR (100 MHz, CDCl₃): δ 203.0, 138.9, 133.4, 132.6, 128.6, 127.8, 127.6, 127.1, 126.1, 125.9, 125.8, 60.4, 55.5, 36.0, 29.6; HRMS (ESI): calculated for C₁₅H₁₆NS [M+H]⁺=242.0998. found: 242.0987.

### Example 3-10

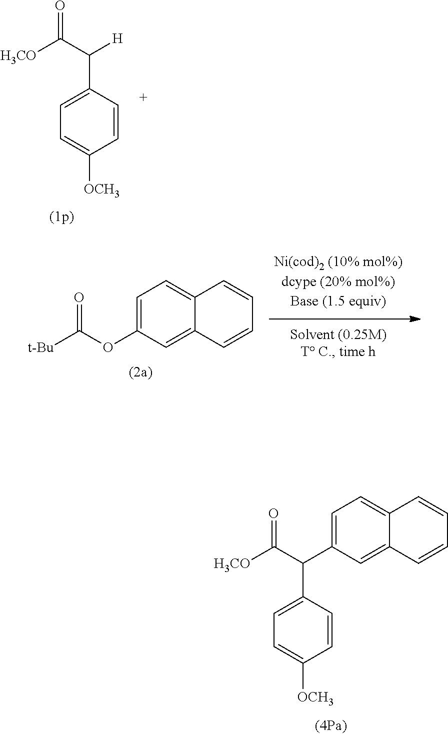 [SMILES: COC(=O)Cc1ccc(OC)cc1 ; CC(C)(C)C(=O)Oc1ccc2ccccc2c1 ; COC(=O)C(c1ccc(OC)cc1)c1ccc2ccccc2c1]

An experiment was performed in the same manner as in Example 3-1, except that the carbonyl compound as a starting material was a carbonyl compound 1p, the ligand was dcype, and the type of base, the type of solvent, the reaction temperature, and the reaction time were changed in various ways. Table 10 shows the results.

TABLE 10

| | | | T | Time | Yield |
|---|---|---|---|---|---|
| Entry | Base | Solvent | (° C.) | (h) | (%) |
| 1 | Cs₂CO₃ | Toluene | 150 | 24 | 9 |
| 2 | K₃PO₄ | Toluene | 150 | 24 | 9 |
| 3 | K₃PO₄ | 1,4-Dioxane | 140 | 24 | 1 |
| 4 | K₃PO₄ | m-Xylene | 140 | 24 | 2 |
| 5 | K₃PO₄ | THF | 120 | 24 | 3 |
| 6 | K₃PO₄ | Diethyl ether | 120 | 24 | 4 |

### Example 3-11

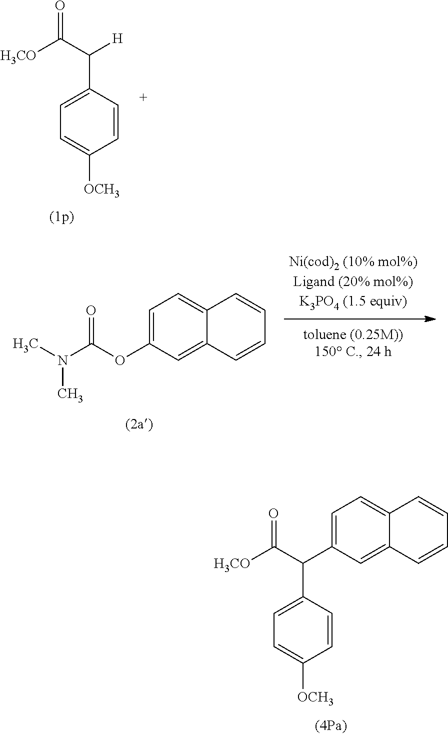 [SMILES: COC(=O)Cc1ccc(OC)cc1 ; CN(C)C(=O)Oc1ccc2ccccc2c1 ; COC(=O)C(c1ccc(OC)cc1)c1ccc2ccccc2c1]

An experiment was performed in the same manner as in Example 3-1, except that the carbonyl compound as a starting material was a carbonyl compound 1p, the phenol derivative was 2a′, the amount of carbonyl compound was 0.60 mmol (2.0 equivalents), and the type of ligand was changed in various ways. Table 11 shows the results. However, in Entry of Table 11, the amount of carbonyl compound was 0.30 mmol (1.0 equivalent), and the amount of phenol derivative was 1.1 equivalents.

TABLE 11

| | | Yield |
|---|---|---|
| Entry | Ligand | (%) |
| 1 | dcypt | 63 |
| 2 | dcype | 36 |
| 3 | BINAP | 9 |

### Test Example 1

### Isolation of Nickel Complex 5

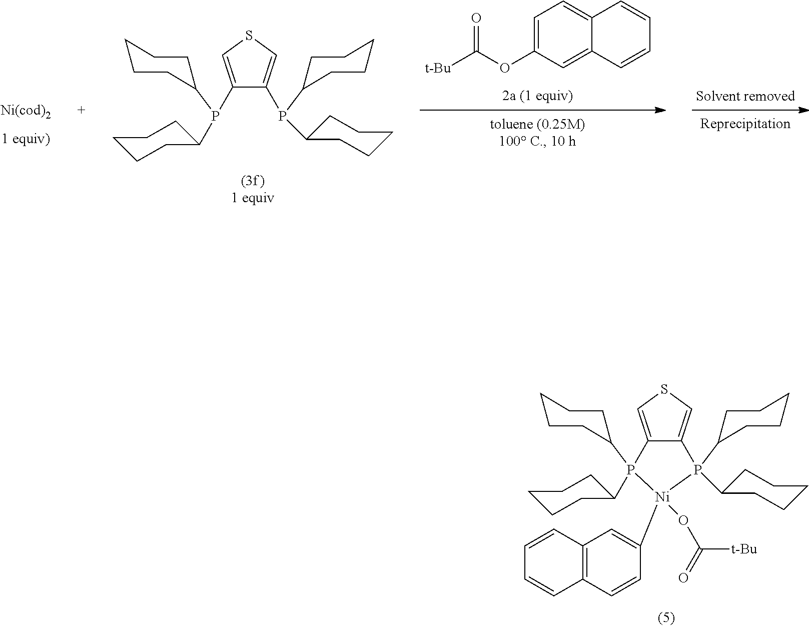

A magnetic stirrer was placed in a 20-ml glass vessel equipped with a J. Young (registered trademark) O-ring tap. After drying with a heat gun under reduced pressure and cooling to room temperature, the vessel was filled with argon. The glass vessel was placed in a glove box in an argon atmosphere, and the phenol derivative 2a (68.5 mg, 0.30 mmol) obtained in Synthesis Example 1-1 was added to the glass vessel. Ni(cod)₂ (82.5 mg, 0.30 mmol, 1.0 equivalent), 3,4-bis(dicyclohexylphosphino)thiophene (dcypt; 143.0 mg, 0.30 mmol, 1.0 equivalent) obtained in Example 1-2, and toluene (1.2 mL) were supplied in the glass vessel. After sealing with the O-ring tap, the glass vessel was taken out from the glove box and heated in an oil bath while stirring at 100° C. for 10 hours. After the reaction mixture was cooled to room temperature, the vessel was placed in the glove box, and the solvent and 1,5-cyclooctadiene were completely removed, thereby obtaining a crude solid. The residue was azeotroped twice with toluene, thereby obtaining an orange solid. After the obtained solid was reprecipitated with hexane, an orange solid was obtained (175.6 mg, 77%).

¹H NMR (600 MHz, CD₂Cl₂) δ 8.21 (s, 1H), 8.16 (d, J=5.5 Hz, 1H), 7.71 (d, J=8.0 Hz, 1H), 7.64 (d, J=8.0 Hz, 1H), 7.57 (d, J=8.0 Hz, 1H), 7.25 (t, J=8.8 Hz, 1H), 7.15 (t, J=8.8 Hz, 1H), 2.70-2.50 (m, 2H), 2.40-2.25 (m, 2H), 2.05-0.69 (m, 53H); ³¹P NMR (243 MHz, CD₂Cl₂) δ 63.8 (d, J_{PP}=13.3 Hz, 1P), 61.6 (d, J_{PP}=13.3 Hz, 1P); HRMS (ESI) m/z calcd for C₄₃H₆₂ClNiO₂P₂S [M+Cl]⁻: 797.2993. found 797.3001.

Thus, the production of the nickel complex 5 suggests that the reaction mechanism of the coupling reaction of the present invention is as described above.

### Test Example 2

### X-Ray Crystal Structure Analysis

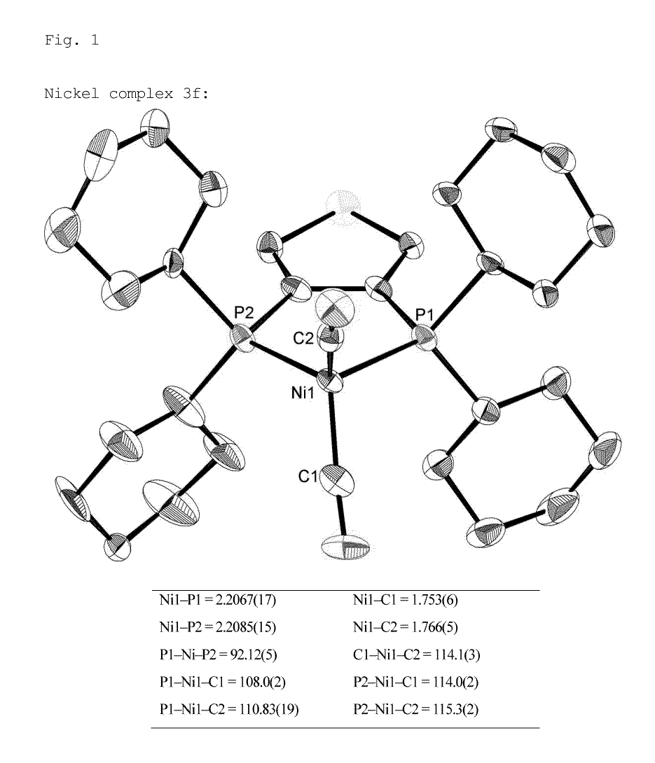

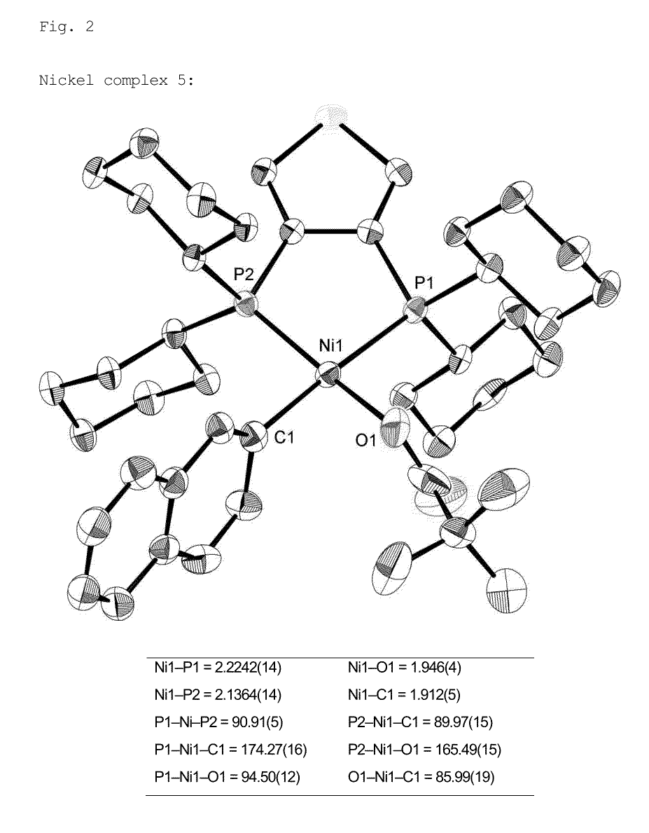

The crystals of the nickel complex 3f obtained in Example 2-1 and the crystals of the nickel complex 5 obtained in Test Example 1 were immersed in mineral oil, placed on a glass fiber, and transferred to a goniometer CCD X-ray detector for crystallography (“Saturn” (trade name), produced by Rigaku Corporation). Graphite-monochromated No Kα radiation (λ=0.71070 Å) was used. Table 12 shows the results. Further, FIGS. 1 and 2 show the structures of the complexes drawn by using the Thermal Ellipsoid Plot program ORTEP.

TABLE 12

| | 3f | 5 |
|---|---|---|
| formula | C₃₀H₄₆NiO₂P₂S | C₄₇H₇₀NiO₃P₂S |
| fw | 591.38 | 835.74 |
| T (K) | 103 (2) | 103 (2) |
| λ (Å) | 0.71075 | 0.71075 |
| cryst syst | Orthorhombic | Monoclinic |
| space group | Peen | P21/c |
| a, (Å) | 31.974 (9) | 15.656 (4) |
| b, (Å) | 11.059 (3) | 15.737 (4) |
| c, (Å) | 16.920 (5) | 19.289 (5) |
| α, (deg) | 90 | 90 |
| β, (deg) | 90 | 111.844 (3) |
| γ, (deg) | 90 | 90 |
| V, (Å³) | 5983 (3) | 4411 (2) |
| Z | 8 | 4 |
| D_{calc}, (g/cm³) | 1.313 | 1.258 |
| μ (mm⁻¹) | 0.851 | 0.599 |
| F(000) | 2528 | 1800 |
| cryst size (mm) | 0.20 × 0.10 × 0.10 | 0.15 × 0.05 × 0.05 |
| 2θrange, (deg) | 3.10-25.00 | 3.09-25.00 |
| reflns collected | 36751 | 29126 |
| indep reflns/Rᵢₙₜ | 5248/0.0905 | 7715/0.0635 |
| params | 371 | 490 |
| GOF on F² | 1.317 | 1.070 |
| R₁, wR₂ [I > 2σ(I)] | 0.0911, 0.1465 | 0.0746, 0.1695 |
| R₁, wR₂ (all data) | 0.0974, 0.1492 | 0.0963, 0.1850 |

1. A compound having a diphosphine skeleton in which a five- or six-membered heterocyclic ring is substituted with two dialkylphosphines and/or dicycloalkylphosphines, or a salt thereof.

2. The compound or a salt thereof according to claim 1, wherein the compound is represented by Formula (1): 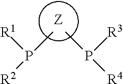
wherein Z is an optionally substituted five- or six-membered heterocyclic ring; and
R¹ to R⁴ are the same or different, and each is optionally substituted alkyl or optionally substituted cycloalkyl.

3. The compound or a salt thereof according to claim 2, wherein R¹ to R⁴ in Formula (1) are the same or different, and each is optionally substituted cycloalkyl.

4. The compound or a salt thereof according to claim 1, which is used to produce a catalyst for coupling reaction of a carbonyl compound and a phenol derivative.

5. A compound having a diphosphine skeleton in which a five- or six-membered heterocyclic ring is substituted with two dialkylphosphines and/or dicycloalkylphosphines, the diphosphine skeleton being bound to nickel.

6. The compound according to claim 5, which is represented by Formula (2): 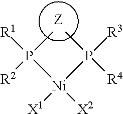
wherein Z is an optionally substituted five- or six-membered heterocyclic ring;
R¹ to R⁴ are the same or different, and each is optionally substituted alkyl or optionally substituted cycloalkyl; and
X¹ and X² are the same or different, and each is a ligand.

7. The compound according to claim 6, wherein R¹ to R⁴ in Formula (2) are the same or different, and each is optionally substituted cycloalkyl.

8. The compound according to claim 5, which is a catalyst for coupling reaction of a carbonyl compound and a phenol derivative.

9. A method for producing an arylcarbonyl compound,
comprising the step of subjecting a carbonyl compound and a phenol derivative to coupling reaction in the presence of the compound according to claim 5.

10. A coupling method comprising reacting a carbonyl compound and a phenol derivative in the presence of the compound according to claim 5.

11. A method for producing an arylcarbonyl compound comprising the step of subjecting a carbonyl compound and a phenol derivative to coupling reaction;
the coupling reaction being performed in the presence of a nickel compound having a monodentate or bidentate dialkylphosphine and/or dicycloalkylphosphine skeleton.

12. The production method according to claim 11, wherein the nickel compound is represented by Formula (3): 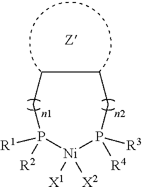
wherein Z′ may or may not form a ring; when Z′ forms a ring, Z′ is an aromatic hydrocarbon ring or a five- or six-membered heterocyclic ring;
R¹ to R⁴, and X¹ and X² are the same as above; and
n1 and n2 are the same or different, and each is an integer of 0 to 2.

13. A coupling method for reacting a carbonyl compound and a phenol derivative according to the method of claim 11,
the reaction being performed in the presence of a nickel compound having a monodentate or bidentate dialkylphosphine and/or dicycloalkylphosphine skeleton.

14. The method according to claim 13, wherein the nickel compound is represented by Formula (3): 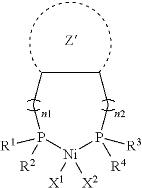
wherein Z′ may or may not form a ring; when Z′ forms a ring, Z′ is an aromatic hydrocarbon ring or a five- or six-membered heterocyclic ring;
R¹ to R⁴, and X¹ and X² are the same as above; and
n1 and n2 are the same or different, and each is an integer of 0 to 2.
